(19) United States
(12) Patent Application Publication
(10) Pub. No.: US 2025/0267422 A1
(43) Pub. Date: Aug. 21, 2025

(54) AUDIO SIGNAL PROCESSOR AND RELATED METHOD AND COMPUTER PROGRAM FOR GENERATING A TWO-CHANNEL AUDIO SIGNAL USING A SPECIFIC HANDLING OF IMAGE SOURCES

(71) Applicant: BRANDENBURG LABS GmbH, Ilmenau (DE)

(72) Inventors: Nils MERTEN, Ilmenau (DE); Thomas THRON, Ilmenau (DE); Karlheinz BRANDENBURG, Ilmenau (DE)

(73) Assignee: BRANDENBURG LABS GmbH, Ilmenau (DE)

(21) Appl. No.: 19/187,557

(22) Filed: Apr. 23, 2025

Related U.S. Application Data
(63) Continuation of application No. PCT/EP2023/079663, filed on Oct. 24, 2023.

(30) Foreign Application Priority Data
Oct. 24, 2022 (EP) 22203362.3

(51) Int. Cl. H04S 7/00; H04S 1/00

(52) U.S. Cl. CPC H04S 7/303; H04S 1/007; H04S 7/305; H04S 2400/11; H04S 2420/01

(57) ABSTRACT

Audio signal processor for generating a two-channel audio signal having: an input interface for providing single-channel acoustic data describing an acoustic environment; a two-channel synthesizer for synthesizing two-channel acoustic data using a listener position or rotation; and a sound generator for generating the two-channel audio signal from an audio signal and the two-channel acoustic data, wherein the two-channel synthesizer is configured to separate the single-channel acoustic data into at least two parts consisting of a direct sound part and at least one of an early reflection part and a late reverberation part, the two-channel synthesizer configured to segment the early reflection part into a plurality of segments, to determine a plurality of image source positions representing source positions of reflection sound, to associate the image source positions to the segments using a matching operation, and to calculate the two-channel acoustic data for the direct sound using the image source positions.

### CROSS-REFERENCES TO RELATED APPLICATIONS

This application is a continuation of copending International Application No. PCT/EP2023/079663, filed Oct. 24, 2023, which is incorporated herein by reference in its entirety, and additionally claims priority from European Application No. 22203362.3, filed Oct. 24, 2022, which is also incorporated herein by reference in its entirety.

### TECHNICAL FIELD

The present invention relates to an apparatus, a method or a computer program for audio reproduction such as a binaural reproduction via headphones or speakers. Particularly, the present invention relates to the processing of digital audio signals together with acoustic data describing an acoustic environment.

### BACKGROUND OF THE INVENTION

State of the art binaural audio rendering systems allow users to simulate and listen to virtual sound sources, which are precisely localizable in space. The simulated sounds seem to originate from outside of the head, which is called “externalization”. With an appropriate system, binaurally rendered sound sources can be perceived at a stable position in space and seem to have similar acoustic properties to real sound sources. This can make them virtually indistinguishable from real sound sources.

A number of Binaural Synthesis methods and algorithms exist, which can be used to achieve externalization. They have in common, that they aim to approximate filter effects that the sound is subjected to on its simulated path to the listener's ear. The combined filters of the system, consisting of a sound source, the acoustic influence of a virtual or real environment and its geometry, the listeners head and body and potentially other influences on the sound, caused by the environment, are called a Binaural Room Impulse Response (BRIR).

The two main components of a BRIR are the Head Related Transfer Function (HRTF) and the Room Impulse Response (RIR). The HRTF encodes the measured or approximated filter effects of the head, torso and outer ear of a human. As such, it is dependent on the listeners head and geometry and the relative position and rotation of head and sound source.

The RIR encodes filter effects of the Room, i.e. reflection, diffraction and shadowing of the sound, introduced by room geometry. It is dependent on the room geometry and the positions and rotations of the listener and sound source inside of the room. (Room hereby refers to any kind of environment, not limited to buildings.)

Simulating these effects is often done by means of complex simulations or more lightweight approximations, which require a complex room geometric model to simulate convincing room impulse responses. Depending on the used binaural synthesis algorithm, current state of the art algorithms often have to make a trade-off between computational complexity, limiting the lower size bound of target systems, or effectiveness of the simulation, often resulting in badly localizable or completely in-head localized sound sources.

Further, these devices require room geometric data of the current room, including reflective surfaces, their absorption and scattering coefficients. This data is hard to acquire, especially in Augmented Reality (AR) settings, where the use of the device is not limited to a single room. Acquiring it is usually not feasible, even for trained users and measuring it automatically is a daunting task.

Depending on the employed Binaural Synthesis algorithms and techniques, these processes can be very computing intensive and time consuming. However, processing power is often limited on the target devices. For instance, the binaural rendering might be deployed on “True Wireless Earbuds” or similar smart headphones or wearables, which only provide very limited processing power to provide an adequate battery life.

These devices are often wirelessly coupled with other devices, like a smartphone, via Bluetooth or a similar wireless protocol. However, these connections introduce an additional delay by requiring coding, conversion and transmission over the air. This delay usually far exceeds the required maximum motion-to-sound latency, which is required to achieve externalization. Motion-to-sound latency here describes the time frame, which the binaural audio system requires to auralize acoustic changes, caused by a user's head movement. The exact audibility threshold for motion-to-sound latency varies and is dependent on the listener, the signal employed and the acoustics of the environment. A latency of at most 50 ms has been determined as a valid threshold, which is inaudible to most users under most circumstances.

In order to produce convincing virtual sound sources, binaural signals and binaural filters are usually updated at this high rate. Depending on the employed binaural synthesis methods, this results in a computational complexity, which is often too high for mobile and wearable devices. Instead, such devices are often cable connected to another computing device, which handles these calculations.

The publication “Proof of Concept of a Binaural Renderer with Increased Plausibility” by U. Sloma, et al., DAGA 2023 Hamburg, pages 208-211 describes a proof of concept demo showcasing the comparison of a real loudspeaker setup and headphones based rendering in a given room. Particularly, the room acoustic processing has been included and is processed in runtime. Particularly, Binaural Room Impulse Responses (BRIRs) are calculated in real-time, based on a single omnidirectional Room Impulse Response (RIR). A very basic room geometric model as well as the positions of the sound sources and microphone need to be captured. From that, the Directions of Arrival (DOAs) of the direct sound and early reflections are estimated by a simplified image source model. The RIR is processed in segments and appropriately convolved with generic HRTF filters. Late reverberation is simulated by noise shaping. This algorithm allows a 6DoF rotation and translation. Furthermore, the Spatial Decomposition Method is discussed. This method uses one measurement microphone and six electret condenser microphones. It is assumed, that the sound field consists of a sequence of individual acoustic events. They can be described with the captured RIRs and the captured DOAs. In the post-processing, the HRIRs are calculated for the measurement position with a 3DoF rotation and a generic HRTF filter.

The publication “Creation of Auditory Augmented Reality Using a Position-Dynamic Binaural Synthesis System—Technical Components, Psychoacoustic Needs, and Perceptual Evaluation”, S. Werner, et al., Applied Sciences, 2021, 11, 1150, discloses a position-dynamic binaural synthesis system that is used to synthesize the ear signals for a moving listener. The goal is the fusion of the auditory perception of the virtual audio objects with the real listening environment. For each possible position of the listener in the room, a set of binaural room impulse responses (BRIRs) congruent with the expected auditory environment is entailed to avoid room divergence effects. The required spatial resolution of the BRIR positions can be estimated by spatial auditory perception thresholds. Particularly, a specific position-dynamic binaural synthesis system relies on a pre-processing of the room geometry, a spatial resolution of reproduction, a listening position representation, a real-time processing block comprising get tracking data and processing and a convolution engine, and a filter creation block comprising the listening positions and the BRIR synthesis. The result of the BRIR synthesis are binaural filters that are used by the convolution engine in the real-time processing block for the purpose of position-dynamic binaural playback. A constant reverberation, an acoustically shaping, a synthesis approach adapting an initial time delay gap (ITDG), a sound source directivity and a real-time processing are discussed.

The publication “Binauralization of Omnidirectional Room Impulse Responses-Algorithm and Technical Evaluation”, C. Pörschmann, et al., Proceedings of the 20^{th} International Conference on Digital Audio Effects (DAFx-17), Edinburgh, UK, Sep. 5-9, 2017, pp. 345-352 discloses a binauralization of omnidirectional room impulse responses algorithm which synthesizes BRIR data sets for dynamic auralization based on a single measured omnidirectional room impulse response (RIR). Direct sound, early reflections, and diffuse reverberation are extracted from the omnidirectional RIR and are separately spatialized. Spatial information is added according to assumptions about the room geometry and on typical properties of diffuse reverberation. The early part of the RIR is described by a parametric model. Thus, modifications of the listener position can be considered. The late reverberation part is synthesized using binaural noise, which is adapted to the energy decay curve of the measured RIR. The direct sound frame starts with the onset of the sound and ends after 10 ms. The following time section is assigned to the early reflections and the transition towards the diffuse reverberation. Sections with strong early reflections are determined. Following this procedure, small window sections of the omnidirectional RIR are extracted describing the early reflections. The incidence directions of the synthesized reflections base on a spatial reflection pattern adapted from a shoebox room with non-symmetric positioned source and receiver. A fixed lookup-table containing the incidence directions is used. By this, a parametric model of the direct sound and the early reflections is created. Amplitude, incidence direction, delay and the envelope of each of the reflections are stored. By convolving each window section of the RIR with the HRIR (φ) of each of the directions, a binaural representation of the early geometric reflective part is obtained. To synthesize interim directions between the given HRIRs, interpolation in the spherical domain is performed. The early part of the single measured omnidirectional RIR contains the direct sound and strong early reflections. For this part, the directions of incidence are modelled reaching the listener from arbitrarily chosen directions. The late part of the RIR is considered being diffuse and is synthesized by convolving binaural noise with small sections of the omnidirectional RIR. By this, the properties of diffuse reverberation are approximated. The synthesized BRIRs can be adapted to shifts of the listener and, thus, freely chosen positions in the virtual room can be auralized.

It has been found that existing BRIR synthesis algorithms suffer from several disadvantages that render the processing computationally expensive, that result in a non-natural sound perception by a listener, that are problematic in adapting the system to a specific source characteristic, position or orientation or a specific listener positon or orientation in an efficient way, or that can even forbid the system to be operating in real time. Furthermore, an additional disadvantage can be that artefacts are created that result in a reduced externalization of the sound impression which contributes to a non-natural and unpleasant feeling for the listener.

Therefore, it is an object of the present invention to provide an improved concept for audio signal processing. Starting from single-channel acoustic data describing an acoustic environment and resulting in an audio sound generation relying on a two-channel acoustic data for the specific setting consisting of the acoustic environment and the one or more sources and the listener.

### SUMMARY

According to an embodiment, an audio signal processor for generating a two-channel audio signal may have: an input interface for providing single-channel acoustic data describing an acoustic environment; a two-channel synthesizer for synthesizing two-channel acoustic data from the single-channel acoustic data using a listener position or rotation; and a sound generator for generating the two-channel audio signal from an audio signal and the two-channel acoustic data, wherein the two-channel synthesizer is configured to separate the single-channel acoustic data into at least two parts consisting of a direct sound part and at least one of an early reflection part and a late reverberation part, and to individually process the at least two parts for generating two-channel acoustic data for each part, wherein the two-channel synthesizer is configured to segment the early reflection part into a plurality of segments, to determine a plurality of image source positions representing source positions of reflecting sound, to associate the image source positions to the segments using a matching operation, wherein the matching operation has calculating a time of sound arrival for each image source to the listener position and associating the image source positions to corresponding segments that have time delays in the corresponding segments best matching with the time of sound arrival of the corresponding image source positions, and to calculate the two-channel acoustic data for the direct sound using the image source positions associated to the segments.

According to an embodiment, a method of generating a two-channel audio signal may have the steps of: providing single-channel acoustic data describing an acoustic environment; synthesizing two-channel acoustic data from the single-channel acoustic data using a listener position or rotation; and generating the two-channel audio signal from an audio signal and the two-channel acoustic data, wherein the generating has separating the single-channel acoustic data into at least two parts consisting of a direct sound part and at least one of an early reflection part and a late reverberation part, and to individually process the at least two parts for generating two-channel acoustic data for each part, segmenting the early reflection part into a plurality of segments, determining a plurality of image source positions representing source positions of reflecting sound, and associating the image source positions to the segments using a matching operation, wherein the matching operation has calculating a time of sound arrival for each image source to the listener position and associating the image source positions to corresponding segments that have time delays in the corresponding segments best matching with the time of sound arrival of the corresponding image source positions, and calculating the two-channel acoustic data for the direct sound using the image source positions associated to the segments.

Another embodiment may have a non-transitory digital storage medium having a computer program stored thereon to perform a method of generating a two-channel audio signal having the steps of: providing single-channel acoustic data describing an acoustic environment; synthesizing two-channel acoustic data from the single-channel acoustic data using a listener position or rotation; and generating the two-channel audio signal from an audio signal and the two-channel acoustic data, wherein the generating has separating the single-channel acoustic data into at least two parts consisting of a direct sound part and at least one of an early reflection part and a late reverberation part, and to individually process the at least two parts for generating two-channel acoustic data for each part, segmenting the early reflection part into a plurality of segments, determining a plurality of image source positions representing source positions of reflecting sound, and associating the image source positions to the segments using a matching operation, wherein the matching operation has calculating a time of sound arrival for each image source to the listener position and associating the image source positions to corresponding segments that have time delays in the corresponding segments best matching with the time of sound arrival of the corresponding image source positions, and calculating the two-channel acoustic data for the direct sound using the image source positions associated to the segments, when the computer program is run by a computer.

Aspects of the invention start from single-channel acoustic data describing an acoustic environment and result in an audio sound generation relying on a two-channel acoustic data for the specific setting consisting of the acoustic environment, the one or more sources and the listener.

Subsequently, specific improvements to algorithms are described with respect to seven aspects of the invention. It is to be emphasized that the implementation of a single aspect in a currently existing system already results in a significant improvement over the art. However, it is also possible to combine a subset of the seven aspects or to even combine all the seven aspects with each other in order to achieve an improved audio signal processor for generating a two-channel audio signal. Thus, it is to be emphasized that the subsequently described seven aspects can be used separate from each other or can be combined in an arbitrary way, i.e., for example the third and the fifth aspect can be combined, or the third aspect to the seventh aspect can be combined, or the first to fourth aspect and the seventh aspect can be combined, etc.

In accordance with the first aspect of the present invention, the specific source characteristic and, particularly, a directivity information of the sound source is integrated into a two-channel synthesis for the purpose of synthesizing two-channel acoustic data from the single-channel acoustic data. This integration of sound source directivity information can be particularly performed in the processing of the direct sound (DS) part of the single-channel acoustic data describing the acoustic environment. However, the integration of the directivity information allowing a natural reproduction of a sound source having a non-omnidirectional directivity characteristic can also be integrated in the processing of the early reflections (ER) part of the single-channel acoustic data, or the directivity information can even be integrated into both, the direct sound processing and the early reflection processing in an efficient way.

In accordance with a second aspect of the present invention, the specific processing of the early reflections (ER) part of the single-channel acoustic data is enhanced. Particularly, the early reflection part is segmented into a plurality of segments where each segment comprises a certain reflection. Particularly, a plurality of image source positions representing the sources of reflection sound are determined, and these image source positions are associated to the segments using an inventive matching operation that relies on a time of sound arrival calculated for each image source to the listener position in an initial measurement. Then, a matching is performed in order to associate the time of sound arrival for each image source to a certain segment, i.e., to a certain reflection in the segment. By this, an automated and high quality association of image source positions to the different early reflections is obtained. By means of an additional integration of the directivity information not only for the direct sound, but also for the individual image sources, a certain orientation of an image source can also be accounted for in order to arrive at a more natural sound reproduction.

In accordance with a third aspect of the present invention, processing of the early reflection part of the single-channel acoustic data describing the acoustic environment is enhanced by calculating the two-channel acoustic data for the early reflection part not only using a specular part describing distinct earlier reflections, but also accounting for a diffuse part describing a diffuse influence in the early reflection part. It has been found that although the “second part” of the room impulse response shows prominent early reflections, it does not consist of only these. Instead, even this early reflections part has a significant diffuse part that has an even increasing influence in the course from the beginning of the early reflections part to the end of the early reflections part i.e., near the beginning of the late reverberation part of the room impulse response. Therefore, by calculating the two-channel acoustic data describing the acoustic environment using a diffuse contribution even in the early reflection part has resulted in better natural auralization of an artificial sound scene, for example, by headphones or by speakers fed with the two-channel audio data generated by the sound generator using the two-channel acoustic data for the early reflection part relying on not only the specular part by also relying on the diffuse part.

In accordance with a fourth aspect of the present invention, that is related to an improved calculation of the late reverberation (LR) part of the single-channel acoustic data such as the BRIR or BRTF (binaural room transfer function) relies on the specific generation of the two-channel late reverberation part by means of combining magnitude-data derived from the single-channel acoustic data and an advantageously binaural two-channel noise sequence. Thus, the generation of two channels from one channel is done by using the same magnitudes but different phase values.

Particularly, an advantageous binaural noise sequence consisting of two channels is converted into a spectral domain with a short-time Fourier transform or any other time domain/frequency domain conversion algorithm. This results in two spectrograms. Furthermore, the late reverberation part or the combination of the early reverberation part and the late reverberation part of the single-channel acoustic data is converted into a spectral representation as well advantageously using the same transform algorithm. Then, the two-channel acoustic data for the environment are derived by relying on the same amplitudes that may also be e.g. low-pass filtered for the actual generation with the two phase spectra and, then, these two resulting spectrograms are transformed into the time domain to obtain the processed late reverberation part and advantageously also the diffuse part of the processed early reflection part as has been discussed before with respect to the fourth aspect. Thus, the specific procedure of diffuse signal calculation can be applied to the late reverberation part only or can be applied to the calculation of the diffuse part of the early reverberation part only or can be applied, as it is the case in the embodiment of the present invention, to the calculation of both the early reflection part and the late reverberation part. Particularly, for the calculation of the combined early reflection and late reverberation part, a separation into these parts is not necessary at all, since the calculation of the binaural diffuse portion is done without any knowledge on any separation of an early reflection part and a late reverberation part so that any such separation between the early reflection part and the late reverberation part is not needed at all for this aspect of the present invention. This approach results in a specific saving of computational resources. Furthermore, a high audio quality is obtained which is even sufficient so that, specifically for the calculation of the late reverberation part, any changes depending on a listener position or a source position or orientation do not have to be accounted for enhancing the efficiency of the algorithm further. Any changes depending on a listener position or a source position or orientation do not have to be accounted for the calculation of the diffuse part in the early reflection part of the room impulse response, too.

In accordance with a fifth aspect of the present invention, the problem is addressed how to efficiently and flexibly obtain a high quality single-channel acoustic data such as a single-channel room impulse response that has sufficient quality for obtaining a high quality auralization. To this end, the input interface is configured to acquire a raw representation related to the single-channel acoustic data and the input interface is additionally configured for deriving the single channel acoustic data using the raw representation and additional data stored in the audio signal processor or accessible by the audio signal processor. Thus, by means of an initial measurement relying on natural sounds producible by a user such as a user clapping with his or her hands or stamping on the floor with his or her feet or even a speech signal can be used instead of a typically used sine sweep signal which is a highly unnatural signal and can, of course, not be generated by a listener at all.

Furthermore, the provision of the initial measurement can be performed by a low quality microphone as is, for example, included in a laptop or mobile phone or so and, then, based on this raw representation related to the single-channel acoustic data, a synthesis or, in general, a generation of high quality single-channel acoustic data can be done using a database matching process relying on test and reference fingerprints or a synthesis can be done with a single or several neural networks that rely on the acquired raw representation such as the initial measurement or even only geometric data on the acoustic environment and, probably, also an intended source position and an intended or initial listener position.

Another procedure of this aspect is to simply record a piece of sound such as a piece of music played by a speaker or several speakers in a certain acoustic environment, and to look up, in a database that is typically remote, via some kind of audio fingerprinting processes for the original version of the piece of sound that has been played by the speaker. By using the clear or ideal sound played by the speakers and the sound having the influence of the room acoustic, the room impulse response or room transfer function or generally, a two-channel acoustic data can be calculated.

This procedure effectively addresses the problem to have a single channel room impulse response that is good enough to perform a useful calculation of a head related impulse response based on a certain listener and source position.

In accordance with a sixth aspect of the present invention, the processing tasks can be distributed to several different devices having different power supplies. This allows to do most of the tasks on a wearable device such as a headphone, an earbud, an in ear element or so, while the second device is a device that has a large battery such as a mobile phone, a smart watch, a tablet or a notebook computer or a stationary computer.

Particularly, it has been found that the computationally most expensive part is the calculation of the late reverberation and, to some extent, also the calculation of the earlier reflection part. However, it has been found that the update rate for these procedures can be lower compared to the update rate of the calculation of the direct sound. On the other hand, the calculation of the direct sound is computationally inexpensive, since this part is only a short portion in time, and therefore, only requires short filters that can be very efficiently processed.

Therefore, the processing task of calculating the direct sound part can easily be performed by a low-power device such as a wearable device while the more demanding tasks are performed by the separate second device. The incurred transmission latency is non-problematic, since a lower update ratio is sufficient for the calculations that are computationally more offensive, i.e., the calculation of the early reflection part and, particularly, the calculation of the late reverberation part that has, depending on the certain acoustic environments, a considerable length in time when the room impulse response is considered. Particularly, in reverberant rooms such as churches, the late reverberation part can extend over several seconds of diffuse reverberation.

In accordance with the seventh aspect, it has been found that a specific attention has to be directed to the separation of the room impulse response and the combination after calculating the individual portions. Particularly, in order to have a high quality system that, on the one hand, allows to calculate the different parts (DS, ER, LR) by individual processes, and to combine the results without suffering from audio quality problems incurred by the separation into the individual parts and by the combining of the individually calculated results, a specific extending of the corresponding parts at a separation time such as between the direct sound and the early reflection part or between the early reflection part and the late reverberation part has to be done in order to obtain an overlap range at the corresponding separation time instant. Furthermore, in order to avoid any artefacts and additionally, in order to allow a seamless processing which has to be done in a considerably short amount of time, the at least one extended part is windowed using a window function accounting for the sample extension, i.e., for the overlap. A specific window that has been shown to be very useful for the purpose of RIR processing is the Tukey window that has lobes with a width of 2n, wherein n is the certain number of samples used in the extension of a part.

Alternatively, a Tukey window is selected such that at the overlap portions, an overlap of advantageously n=16 samples occurs. The overlap can be in a range of between 8 samples and 32 samples as well. The rest of the samples maintains its amplitudes of 100 percents, i.e., a windowing factor of e.g. 1. Hence, there is a Tukey window with a small amount (e.g. 16) of samples as a lobe yielding seamless transition characteristics between the corresponding two parts of DS and ER, and/or ER and LR.

A further issue related to this aspect is the integration of the initial time delay gap (ITDG) that can advantageously be performed in this overlap range between the direct sound part and the early reflection part. Therefore, a moving of the ITDG back and forth is non-problematic, since the overlap range will typically be larger than the ITDG maximum movement area. Therefore, even though the overlap will not be ideal anymore, when a movement with respect to ITDG has been performed, this has nevertheless found to be sufficiently accurate.

This invention describes an unprecedented system for the auralization of binaural audio. It uses acoustic and geometric properties of the environment to synthesize precisely locatable virtual sound sources, which seem to embed neatless into the physical environment around the user. The binaurally rendered sound sources can be perceived at a stable position in space and seem to originate from outside of the head, which is called “externalization”. With the system, virtual sound sources can be perceived as indistinguishable from real sound sources. This is achieved by combining filters of the sound source (Directivity Transfer Functions—DTFs), the acoustic influence of the environment (Room Impulse Response—RIR) and the listener's head and body (Head-Related Transfer Functions—HRTFs) to obtain the Binaural Room Impulse Response (BRIR). Processing of the binaural signal, reactive to the users motion and acoustic environment, enables the externalization of sound and interactivity with the system. Applications of the described system and methods include digital audio reproduction, multimedia applications including virtual reality and augmented reality.

In its most basic embodiment, the system consists of a single device, which contains all necessary sensors, components and sound transducers. The system might include the necessary components in a headphone or ear plug form factor and do all processing directly on the device. In other embodiments, the system works on distributed devices. The disclosed system consists of three principal, functional components, which work together to create a binaural signal in real time. The first component provides an omnidirectional RIR such as an RIR recorded from an omnidirectional loudspeaker or with an omnidirectional microphone or advantageously with both omnidirectional elements, which has desired acoustic properties and contains the relevant acoustic cues of the environment. This especially includes the frequency dependent energy distribution of the reverb over time. In one form, the RIR provider holds qualitative in-situ measurements of the RIR. utilizing a loudspeaker and an omnidirectional microphone. Supplementary, the system can estimate (psycho-) acoustic parameters of low quality RIR measurements or surrounding noise and synthesize RIRs from these parameters or pick suitable higher quality RIRs from a database. This system also incorporates a machine learning approach, e.g. for supporting the parameter estimation. If necessary, multiple RIRs can be blended to improve on transition areas between different acoustic environments, e.g. coupled rooms.

The second component is a Binaural Synthesizer, which takes a RIR and adds binaural cues to it, turning the RIR into a BRIR. The Binaural Synthesizer further receives room geometric information as an input. In an embodiment, the room geometric information consists of a shoebox geometry, which approximates the users real environment, by fitting a rectangular room consisting of six surfaces. This gives estimations about acoustically reflective surfaces in the environment, especially floor, ceiling and walls close to the listener. While the simplification by the shoebox room geometry already yields good results, improvements can come from more accurate geometry models of the room. The RIR itself is processed in split segments motivated by basic research in the field psychoacoustics. The direct sound describes the first sound wave that directly reaches the listener. Here, influences are given by the according HRTFs and DTFs as well as the distance law for sound propagation. These cues can be applied straight forward. For the reflections in the room represented in the RIR, there is a transition from specularity to diffuseness. The given RIR is combined with phase information from a binaural noise sequence to yield the diffuse layer of the BRIR. The early reflection segment is split into blocks, that are assigned with an estimation for the ratio between specular and diffuse energy. The blocks are convolved with HRTFs and optionally DTFs to get the directional part, which is layered with a snippet from the diffuse part on the according indices. After combining the three segments, a BRIR is complete.

The binaural synthesizer is connected to positional sensors, which are able to determine the user's head rotation and additionally its position relative to a reference system. These pose information (“pose” stands for listener position and listener orientation or source position and source orientation) are provided in real time by the position tracking system. The virtual source poses are provided by a preset, optionally changing over time as moving sound sources. The Binaural Synthesizer is connected to a system, which yields measured or synthesized HRTFs corresponding to directions of arrival. Similarly, a part of the system deploys directivity transfer functions (DTF) of a sound source, depending on the relative position. Like for HRTFs, the DTFs might be derived from measurements or a synthesis process. The synthesized BRIR is sent to the Auralizer, where it is convolved with an Audio Signal in real time. For this, a state of the art blockwise realtime convolution method might be used.

The resulting binaural audio signal is then played back over headphones, but cross-talk cancelled loudspeakers might also be employed. In order to keep the illusion of an externalized sound source plausible, the BRIRs need to be resynthesized regularly with current positional data. In some embodiments, the three segments might be calculated at different rates while maintaining the immersive experience. The described system represents a novelty in the field of binaural synthesis. It makes it possible to experience life-like virtual, spatial sound.

A system for plausible binaural reproduction of digital audio is described. It allows the auralization of virtual sound sources (sound sources that don't exist in the real listening environment of the user), by finding and incorporating a Room Impulse Response (RIR) similar to RIRs belonging to the actual room, without measuring it directly.

RIRs are impulse responses, which describe the combined filter effects of the sound source, sink and the exact influence of the room (environment) on an acoustic signal, for a specific configuration of those elements. As such, measured RIRs are, among other influences, dependent on the position and spectral characteristics of both source and sink. Similarly, a Binaural Room Impulse Response (BRIR) describes the filter effects of a source, the local influence of the environment and the influence of the human anatomy (e.g. outer ear, head shape and torso).

Described hereafter is a solution to derive BRIRs for arbitrary configurations of the involved components, even new positions of virtual sound-sources, and use them for binaural synthesis and rendering in a real time scenario. This allows the rendered sound sources to be perceived stably externalized outside of the head.

The solution divides the problem into three parts, that are parts of the processing chain:
1. derive a new RIR from available audio recordings, that take room acoustics into account;
2. use the RIR to extrapolate BRIRs for the specific configuration of listener, source and room to be auralized;
3. playback of the binaural audio to the user of the device.

All of the processing steps entailed might be done on a single device, combining all the sub-systems entailed. In its most basic form however, it consists of two systems, connected by a network.

It is furthermore to be mentioned that the above three parts can be applied independently from each other, where the corresponding other two parts are not implemented as described but via alternative solutions. Or, for a most advantageous result, the three parts can be implemented together. Alternatively, only two of the three parts can also be combined but the remaining part is not implemented as described but via alternative solutions.

The first system consists of at least one microphone (or an array of microphones), at least one processor and playback devices capable of delivering binaural audio, such as headphones or speakers, as well as a device capable of measuring user (head-) position and movement in the environment, like an IMU or optical tracking system. This second system consists of at least one processor and non-transitory memory.

This invention describes a system for the auralization of binaural audio. It uses information about the user's physical environment, in the shape of a impulse response or reverberated audio signal. It acquires its acoustic properties, to synthesize well externalized, precisely locatable virtual sound sources, which seem to originate from the physical environment around the user.

Inventive audio rendering systems allow users to simulate and listen to virtual sound sources, which are precisely localizable in space. The simulated sounds seem to originate from outside of the head, which is called “externalization”. With an appropriate system, binaurally rendered sound sources can be perceived at a stable position in space and seem to have similar acoustic properties to real sound sources. This can make them virtually indistinguishable from real sound sources.

This effect is achieved by precisely controlling the sound, which arrives at the ear drum of the user. Typically, two loudspeakers are employed, each approximately reproducing (or auralizing, “making audible”) the sound, which would arrive at the listeners ear. One can play back the reproduced audio signal directly at the ear using headphones. Alternatively, cross-talk canceled loudspeakers might be employed at a further distance from the users ear.

Embodiments use psychoacoustic knowledge to both decrease the computational complexity of the system and to allow a distributed calculation of the binaural synthesis on devices, which are connected by transmission channels which add a greater delay to the signal processing than is otherwise acceptable.

BRIRs combine multiple filter effects. They can be split at arbitrary points in time, resulting in any number of sub filters. They can then be reassembled by either summing the individual parts, with respect to their individual delays, or by convolving the filter with a full or partial signal and summing the resulting signals with respect to their individual delays. The same basic segmentation and summation process is also valid, when parts of the auralized signal or all of it are not processed by means of convolving a BRIR with a signal, but instead are simulated directly, i.e. by using methods based on delay networks.

By using psycho acoustic domain knowledge about how different parts of the binaural filter are perceived differently, a rendering system can be designed in a way, that it calculates less important parts of the filter less often and distributes those calculations between devices.

In one form, the system consists of a single device, capable of synthesizing and auralizing a binaural signal in real time. It includes at least two loudspeakers, which are able to reproduce the sound for one ear each, i.e. all types of common headphones or crosstalk-canceled speakers.

The system further includes one or more positional sensors, which are able to determine the head rotation of the user relative to a reference system. (This is commonly called three degree of freedom or 3DoF tracking.) In a different embodiment, the system includes one or more positional sensors instead, which are able to determine the head rotation of the user relative to a reference system, plus their position relative to the reference system. (This is commonly called six degree of freedom or 6DoF tracking.) The system is able to process the binaural filters or to directly simulate the auralized signal, by employing one or more adequate binaural synthesis algorithms. It does not depend on one specific method of auralization. Different embodiments of the system might use different binaural synthesis algorithms.

In this embodiment, the used binaural synthesis algorithm must be capable of calculating the filter for the direct sound path and the room reverb separately. Auralization of the direct sound path is typically achieved by blockwise convolution of a filter, which approximates the filter effects of the users head, ears and torso in relation to a sound source at a given position and distance (the HRTF), with the audio signal.

Processing of these filters needs to encode correct changes in the inter-aural-time-difference (ITD) and inter-aural-level-difference (ILD) as well as changes in the sound intensity and other cues. Human listeners are comparatively sensitive to even small changes in these values, which is why it is necessary to calculate these changes with good spatial- and time-resolution. These filters are however comparatively short and deriving them usually involves only few processing steps.

The room reverb simulates the filter effects on the sound which are caused by the environments geometry for sound which does not travel on a direct part from the sound source to the users ears. This includes reflection, refraction, absorption and resonance effects. Such a reverb filter is expected to be much longer than the short direct sound filter. A number of processes and algorithms and systems are capable of processing adequate binaural reverb, such as the image source algorithm, raytracing, parametric reverberators and a number of delay network based approaches.

In this embodiment, the system uses the fact, that human listeners are more sensible to changes of the direct sound filter and less sensitive to changes of the reverberation filter. The signal processor is programmed in a way, that it calculates the direct sound filters far more rapidly than the reverberation filters. This allows the system to minimize clearly audible jumps of the auralized sound, when filters are exchanged and increases the sensation of externalization, while avoiding full filter updates. Updating these filters or signal parts encoding the direct sound path at a rate of about 188 Hz has proven to be a sensible default for such a system, but lower refresh rates (like 94 Hz or 50 Hz or even lower and more than 15 Hz) might be feasible in different embodiments of the system. The reverb filters are calculated at a much lower rate, typically at most one tenth of the direct sounds processing rate, depending on the acoustics of the environment and the user.

Either the signal processor, or another processor is configured as an aggregator. In some embodiments, in which the employed binaural synthesis methods return a continuous stream of blockwise binaural audio signals, this aggregator simply sums up the blocks supplied by the direct- and reverberant processing paths and acts as a signal aggregator. This requires, that the blocks to be summed correspond to the same point in time or contain control data that identifies the time frame they correspond to. Alternatively, the aggregator can be configured to sum up the two partial filters, with respect to their time delays, as determined by the algorithms. It therefore reconstructs a full BRIR filter from the individual processors results and acts as a filter aggregator. The filter can then be used to convolve audio signal blocks using state of the art realtime (blockwise) convolution methods. The aggregator keeps a full BRIR filter in its memory at all times. The BRIR can therefore be partially updated at the individual rates of the individual processors, which process the partial filters. The resulting signal blocks contain the combined binaural signals for the direct sound path and the reverberation path. They are then passed to a loudspeaker signal generator, to be played back over the system's loudspeakers. The loudspeakers can be speakers in a wearable device or cross talk cancellation speakers or any speakers such as speakers placed with some kind of sound separation element in between. This enables auralization of binaural audio with a similar level of externalization and perceived quality to those of the individual algorithms, while lowering processing requirements significantly.

A further part or aspect of the solution receives the previously derived RIR as an input and synthesizes a BRIR from it. It uses further metadata, like available positional data of both the room, the listener and the sound source, for the synthesis process. The system tracks the users position, relative to the source to be auralized and the real room, using a tracking system, consisting of one or more sensors, like an IMU or an optical tracking device. It receives metadata about the virtual sound sources position and a (individual or general) HRTF set. More metadata, like real or virtual room geometry, sound source directivity, sound source boundaries etc. might be optionally supplied. For processing, the system might split the received RIR into arbitrary time-segments, which can be processed in parallel with different algorithms and at different intervals. In one embodiment, the RIR is split into three parts, including direct sound, early reflections and late reverberation. The direct sound segment is truncated in a way, that it contains the part of the RIR that contains the sound directly transmitted from source to receiver, but does not contain the first reflection arriving at the receiver. The late reverberation segment might start at a point, after which no single, strong reflections are perceptible anymore. The segments are windowed appropriately, for instance using overlapping Tukey windows, so that they can be reconstructed later. The relative position of listener and source determines the incidence direction of the direct sound, which is used to select a fitting HRTF from the set, either directly or by interpolation, to convolve it per channel with the direct sound segment of the RIR.

For the full length of the two reverberant parts, a pseudo-diffuse RIR is calculated by modeling the frequency dependent energy envelop of the RIR onto the binaural white noise (a signal with uniformly distributed energy over all frequency bands, but the phase information of the perfectly diffuse field of a BRIR), while retaining the phase information of the high density reflection pattern. This can be done by separating frequency bands using a perfect reconstruction filter bank, determining bandwise, lowpassed envelopes and multiplying the noise signal with it. Alternatively, RIR and binaural noise can be transformed to the time domain, for instance by using a STFT, before applying the magnitude of the RIR onto the noise while keeping the phase and transforming it back to the time domain. The hereby derived pseudo-diffuse part, windowed accordingly, is used by the system as the late reverberation of the BRIR.

The early reflections segment of the RIR is further windowed into sub-windows, which may or may not correspond to the location of single- or multiple early reflections. Similar to the direct sound, each of the detected sub-segments is assumed to have an incidence direction, if it corresponds to an early reflection. This direction of arrival is either derived from a room model of appropriate complexity, using an algorithm like the image-source algorithm, or chosen statistically. A HRTF is picked or interpolated based on that direction and convolved with the sub-segment. To overcome the sparseness of this approach, the system mixes the pseudo-diffuse part with the fully directional (“specular”) part, to simulate diffuseness from reflections arriving at a similar time, and/or non-linear parts of the RIR.

For that, a function to determine a coefficient for the diffuseness of each window is used, to linearly interpolate between diffuse- and specular parts for each sub-segment. An appropriate function might be formed out of the energy ratio of the lowpassed average energy in a small window around the signal, to the ratio of the lowpassed average energy in a larger window around the signal, therefore approximating the ratio of local energy in relation to the short term average energy, as a predictor for masking effects.

The resulting sub-segments are then windowed and reassembled. Depending on the used signals and HRTFs, further post processing like diffuse field or headphone equalization might be applied. An embodiment of the system might use additional knowledge of the room or even metadata, to preprocess the RIR to adjust characteristics of the room. For instance, the late reverberations energy decay might be adjusted, or the time of arrival of the early reflections might be further adjusted by inferring them from the reflection model. The resulting BRIR is convolved with an audio signal, using blockwise convolution, resulting in a real time auralization.

The solution in its entirety further minimizes room-acoustic divergence and can be adjusted to the user using individualized HRTFs. This allows it to be used in auditory augmented reality scenarios.

### BRIEF DESCRIPTION OF THE DRAWINGS

Subsequently, embodiments are discussed with respect to accompanying drawings, in which:

FIG. 1 is a general diagram indicating advantageous basis for the seven aspects;

FIG. 2 illustrates an implementation of the two-channel synthesizer illustrating the procedures for the first to fourth aspects and the seventh aspect of the present invention;

FIG. 3a illustrates an procedure for the first aspect and/or the second aspect;

FIG. 3b illustrates a table for indicating what has to updated under a certain condition;

FIG. 4a illustrates a magnitude representation of the room impulse response/room transfer function in three-dimensions;

FIG. 4b illustrates the room impulse response when the direction of emission is the one indicated in FIG. 4a, i.e., an emission to the front of the sound source;

FIG. 4c illustrates a directivity transfer function for the directivity impulse response of FIG. 4b;

FIG. 5a illustrates an implementation of the first aspect;

FIG. 5b illustrates a further portion of the advantageous procedure in accordance with the first aspect;

FIG. 5c illustrates a further processing in accordance with the first aspect;

FIG. 5d illustrates a further procedure in accordance with the first aspect;

FIG. 6a illustrates a three-dimensional sphere for the purpose of determining/selecting head related transfer functions or head related impulse responses;

FIG. 6b illustrates the left HRIR and the right HRIR when the user is on a front/left position illustrated in FIG. 6a;

FIG. 6c illustrates the left and the right HRTFs for the corresponding HRIRs of FIG. 6b;

FIG. 7 illustrates an implementation of the second aspect of the present invention;

FIG. 8a illustrates the generation of image sound sources up to the first order reflections;

FIG. 8b illustrates a procedure for a second aspect of the present invention;

FIG. 9 illustrates an implementation of the second aspect;

FIG. 10a illustrates an embodiment of the third aspect of the present invention;

FIG. 10b illustrates a further embodiment of the third aspect;

FIG. 11a illustrates another implementation of the third aspect;

FIG. 11b illustrates an embodiment for the combination of the specular part and the diffuse part in accordance with the third aspect;

FIG. 12a illustrates the initial time delay gap;

FIG. 12b illustrates an application of the initial time delay gap for the third aspect or the seventh aspect;

FIG. 12c additionally refers to the initial time delay gap (ITDG) in the implementation in accordance with the third and the seventh aspect;

FIG. 13a illustrates an implementation of the fourth aspect;

FIG. 13b illustrates an embodiment of the fourth aspect of the present invention;

FIG. 13c illustrates an implementation of the fourth aspect;

FIG. 13d illustrates a further procedure in accordance with the fourth aspect of the present invention;

FIGS. 14a-e illustrate different implementations specifically relating to the fifth aspect or the other aspects;

FIG. 15 illustrates an implementation of a required hardware for the first device on the one hand and the second device on the other hand in accordance with the sixth aspect of the present invention;

FIG. 16 illustrates an implementation of the fifth aspect of the present invention;

FIG. 17a illustrates real embodiments of the fifth aspect;

FIG. 17b illustrates another embodiment of the fifth aspect;

FIG. 17c illustrates a further embodiment of the fifth aspect;

FIG. 18 illustrates a further embodiment of the fifth aspect or the seventh aspect;

FIG. 19 illustrates a schematic representation of an embodiment of the sixth aspect;

FIG. 20 illustrates a further embodiment of the sixth aspect of the present invention;

FIGS. 21a-b illustrate different embodiments for the audio sound generator;

FIGS. 22a-f illustrate a further embodiment of the sixth aspect of the present invention;

FIG. 23a illustrates an implementation aspect of the present invention where the sound generator uses a full two-channel acoustic data set for the generation of the two-channel audio signal:

FIG. 23b illustrates an alternative embodiment, where the same audio signal is convolved with the individual two-channel data segments and the individual regenerated binaural audio signals are combined with each other;

FIG. 24a illustrates an embodiment in accordance with the seventh aspect;

FIG. 24b illustrates a further processing in accordance with the seventh aspect;

FIG. 25 illustrates another implementation of the seventh aspect with an integration of the ITDG adjustment; and

FIG. 26 illustrates an implementation of the ITDG adjustment in accordance with the seventh aspect or the third aspect of the present invention.

### DETAILED DESCRIPTION OF THE INVENTION

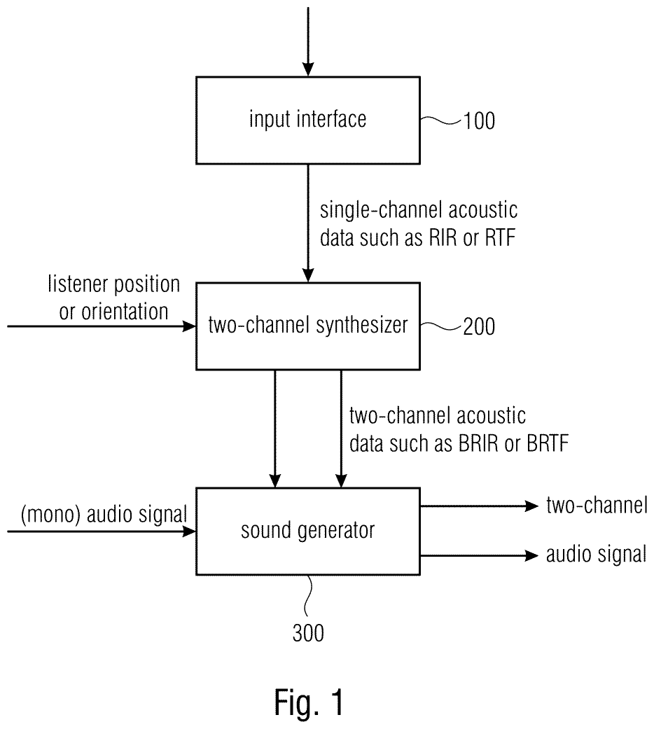

FIG. 1 illustrates an input interface 100 that can receive several inputs as will be described later on, and that provides a single-channel acoustic data describing an acoustic environment. The single-channel acoustic data can be a room impulse response or a room transfer function or any other description that describes an acoustic environment such as a room or an open room or a semi-open room. The acoustic environment can also be an environment out of room depending on the situation. Typically, the acoustic environment will comprise reflection objects such as room walls, furniture, etc. or absorption objects such as persons in a room or curtains in a room or any other “acoustic objects”.

The audio signal processor additionally comprises a two-channel synthesizer for synthesizing two-channel acoustic data from the single-channel acoustic data using a listener position or orientation as illustrated in FIG. 1. The result of the two-channel synthesizer 200 is a two-channel acoustic data such as a binaural room impulse response or a binaural room transfer function or any other two-channel impulse response or transfer function as the case may be. Other descriptions from the impulse response or the transfer function can also be applied as the acoustic data such as a certain parameterization, etc.

The two-channel acoustic data is input into a sound generator for generating the two-channel audio signal from an audio signal which is typically a mono signal also illustrated in FIG. 1 and the two-channel acoustic data received from the two-channel synthesizer 200 of FIG. 1. The input interface can also be termed in this specification as the RIR provider. Further, the two-channel synthesizer is also termed to be a binaural synthesizer and the sound generator is also termed to be an auralizer in this specification. Nevertheless, both descriptions mean the same thing, i.e., the RIR provider is generally an input interface, the binaural synthesizer is a general two-channel synthesizer and the sound generator is a general auralizer.

The two-channel synthesizer 200 is configured to separate the single-channel acoustic data into at least two parts that consist of a direct sound part, an early reflection part and a late reverberation part, and the two-channel synthesizer 200 is configured to individually process the at least two parts for generating two-channel acoustic data for each part.

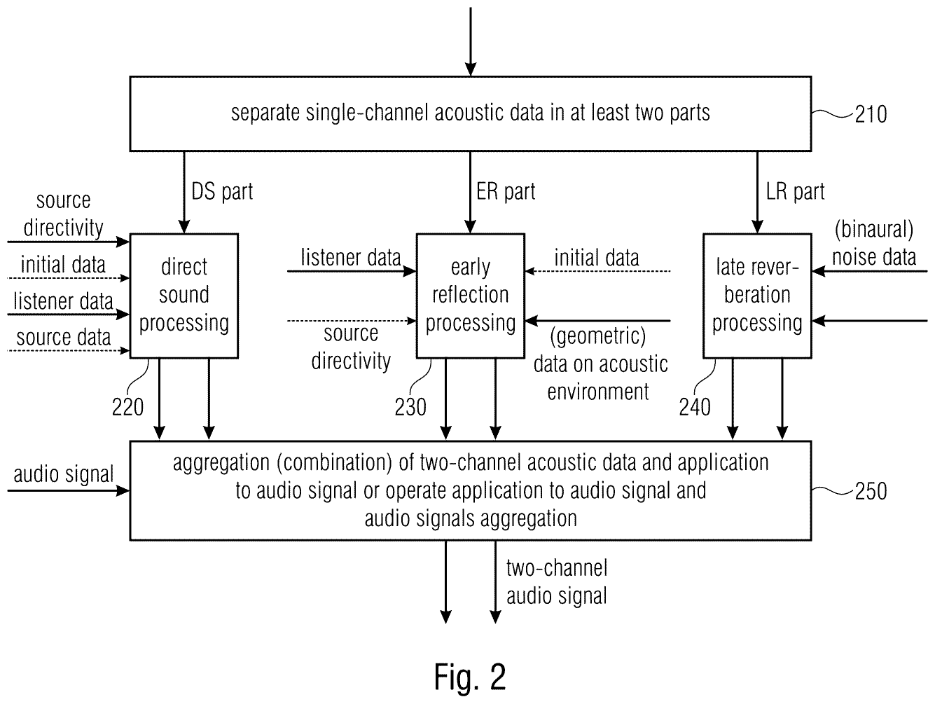

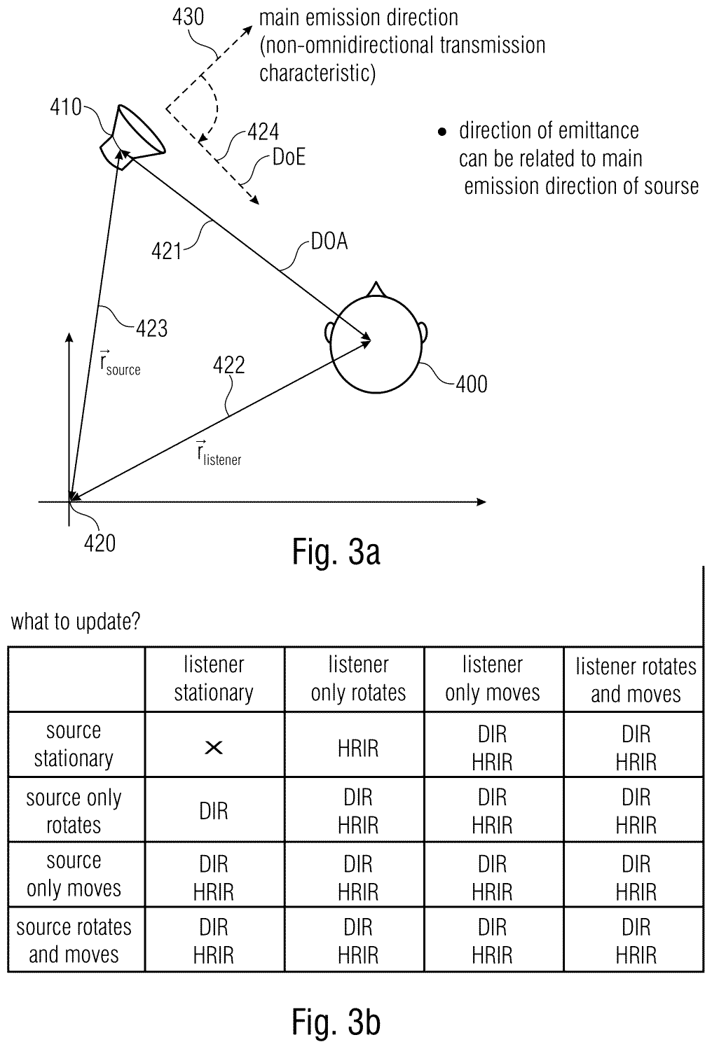

This is illustrated in FIG. 2. In block 210, the single-channel acoustic data is separated in at least two parts. Block 220 illustrates a direct sound processing. Block 230 illustrates an earl reflection processing and block 240 illustrates a late reverberation processing. All three two-channel acoustic data for each part are combined by the aggregation or combination of the two-channel acoustic data as illustrated in FIG. 250. Furthermore, it is to be noted that block 250 covers the two alternatives that can, in general, be performed. The first alternative is the individual parts of a BRIR are aggregated into a full BRIR and, then, the full BRIR is applied to the audio signal by convolution as illustrated in FIG. 3a. The convolution is performed by the sound generator 300 of FIG. 1 that also receives the audio signal.

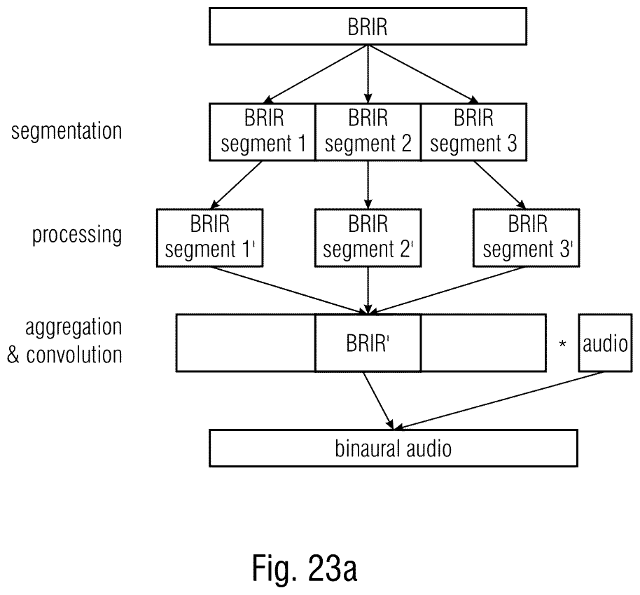

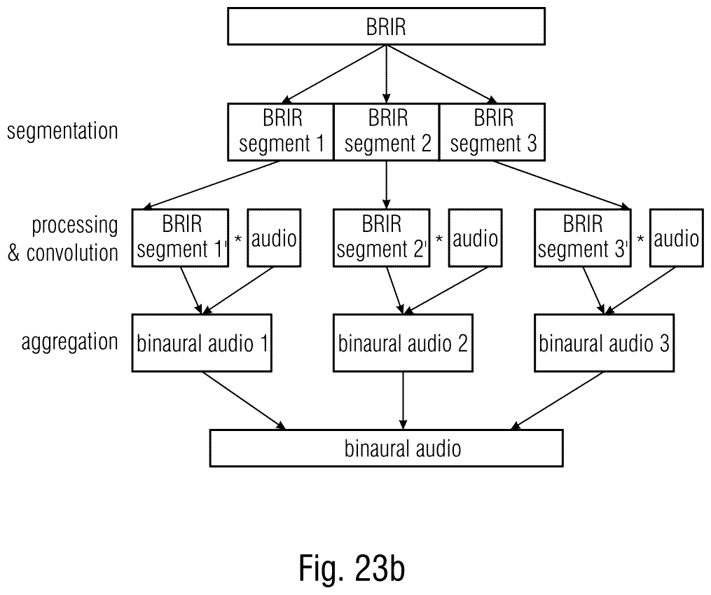

The alternative embodiment illustrated in block 250 of FIG. 2 is also illustrated in FIG. 23b. Here, an aggregation of the individual parts of the BRIR does not take place. Instead, each part is convolved with the audio signal separately so that three streams of binaural audio data are obtained and, then, the binaural audio data are calculated by combining the three individual streams binaural audio 1, binaural audio 2, and binaural audio 3. Thus, the processing with the audio signal and the aggregation of the audio signals is performed by the sound generator 300 as illustrated in FIG. 1.

Furthermore, it is to be noted that, in accordance with different aspects of the present invention, it is not necessary to always process three parts. Instead, for the first aspect, it is sufficient to separate the single-channel acoustic data only in two parts, i.e., the direct sound part and the remaining part of an e.g. RIR. For the purpose of the second aspect of the invention, where the image sources are associated to the individual segments, a separation into three parts is required, since the early reflection part is placed between direct sound part and late reverberation part. For the purpose of the third aspect that refers to the specific merging of the specular part and the diffuse part, a separation into three parts is useful as well. However, for the purpose of the fourth aspect that is related to the specific calculation based on binaural noise, only a separation in two parts is required, the first part comprises the direct sound and the early reflections and the second part comprises the late reverberation. For the purpose of the fifth aspect, any partition is not required at all, and any auralization processing can be performed that requires a single-channel acoustic data describing an acoustic environment, since the fifth aspect is related to provision of the room impulse response rather than how it is processed further on. However, the fifth aspect can, of course, be combined with all other aspects and, therefore, the fifth aspect can also use, in a certain embodiment, a separation as indicated in block 210 in two or three parts. In accordance with the sixth aspect, a separation into at least two parts is required, since the direct sound processing is performed advantageously on the wearable device while the processing of the remaining portion is done on the second device. When three devices are used, then a separation into three portions is required. The seventh aspect that relates to the separation of RIR and the combination of the separated portions, a separation into two parts is sufficient, and the seventh aspect is also advantageously applicable when a separation into three parts has been done. The same is true for the introduction of the initial time delay gap which can also be done in accordance with the present invention, when there does not exist a separation between the early reflections part and the late reverberation part.

In an embodiment illustrated in FIG. 2, the direct sound processing relies on the source directivity, initial source or sink data from the initial measurement, current listener data and/or current source data. In this context, it is to be noted that current listener data referred to as listener position, listener orientation or both also termed to be a listener “pose” in the following text. The same is true for the source data. The source data can be a source position or a source rotation or both, the source position and the source rotation. Specifically, the source rotation can be advantageously accounted for even for non-omnidirectional sources using the source directivity information in accordance with the first or second aspect of the present invention.

The early reflection processing in block 230 relies on the listener position and/or orientation, and geometrical data on the acoustic environment and, typically, initial data such as the association of image sound sources to early reflections. Furthermore, the source directivity can be accounted for in the earlier reflection processing in block 230 as well.

The late reverberation processing 240 relies on the two-channel noise data illustrated as two arrows in FIG. 2 in order to illustrate the transformation of the late reverberation part which is a single channel part into two output channels illustrated at the lower portion of block 240 in FIG. 2.

Embodiments provide a binaural synthesis system, which uses RIR's as and very simplified room geometric data as an input, instead of complex geometric data. It aims to synthesize virtual sound sources, which seem to originate from an arbitrary position around the user. They are stably anchored and react to movements of the listener, like real sound sources would. Applications of the described system and methods include digital audio reproduction, multimedia applications including virtual reality and augmented reality.

Processing of the binaural signal, reactive to the users motion and acoustic environment, enables the externalization of sound and interactivity with the system. The described device contains another system, which sends audio content and all required meta information, described later, to the described system.

In its most basic embodiment, the system consists of a single device, which contains all sensors, components and sound transducers entailed. Such a device has two loudspeakers, one for each ear, which are used to reproduce binaural signals to the user. The system might include the components entailed in a headphone or ear plug form factor and do all processing directly on the device.

The disclosed system consists of three principal, functional components, which work together to create a binaural signal in real time. Different embodiments of the system might include different implementations of these components, however their purpose remains the same.

The first component is a RIR-provider. Purpose of this component is to provide an omnidirectional RIR, which has desired acoustic properties and contains the relevant acoustic cues of the real or virtual environment or a modified version of it. This especially includes the frequency dependent energy distribution of the reverb over time. The exact properties and cues, which the RIR encodes, depend heavily on the embodiment of the system. So does the working mechanism of the component. In one form, the RIR-provider is connected to a single microphone and a loudspeaker. It contains non-transitory memory, which holds one or multiple RIR's.

The RIR's can be recorded by any state of the art measurement method, able to provide a good measurement of the room acoustics. This can for instance be done by playing an exponential sine sweep or minimum length sequence over the loudspeaker and recording the reverberated audio using the omnidirectional microphone within the critical distance of the sound source. Using deconvolution, the RIR can then be calculated from the reverberated recording and the input signal. The recorded RIR's are stored in memory.

The second component is a Binaural Synthesizer, which takes a RIR from the RIR provider as an input. At this point, the recorded Room Impulse Response contains important monaural cues of the rooms acoustics. Binaural information, necessary for spatial hearing and externalized perception by the user, needs to be added to the RIR, turning it into a BRIR. The Binaural Synthesizer further receives room geometric information as an input. In an embodiment, the room geometric information consists of a shoebox geometry, which approximates the users real environment, by fitting a rectangular room consisting of six surfaces into the real environment. The width, depth and height of this shoebox room is provided by the user of the system, whereas the surfaces should coincide with major acoustically reflective surfaces in the real environment, especially floor, ceiling and walls close to the listener. The second component is further connected to one or more positional sensors, which are able to determine the head rotation of the user relative to a reference system. (This is commonly called three degree of freedom or 3DoF tracking.)

In a different embodiment, it is included to one or more positional sensors instead, which are able to determine the head rotation of the user relative to a reference system, plus their position relative to the reference system. (This is commonly called six degree of freedom or 6DoF tracking.) The position and rotation of the user in the reference coordinate system are provided in real time by the position tracking system. The position and rotation of the virtual sound sources can be provided by a preset configuration. In some embodiments, the position of the sound sources might be changed periodically by an external system, representing moving sound sources. In some embodiments, an offset to the position and rotation of the user might be periodically added, e.g. allowing to simulate movement of the users representation in a virtual world.

The Binaural Synthesizer is further connected to a system, which is able to approximate HRTF's, which correspond to a given relative position between a sound source and the user. In one form, such a system might contain a dataset of measured or synthesized HRTF's and the relative position vectors between source and sink (called direction of arrival or DOA) to which they correspond. Given a DOA as an input, it then selects the single HRTF, whose corresponding DOA best matches the input DOA, i.e. by maximizing the scalar product of the two unit vectors. In other embodiments, a suiting HRTF might be synthesized, given the relative positions.

Similarly, the Binaural Synthesizers is connected to a system, which is able to approximate the directivity transfer function (DTF) of a sound source, which is the relative position dependent filter effect of the sound source. Such a system might work by selecting a best match from a database or synthesizing a DTF, like the HRTF system.

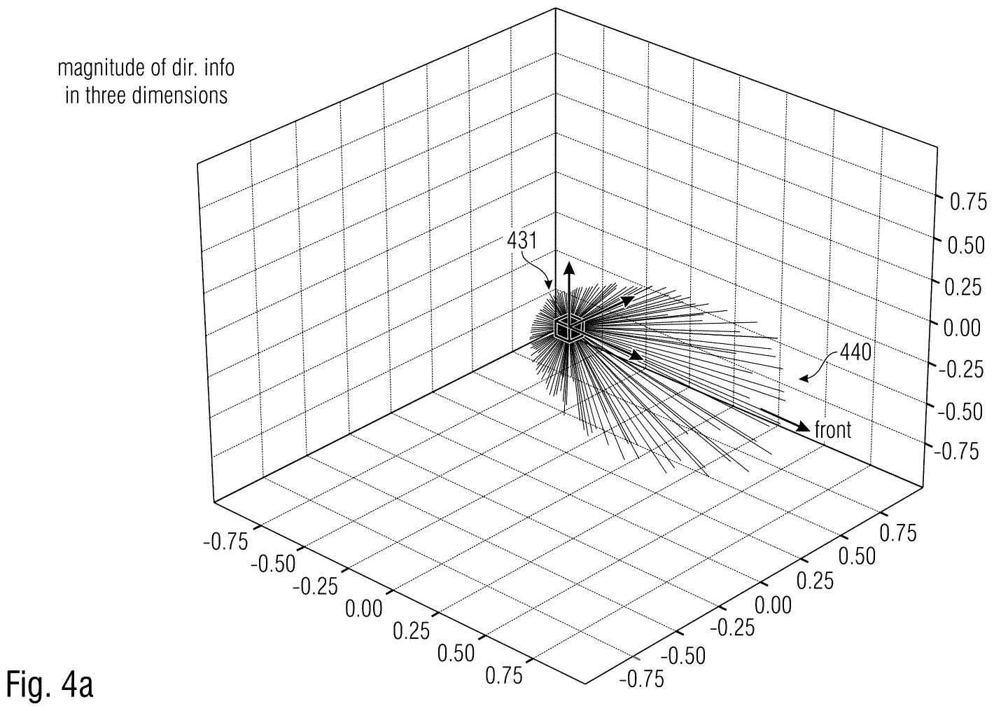

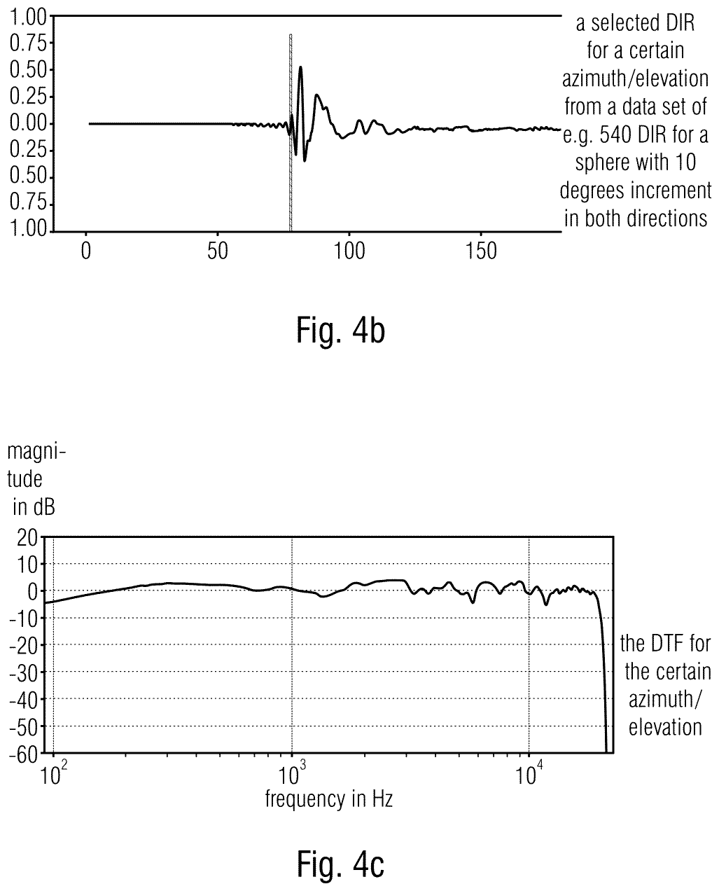

Subsequently, the subject-matter of the present invention in accordance with the first aspect is illustrated in FIG. 3a. FIG. 3a illustrated a coordinate system with an origin 420 and a listener 100 at a listener position assumed to be in the origin of the listener's head when the listener's head is assumed to be a sphere. Furthermore, a source 410 is shown that is directed away from the listener with a main emission direction 430. A non-omnidirectional transmission characteristic is assumed for the source as is, for example, illustrated in FIG. 4a illustrating the magnitudes of the direction information in three-dimensions. As is shown in 431, the magnitudes behind the sound source which is, in FIG. 4a, an exemplary loudspeaker are small compared to the magnitudes 440 in front of the speaker.

Furthermore, in the example in FIG. 4a, the listener is placed in front of the speaker so that a directivity impulse response shown in FIG. 4b is obtained. The directivity transfer function, i.e., the directivity impulse response when transformed into the spectral domain is illustrated in FIG. 4c. Hence, it can be seen that the sound source in FIG. 4a, FIG. 4b, FIG. 4c has a strong non-omnidirectional directivity and, additionally, even in the front has a certain room impulse that, when transformed into the spectral domain, shows a significant non-linear frequency response. It is to be noted that the phases are not illustrated in FIG. 4c, but the directivity impulse response results in a complex directivity transfer function.

In accordance with the second aspect of the present invention, the two-channel synthesizer as illustrated in FIG. 1 is configured to determine, for a certain listener position and a source position and/or orientation of a sound source, a directivity information of the sound source. Furthermore, the two-channel synthesizer is configured to use the directivity information in the calculation of the two-channel acoustic data for the direct sound part as illustrated by the corresponding input into block 220 of FIG. 2.

Particularly, the two-channel synthesizer 200 is configured to determine, in addition to the directivity information, two head-related data channels from the source position or orientation and the listener position or orientation and to use the two head-related data channels and the directivity information in the calculation of the two-channel acoustic data for the direct sound part. Particularly, referring to FIG. 3a, the DOA vector 421 is illustrated as the difference between the listener vector 422 and the sound source vector 423.

Furthermore, FIG. 3a additionally illustrates a direction of emission vector 424 that is directed in the opposition direction as the direction of arrival vector 421. Typically, the directivity information for the sound source is given with respect to the main emission direction 430. Therefore, in order to select the correct directivity information typically from a data set of several directivity information for a sphere around the sound source 410 related to the main emission direction or related to any reference point typically different from the origin of the world coordinate system, in which the location vectors of source and listener are given, the rotation of the sound source 410 has to be accounted for. Thus, since the rotations of the main emission direction 430 with respect to the DOA vector 421 or the DoE vector 424 is about 90° in the exemplary figure, the two-channel synthesizer 200 would, therefore, determine the directivity information that is given for a 90° azimuth angle with respect to the main emission direction 430 of FIG. 3a.

Typically, a directivity information is given as a DIR per azimuth angle and elevation angle, and, in an embodiment of the present invention, there do exist about 540 DIR data sets for a sphere that were measured with corresponding ten degrees differences or ten degrees increments in both, the azimuth direction and the elevation direction.

Alternatively, this information can also be provided via a directivity transfer function (with magnitude and phase or real part and imaginary part) for the certain azimuth/elevation.

Alternatively from providing a full data set, from which the two-channel synthesizer can select an identified directivity information for the correct orientation of the source with respect to the listener, the directivity information can also be synthesized or actually calculated using certain parameters for certain classes of sources. Furthermore, the directivity information can also be given in a lower resolution than exemplarily illustrated as a ten degrees resolution in both directions. Interpolations of selected room impulse responses can be performed as well depending from a current situation to be auralized. In a further embodiment, when the room impulse responses for a certain sound source are not available, these sound sources can be synthesized or measured and stored in a certain memory that is accessible by the two-channel synthesizer.

FIG. 3b illustrates a table indicating what has to be updated under a certain condition of listener movement and source movement. Naturally, when both, the listener and the source are stationary, any changes with respect to the earlier situation do not have to be performed. When the source is stationary and the listener only rotates, then the room impulse response or directivity information will not change, and the rotation of the listener only influences the process that a new head related impulse response or head related transfer function has to be selected that accounts for the positions of the ears with respect to the source in view of the rotation. Another interesting point is that, when only the source rotates and the listener remains stationary, then a new room impulse response has to be calculated, but the head related impulse response remains the same. In all other instances illustrated in FIG. 3b, both, the room impulse response and the head related impulse response change for a certain situation indicated in the table with the title “What to update?”.

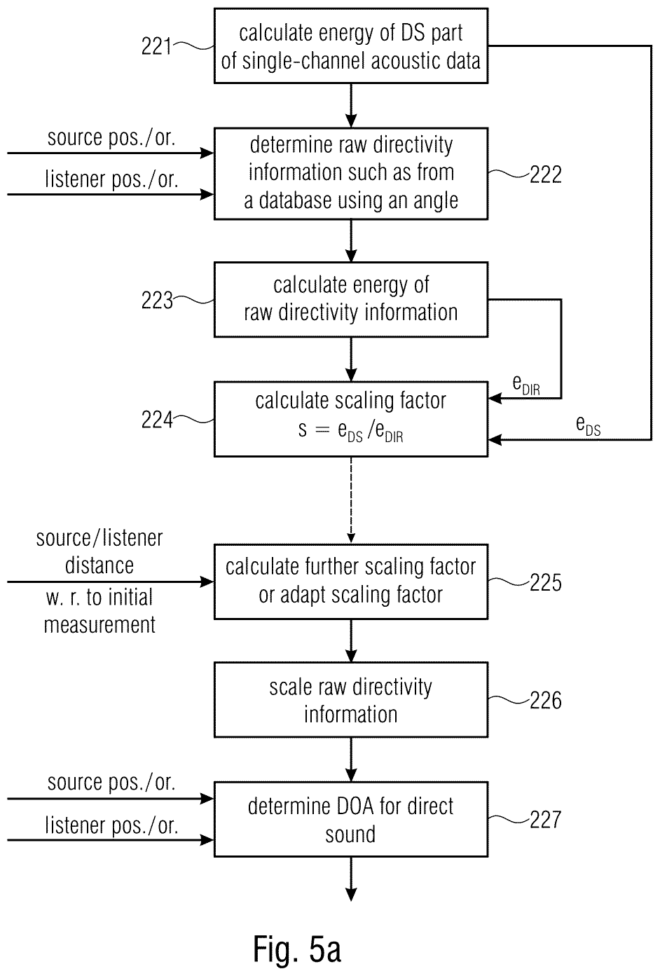

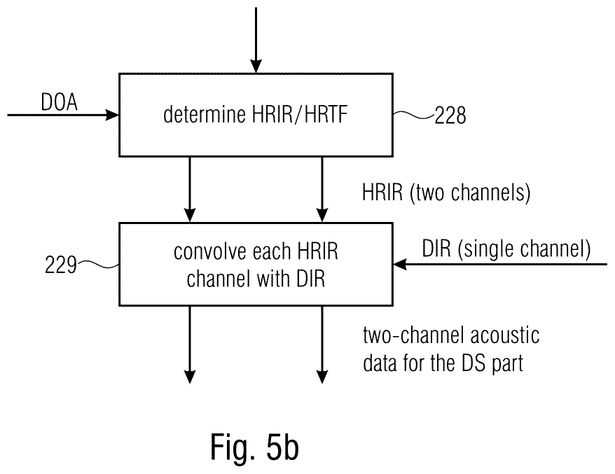

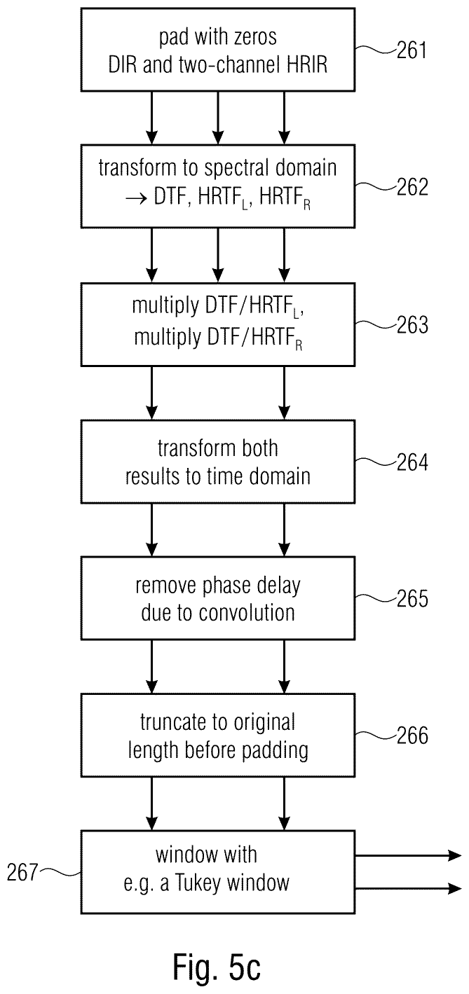

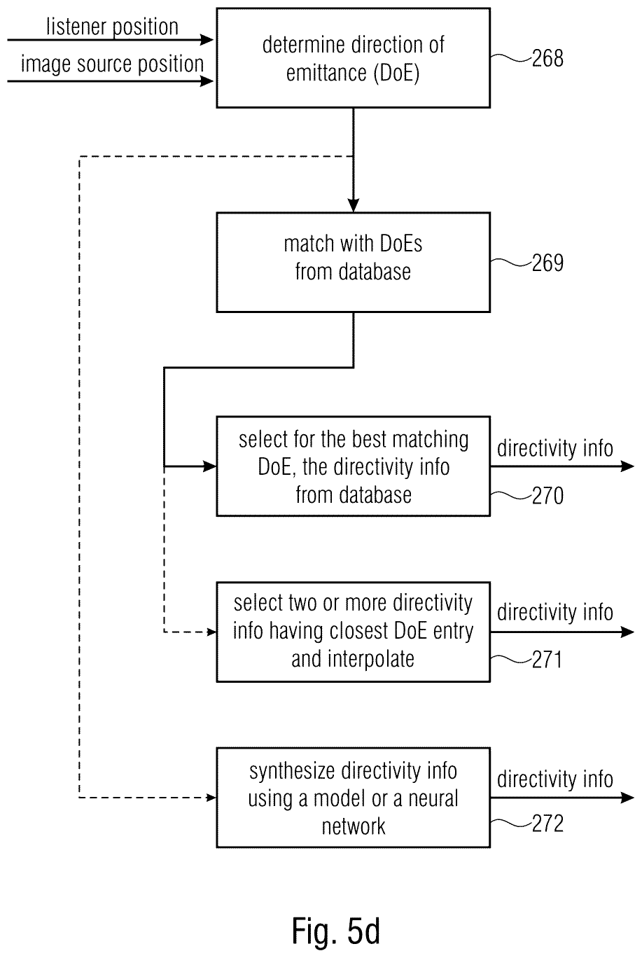

FIG. 5a illustrates an implementation of a specific embodiment. Typically, the direct sound part of the room impulse response is only used for the calculation of the energy in block 221, but is not used later on. Instead, the initial part of the room impulse response provided by the input interface is replaced by the corresponding directivity impulse response selected as discussed with respect to FIG. 3a. In an implementation the energy is related to the frontal DOE. Measurements to determine the three dimensional directivity information are performed in such a way that the microphone is on the sound axis.

Typically, the data set for the room impulse responses as discussed with respect to FIG. 4b will not have the same energy as the first part of the room impulse response provided by the input interface 100. Therefore, depending on the source position or orientation and the listener position orientation, a raw directivity information is determined such as from a database using a certain angle as illustrated in FIG. 5a at 222. Alternatively, depending on the certain angle derived the source position and orientation and the listener position, the room impulse response can also be synthesized.

In block 223, the energy of the raw directivity information is calculated. In block 224, a scaling factor is calculated by dividing the direct sound part energy by all directivity energy. In case of the same distance between the source 410 and the listener 400, the new directivity information is scaled with the scaling factor from block 224 and block 226.

Alternatively, when the distance between the listener 400 and the sound source 410 has changed by means of a movement of either the source 410 or the listener 400, a further scaling factor is calculated in block 225 or the scaling factor of block 224 is adapted. Particularly, the loudness of the source 410 would have to be reduced, when the source moves away from the listener with respect to the initial measurement situation, i.e., when the original room impulse response provided by the input interface has been measured. Then, the further scaling factor will be lowered. When, however, the movement of the source or the listener has resulted in a smaller distance with respect to the initial distance between the source and the listener, the scaling factor has to be increased. For the purpose of increasing or decreasing the scaling factor, the distance law of sound is applied. The scaling factor for the distance correction is done using e.g. the law of distance for sound or similar procedures. A maximum amplification factor is limited in order to avoid that the direct sound becomes too loud, when the listener position comes closer and closer to the sound source position.

In block 227, a direction of arrival for the direct sound is determined as illustrated in FIG. 3a. Then, based on the DOA, the correct HRIR or HRTF is selected as shown in block 228. In block 229, the single channel directivity information as scaled by the scaling factor potentially modified due to a changed distance is convolved with the HRIR. Particularly, the HRIR has two channels, and the directivity information has a single channel and, therefore, the single channel is convolved with the left channel of the HRIR to obtain the first channel of the result of block 229, and the DIR is convolved with the right channel of the HRIR to obtain the right channel of the result of block 229 which is the two-channel acoustic data for the direct sound part.

Thus, the two-channel synthesizer 200 is configured to determine a direction of emission of a source location vector of the source and a listener location vector of the listener and the rotation of the source and to derive the directivity information from, for example, a database of directivity information sets, wherein a directivity information set is associated with a certain angle typically related to the main emission direction or to a certain source emission direction.

Contrary thereto, the direction of arrival for the listener position or orientation is calculated from the source location vector of the sound source and a listener location vector of the listener and a rotation of the listener.

FIG. 5c illustrates further implementations of how the head related impulse response is convolved with the directivity impulse response illustrated in block 229. To this end, block 261 indicates that the directivity impulse response and the two-channel HRIR are each padded with zeros and, then, transformed to a spectral domain in order to obtain three spectra, wherein the first spectrum is the directivity transfer function, the second spectrum is the left HRTF and the third spectrum is right HRTF.

Then, the DFT spectrum and the HRTF_{L} spectrum are multiplied and the DFT spectrum and the HRTF_{R} are multiplied as shown in block 263. The output of block 263 are two spectra that are transformed to the time domain. Then, a phase delay that has been introduced e.g. due to the convolution, i.e., the transformation, the multiplication and the inverse transformation is removed in block 265 and both channels are truncated to the original length that they had before the padding in block 261 and, finally, in block 267, a windowing with, for example, a Tukey window takes place.

The following procedure can be performed in order to obtain at the two-channel audio signal for the direct sound part. The RIR is first preprocessed, to achieve consistent alignment between different inputs to the system. This later enables blending between different input RIR's. Alignment is done by detecting the direct sound, using a suitable state of the art algorithm. Finding the direct sound can for instance rely on a maximum peak detection, if it is guaranteed that the direct sound of the input always coincides with the highest peak. In more complex scenarios, a more robust, state of the art direct sound detection can be chosen.

The first samples of the impulse response are then cut or extended by zero valued samples, so that the detected direct sounds sample index coincides with a predefined sample index, offset from the beginning of the impulse response. The Binaural Synthesis method assumes, that a RIR can be split into three separate filters, which can be processed separately—namely direct sound (DS), early reflections (ER) and late reverberation (LR). The input RIR is then further preprocessed by separating it into these three separate, partial filters. The transition between DS and ER can be chosen in a way, that it maximizes the distance between the detected DS peak and the first reflection. The transition between ER and LR is chosen in a way, that it coincides with the perceptual mixing time of the given acoustic environment. It can either be calculated by a state of the art algorithm or estimated. In some embodiments, the transition between ER and LR can be earlier than the perceptual mixing time, decreasing the computational complexity.

The three segments intervals are then extended by n samples at their respective transition times, so that they overlap by 2n samples. Suitable window functions are chosen, which allow a near perfect reconstruction of the filter segments later on. For instance, a Tukey window function might be chosen, with its lobes 2n samples wide.

The Binaural Synthesis method assumes, that the room acoustic effects can largely be separated into a so called specular reflection component, which assumes that strong, geometric reflections behave like rays and a diffuse component. The specular reflection component can be derived from models like the Image Source Model (ISM) or simulation approaches based on raycasting. The diffuse component is used under the assumption, that a part of the signal can be approximated by a roughly equally distributed diffuse sound field, with high reflection density. It can retain the time and phase relationships of a diffuse field, while modeling the energy distribution of the RIR's reverberant part.

The DS segment contains the combined filter effects of the sound source and the users outer ear and body. Both of these filters are dependent on the relative position between the virtual sound source and the sinks (the listeners ears). Both positions and rotations (of source and sink) are provided as an input to the Binaural Synthesizer.

Given the relative positions, an appropriate HRTF and DTF filter is selected from the respective sub systems. The filters are padded to double their length and then convolved with each other, by multiplying them and transformed back into the time domain, using an inverse Fast Fourier Transform (IFFT). Depending on the used filters, a introduced phase delay can be removed by shifting the filter in time before truncating and windowing it, so that the binaural direct sound filter has the same length as the original filter and the direct sounds center index corresponds to the same sample index as that of the original RIR's direct sound.

FIG. 5d illustrates an embodiment for the determination of the direction of emission in block 268. It is assumed that the database organized with certain direction of emissions. In block 269, a matching with the test direction of emission of block 268 is performed and, block 270, the directivity information for the best matching DoE is selected.

In block 271, an alternative is illustrated. Instead of finding the best matching DoE and selecting the directivity information from the database based on this DoE, two or more directivity information having the closest DoE entry are selected and an interpolation is performed as shown in block 271.

Regarding a further alternative illustrated in block 274, a directivity information can also be synthesized using a model or a neural network and a model based on the test DoE as determined by block 268. Regarding the DoE, reference is made to FIG. 3a indicating that, although the DoE is directed in the opposite direction of the DOA, the DoE is not related to the origin of the coordinate system 420 in FIG. 3a, but is related to the main emission direction 430. Thus, the DoE reflects the situation that the rotation of the source is applied to the vector DOA and the direction is inverted. Other alternatives with other relations to other coordinate systems can, of course, be performed.

As outlined in block 260, it is of advantage to perform a padding to double the length with the directivity impulse response and the first and the second HRIRs to obtain the padded functions and to combine the padding functions by convolving in the time domain or by using a frequency domain multiplication. Furthermore, the phase adjustment indicated in block 265 makes sure that the correct time delay from the zero sample index to a certain index where, typically, the first direct sound part is located is maintained so that a later construction of the full BRIR always relies on a defined situation.

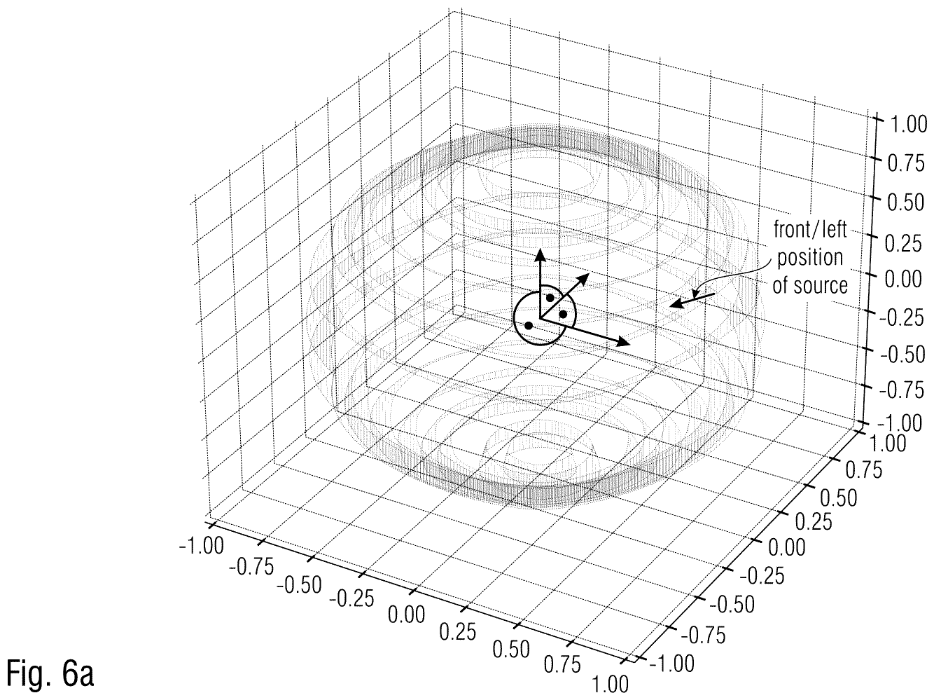

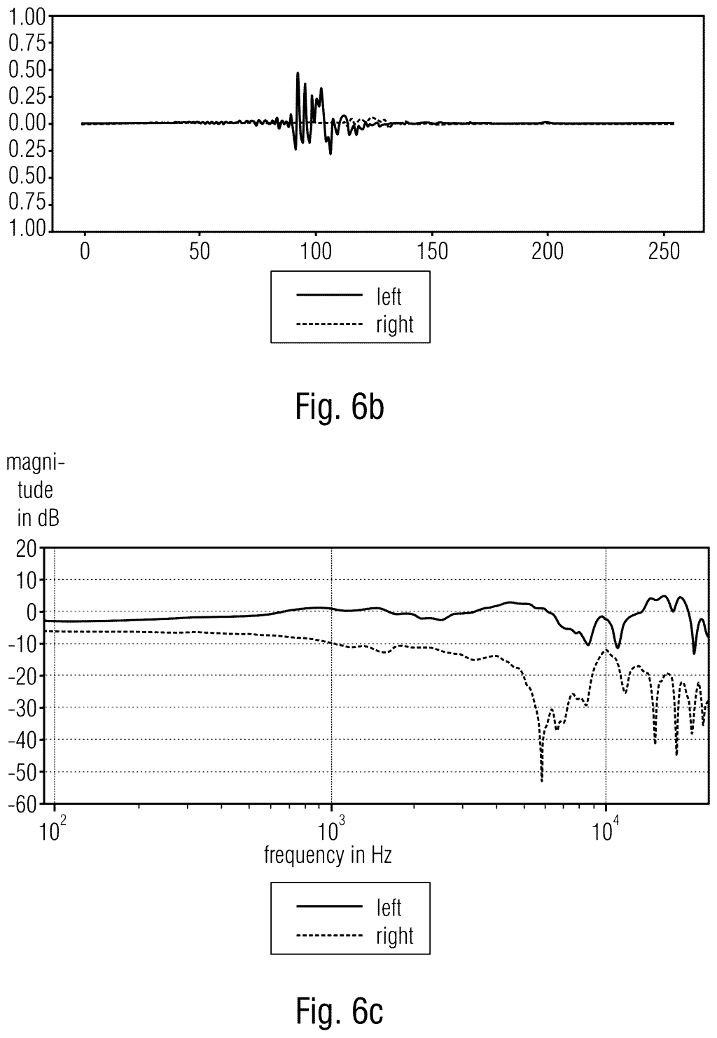

FIG. 6a illustrates a sphere for the purpose of illustrating the HRTF or HRIR concept. Particularly, the illustration in FIG. 6a shows that the user is at the front/left position of the source. The corresponding left and right HRIRs functions are illustrated in FIG. 6b, and it becomes clear that the left HRIR is significantly stronger than the right HRIR and a contribution occurs in the left HRIR before a contribution of the HRIR takes place. This is clear, since the sound from the sound source and the position illustrated in FIG. 6a reaches the left ear before the right ear and the amplitude of the sound that reaches the right ear is attenuated by the head.

The corresponding frequency domain responses are illustrated in FIG. 6c indicating that at frequencies below 1 KHz, the main effect is the difference in amplitude and above 1 KHz, and, particularly, to the higher frequencies, the right HRIR shows a pronounced notch filter effect.

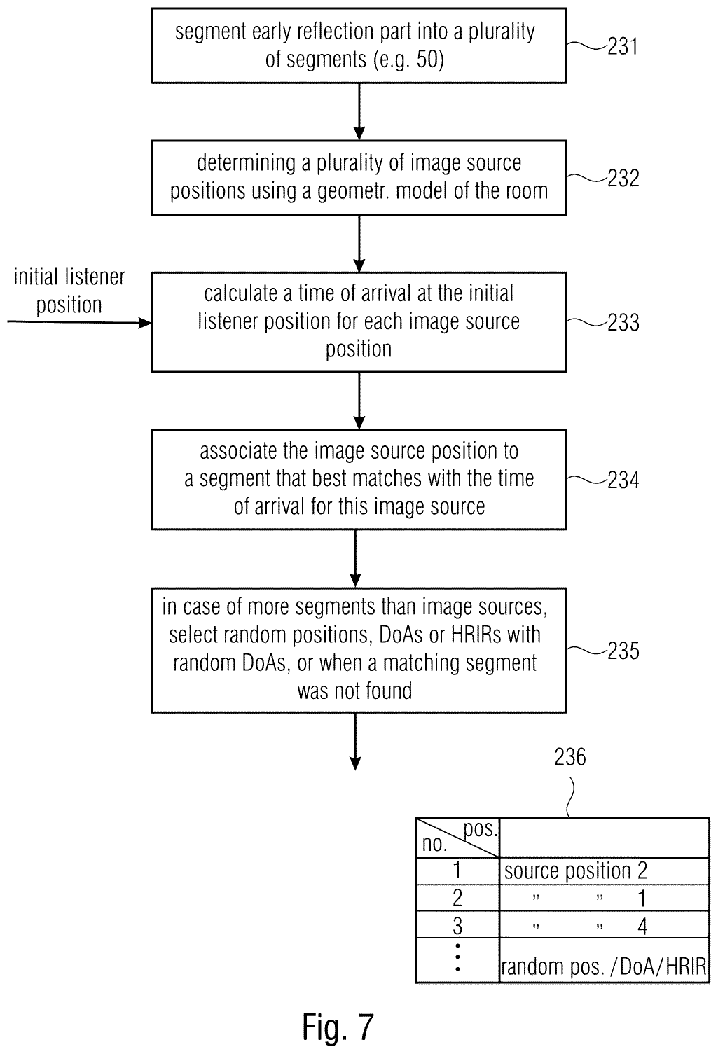

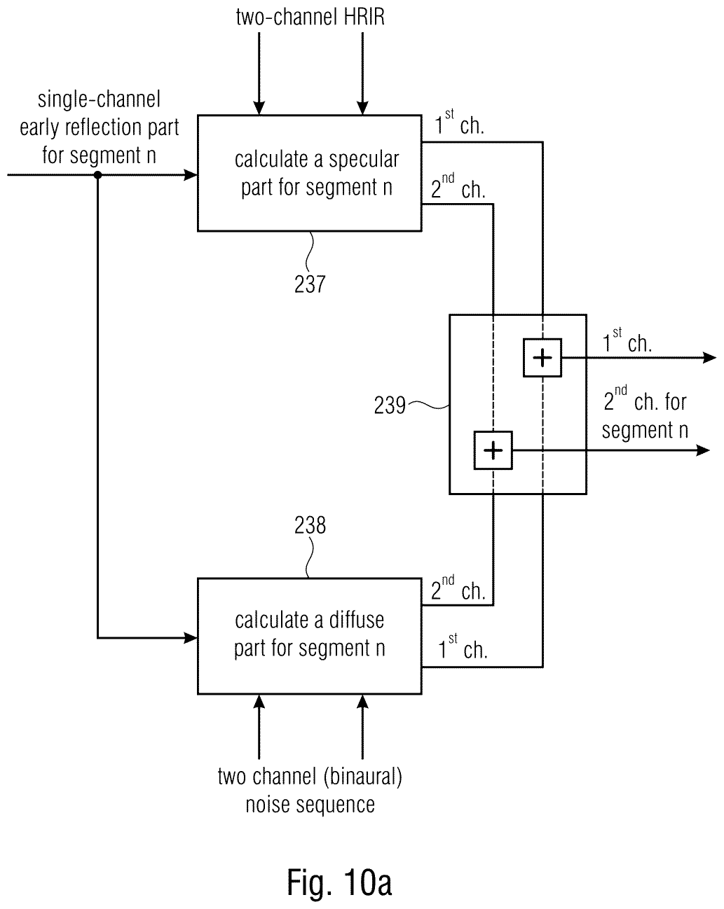

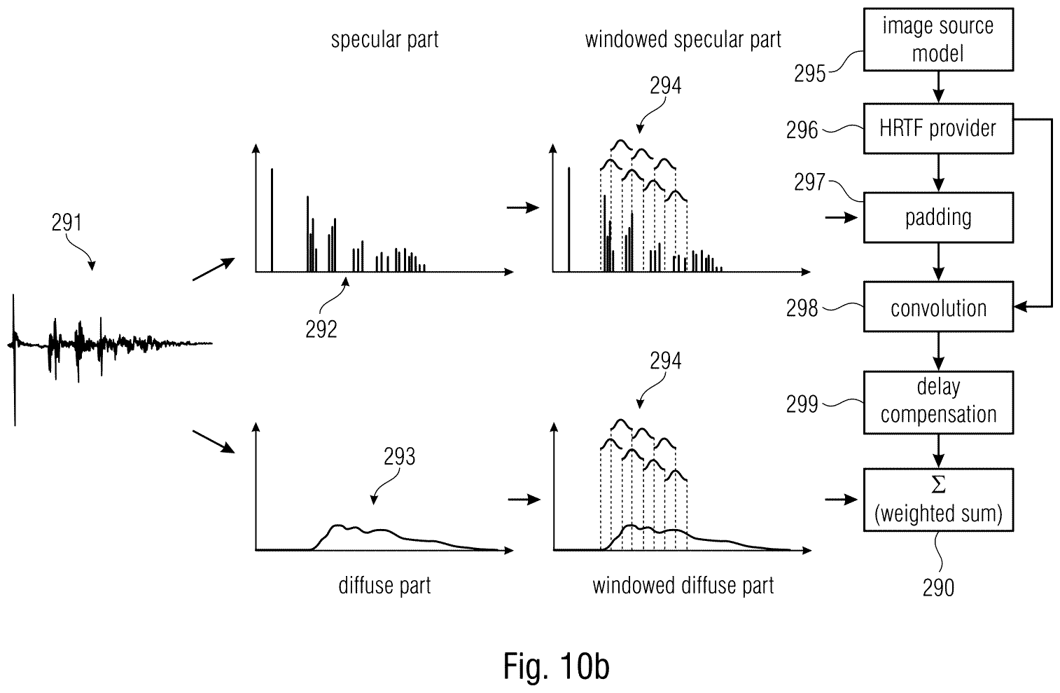

Subsequently, the second aspect of the present invention is described with respect to FIG. 7 and following figures. In accordance with the second aspect, the two-channel synthesizer and, particularly, the early reflection processing block 230 is configured to segment the early reflection part into a plurality of segments as shown in block 231. Exemplarily, FIG. 10b only illustrates four segments 294, but a segmentation can be performed up to fifty segments or more. Naturally, less segments can also be used. In an embodiment, there exist blocks with 256 samples and an overlap of 128 samples. The number of segments is obtained by the length of the early reflection part (direct sound until the mixing time) having roughly 7700 samples. Dividing this number by an advance value of 128 per segment results in about 60 segments. But, the number can vary depending on the length of the early reflection part, the advance value and potential other parameters used.

Furthermore, as shown in block 232, a plurality of image source positions is determined advantageously using a geometric model of the room such as a shoe box model. The image source positions represent source positions of reflection sound. Furthermore, an association of the image source positions to the segments is performed using a matching operation. In the matching operation, a time of sound arrival from each image source to the listener position is calculated as illustrated in block 233. Advantageously, the initial listener position is used for this calculation, so that the initial listener position, i.e., the listener position when the RIR was provided by the input interface is input. Then, the image source positions are associated to corresponding segments that match with the time of arrival for a specific image source in a best way as illustrated in block 234.

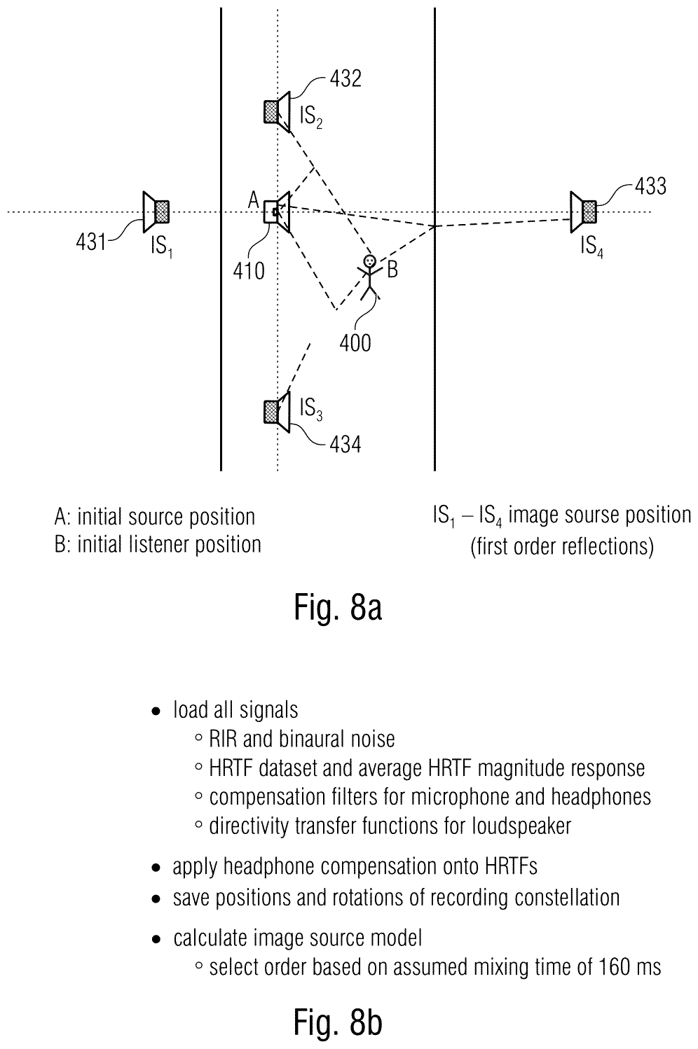

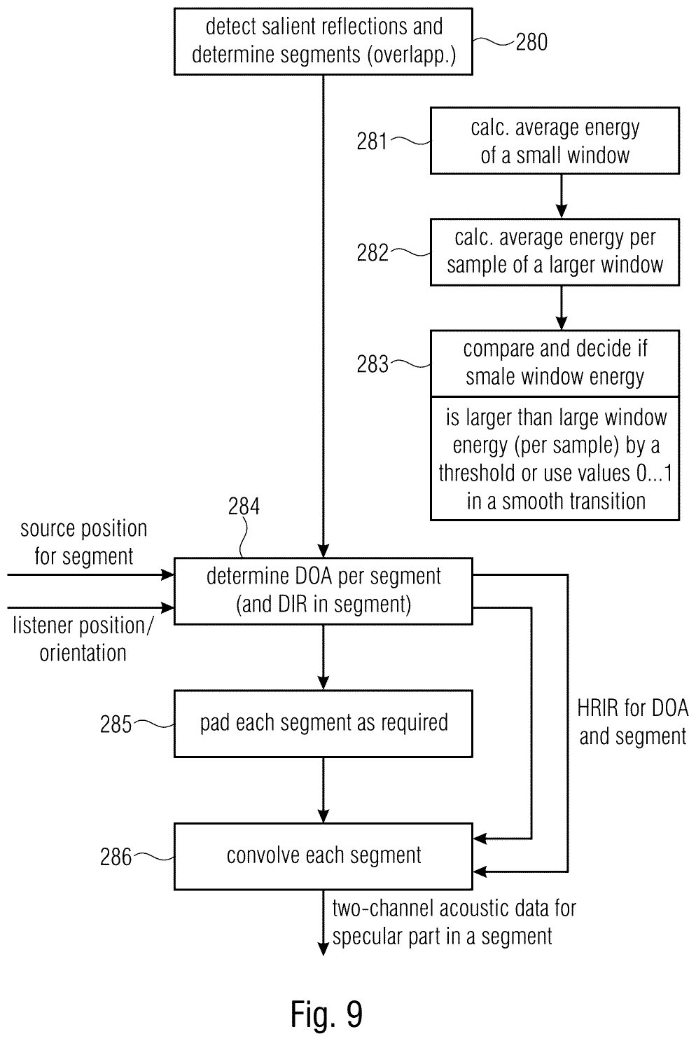

Therefore, the time of arrival for the sound from each image source position to the initial listener position is compared to the time index in a certain segment. Typically, the segments have a certain width and, therefore, for a segment, the time index in the middle of the segment is compared to the time of arrival. When a time of arrival for an image source position is equal to the time index associated with a segment such as the time index in the middle of the segment, then this image source position is associated with this segment for the further calculation such as a calculation of a direction of arrival for this segment. Typically, the image source positions are calculated for the room model up to a certain order. Some first order image source positions being the first reflections are indicated in FIG. 8a. Particularly, FIG. 8a illustrates the listener 400 at the initial listener position and the source 410 at the initial source position. The construction of the four image sources for the (part of) the first order reflections result in image source positions 1, 2, 3, 4 for the image sources 431 to 434. It is to be noted that floor and room reflections that also belong to the first order reflections are not illustrated in the two-dimensional FIG. 8a. The second order reflections can also be constructed and refer to the physical effect that a reflection reaching the listener's head travels on and is reflected at a second wall and, then, reaches the listener again.

Thus, depending on how complex the geometrical model is, a certain number of image sound sources are determined with respect to their position and are associated to corresponding segments. When, for example, fifty segments are used for segmenting the early reflection part, then it is sufficient to determine the image source positions up to an order resulting in fifty sources. However, this can be quite complex and, in order to save computational resources, an advantageous way of doing this is to only calculate image source positions up to a certain order resulting in less than fifty image source positions. The remaining image source positions can be selected in a random way as illustrated in block 235. Therefore, if it has been found that a certain segment results in a non-matching image source associated with this segment, either a random position is associated to this segment or, in the further calculation, a random direction of arrival and, therefore, a randomly selected HRIR is used for the processing of this segment.

The result of this procedure is illustrated in table 236 at the bottom of FIG. 7 illustrating that the first three segments are associated with source position 2, source position 1, source position 4, respectively, and there also exists one or several segments typically in the end of the segments when the segments are counted from the direct sound/early reflection border to the early reflection/reverberation border that do not have a discrete image source position, but that have associated therewith a random source position or receives a random HRIR in the processing of this segment.

As outlined, the two-channel segment is configured to determine the plurality of image source positions using an initial source position and an initial sink position of an initial measurement and geometric data on the acoustic environment. Particularly, the image source method is of advantage as illustrated in FIG. 8a.

In an embodiment of the present invention, the two-channel synthesizer 200 is configured to detect salient reflections and, from these detected salient reflections, overlapping segments are constructed as illustrated in block 280. For the purpose of detecting a salient reflection, the procedures in blocks 281-283 are performed. In block 281, an average energy per sample of a small window sliding over the early reflection part is calculated. In block 282, an average energy per sample of a larger window is calculated again sliding over the early reflection part. In block 283, both average energies are compared sample by sample and it is decided, if the average energy per sample in the small window is larger than the average energy per sample in the large window by, for example, a third certain threshold. This procedure results in segmentation of the early reflection part.

In block 284, the determination of the direction of arrival information per segment is performed. Advantageously, a directivity information as discussed before with respect to the first aspect and, particularly, FIG. 3a can also be performed. This allows to account for the specific orientation the image sources with respect to the listener and, particularly, that, for example, image source IS₁ illustrated at 431 is directed away from the listener 400.

In this embodiment, the two-channel synthesizer is configured to determine, for the listener position and an image source position or orientation of an image sound source, directivity information of the image sound source, and to use the directivity information in the calculation 220 of the two-channel acoustic data for the earlier reflection sound part. Advantageously, the directivity information for each image source is derived from the same set of directivity information determined for the direct sound part, or wherein an orientation of the image sound source is determined by an image source model, and the directivity information is in a specific embodiment determined and used for a predetermined subset of the segments in the early reflection part, which comprises less than ten segments and advantageously only 2 segments. The remaining segments can then be calculated without any directivity information of an image source. The other procedures for the calculation of the directivity can be performed as outlined in FIG. 5a, where for the segment, for which the directivity information is accounted for, the actual RIR segment is replaced by the directivity information weighted by the energy scaling factor as determined by block 224, but using the energy of the corresponding reflection segment. For simplicity reasons it is of advantage to not apply a distance correction such as in block 225, but this can nevertheless be done, when the listener approaches the image source of moved away from the corresponding image source being responsible for the reflection under consideration.

In block 285, each determined segment is padded to a certain length, and particularly, to the length existing for the HRIR database and, in block 286, each segment is convolved with the corresponding DOA-related HRIR for the segment as indicated by the two connection lines between 284 and 286. This procedure results in two-channel acoustic data for a specular part in a segment. In case of only processing the specular part for the early reflection portion of the room impulse response, the result of block 286 can be used for further processing. However, when the second aspect is combined with the third aspect, the diffuse part is processed as well for the earl reflection portion. This will be discussed later on with respect to FIG. 10a.

The ER segment is assumed to consist of a specular reflection component and the diffuse component. In general, the first part of the ER's is expected to be mainly specular, as it contains strong, first order reflections. Later parts of the ER segment are expected to contain a higher amount of coinciding reflections, making them more diffuse. The ER synthesis first further segments the ER part of the RIR into smaller segments. In some embodiments, this is done by detecting perceptively salient reflections and selecting windows of at least the Head Related Impulse Response's (HRIR's) sample count around them.

Such windows containing reflections can be detected by a heuristic, like comparing the average of energy per sample in the window with the sample count n with the average of the energy per sample in a larger window with the sample count m around the first window. For windows of size m=2n a common heuristic might be, that a reflection is considered salient, it's average energy per sample is 6 dB higher than that of the surrounding window. These windows are then assumed to contain salient reflections.

In some embodiments, this approach might be generalized by assuming a continuous, regular grid of reflection windows, each with the same sample count and overlap. This effectively quantizes assumed reflections time of incidence to the grid. Each of the detected reflection windows is assumed to partially consist of a specular and a diffuse part, while the remaining parts are assumed to be completely diffuse. Each of the reflection windows is assigned a diffuseness coefficient, which approximates how diffuse the reflection is. A heuristic or formula can be used to determine the exact diffuseness coefficient. Different embodiments of the system might use different methods for determining the coefficient. A possible heuristic might be based off the previous heuristic used for finding salient reflections, such that given the total energy of the small window Eₛ in dB and the total energy of the large window Eₗ in dB, the diffuseness coefficient α can be calculated as α=(Eₛ/Eₗ+6 dB)/12 dB.

A diffuseness coefficient α larger or equal 1 means, that the reflection is fully specular, whereas α smaller or equal 0 means that the reflection is fully diffuse. Therefore the value of α is limited to the range [0,1]. Similar to the DS part, the fully directional specular part of the reflection window needs to be convolved with a HRTF. For this, it might use a HRTF from the same HRTF provider as the DS processing step.

The required DOA, used to acquire the HRTF, is calculated by using the Image Source Method. Image source positions are calculated, based on the provided geometric room information. A best candidate is then selecting, by comparing the times of sound incidence at the sink for each image source and comparing it to the time of incidence of the reflection window. The best matching image source is selected and the normalized vector between it and the sink assumed as the DOA for the specular reflection.

In other embodiments, the DOA's might instead be determined by other means, like a statistical distribution heuristic or by analyzing the times of arrival on a microphone array, the so called Spatial Decomposition Method. The binaural specular part is then calculated by convolving the windowed reflection segment with the HRTF, e.g. by appropriately padding the segment and multiplying it with the HRTF in the frequency domain, before transforming the result back and removing introduced phase delays if necessary. This produces the specular window wₛ.

The binaural diffuse part is acquired by selecting the same sub window, but this time it comes from the synthesized diffuse filter. This diffuse reflection snippet is then multiplied by a Hann window of size n—giving w_{d}.

The diffuse reflection window w_{d} and the specular window wₛ are then combined linearly, given the diffuseness coefficient α, such that the resulting window w_{bin} is combined according to the formula

$${w}_{bin} = α * {w}_{s} + ( 1 - α ) * {w}_{d} . \qquad ( equation 1 )$$

Therefore, with respect to FIG. 8b, one implementation is that, for an initialization, a loading of required signals is done. A first signal is the room impulse response provided by the input interface or the single-channel acoustic data. The second signal is the binaural noise that is used later on in accordance with the third or the fourth aspect. Furthermore, an HRTF data set and, if required, an average HRTF magnitude response is loaded. Furthermore, compensation filters from microphone and headphones can be applied as illustrated with respect to the seventh aspect and the directivity transfer functions for the loudspeakers as discussed with respect to the first and the second aspect. Furthermore, the headphone compensation can be applied onto the HRTFs before selecting certain HRTFs so that, in response to a DOA, already compensated HRTFs can be selected. Then, the positions and rotations of the recording constellation are saved as the initial listener position or orientation or initial sink position or orientation and the initial source position or orientation. Then, the calculation of the image source model as illustrated in FIG. 8a takes place and, in order to have enough image sources, an order is selected based on the assumed mixing time between the early reflection part and the late reverberation part that is, for example, by 160 ms in the room impulse response is selected. However, in order to simplify this procedure, a lesser number of image source positions can be used and the segments that did not receive an associated image source position in the matching process are associated with random positions or random data in general. This procedure of randomly associating a certain HRTF for a segment in a random way is also advantageous to do, when a matching image source position for a certain reflection is not found in the matching process.

Subsequently, the third aspect of the present invention is illustrated with respect to FIG. 10a. Particularly, the two-channel synthesizer is configured to calculate a specular part for segment n or, generally, for the early reflection part as discussed with respect to the second aspect and as shown in block 237. Additionally, the two-channel acoustic data for early reflection part are also calculated using a diffuse part as shown in block 238 that describes a diffuse influence in the early reflection part. Both blocks 237 and 238 receive a single-channel early reflection part for the segment n as provided by block 210 of FIG. 2. Both blocks 237, 238 output two channels of binaural data, and these two channels are combined in block 239 correspondingly so that a first channel and a second channel for segment n is obtained, and this two-channel data for the early reflection part not only represents the specular influence of the distinct early reflections as in known procedures, but also accounts for the diffuse portion that heavily contributes to natural and pleasing sound impression for the listener.

Particularly, the two-channel synthesizer 200 is configured to calculate the diffuse part using a combination of the early reflection part of the single-channel acoustic data and a two-channel noise sequence as input into block 238. Advantageously, this two-channel noise sequence is a binaural noise sequence as measured when a certain noise signal is emitted by a speaker at a certain position with respect to an artificial head, and where a full HRTF is detected by a means of two microphones residing in the artificial head. Such binaural noise can be actually measured or can, alternatively, be synthesized or if this is, for some reason, not practical, even two different noise sequences can be used for the binauralization of the late reverberation part of the room impulse response.

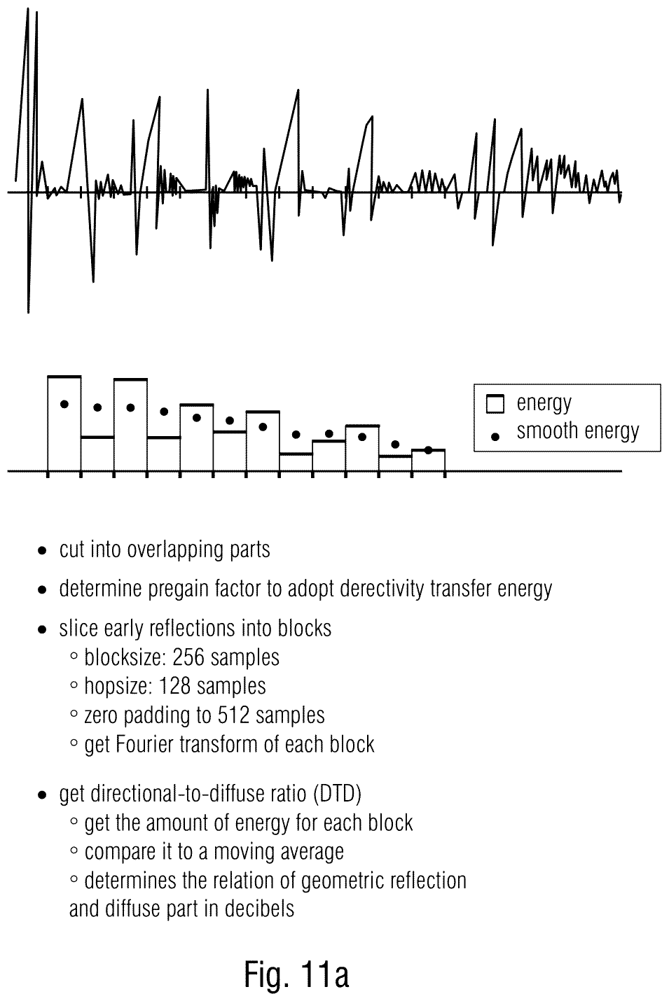

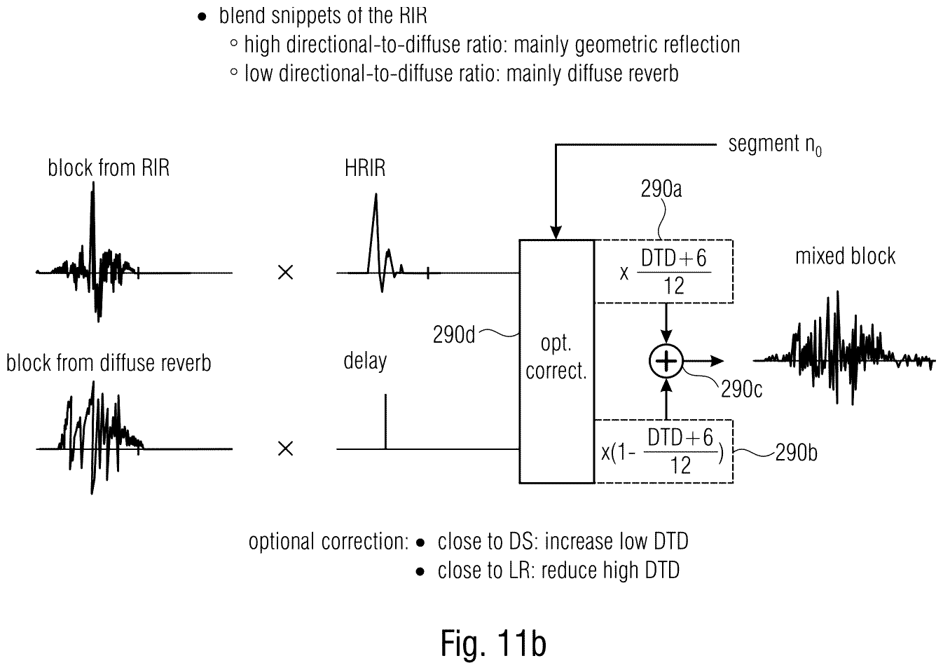

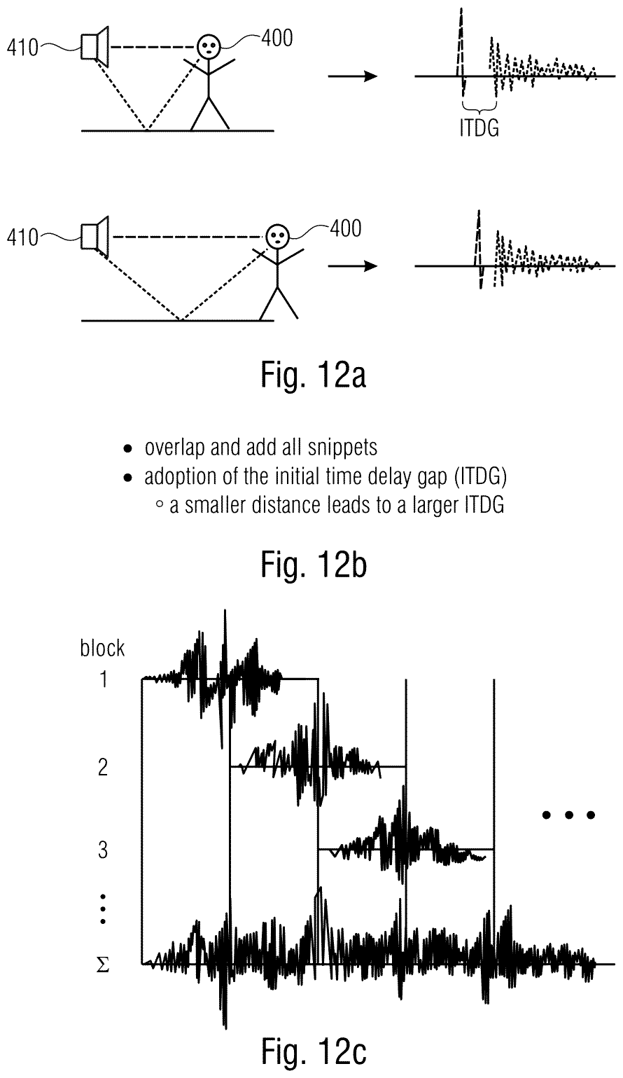

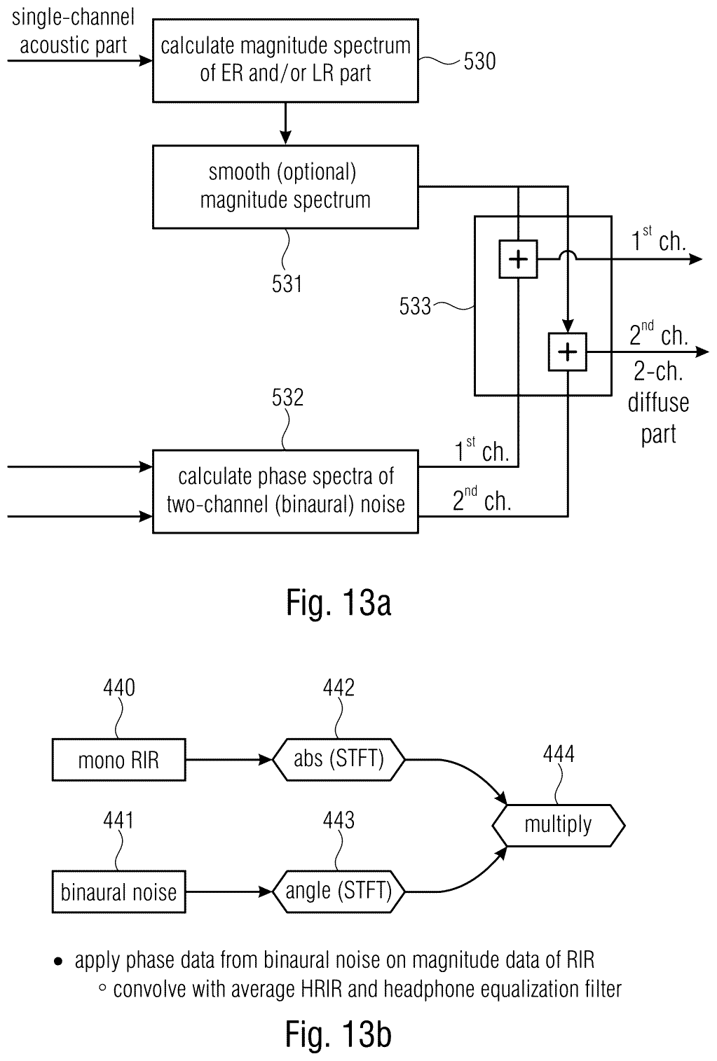

In an implementation as illustrated in FIG. 11b, a weighted addition of the specular part and the diffuse part is performed where weighting factors are, for example, determined as indicated in blocks 290a, 290b, and the actual addition of the weighted contributions takes place in block 290c. To this end, reference is also made to FIG. 10b illustrating, at block 291, an exemplary room impulse response as can be measured or synthesized. However, it needs to be noted that the room impulse response 291 is not a true room impulse response, since, for the purpose of explanation, the early reflections have been enhanced with respect to the direct sound. Particularly, the impulse response comprises a specular part 291 and a diffuse part 293. In 292, the illustration shows specular reflections and, therefore, not the true snippets from 291. The same is true for block 293 that shows a kind of diffuse part, but not directly derived from the room impulse response 291, since the scale of the early reflections and the direct sound is modified. Blocks 294 illustrate seven overlapping segments, for a situation, where the early reflection part is separated into seven segments only. However, more segments can be used as well and, in a typical implementation fifty segments or even 60 or more segments can be used.

The same segments are applied to the diffuse part subsequent to a windowing operation applied to the diffuse part so that the diffuse part can well be combined with the windowed specular part.

Therefore, for the calculation of the weighted sum 290, the windowed diffuse part is used and, the windowed specular part is processed using the image source model 295 as discussed before, where, additionally, an HRTF provider 296 has provided the correct HRTF for each segment and, subsequently, a padding operation 297, a subsequent convolution operation 298 with the selected HRTFs from block 296 is performed and, finally, a delay compensation 299 is applied so that a correct mixing of the specular part and the diffuse part for each early reflection segment is obtained.

In an embodiment illustrated in FIG. 11b, a further correction 290d is performed in order to address the situation that, close to the border between the direct sound and the early reflection, a specular part should dominate the diffuse part, i.e., should have a stronger influence than the diffuse part. On the other hand, at the other end of the early reflection part, i.e., at the border between the early reflection part and the late reverberation part, the diffuse part should dominate over the specular part.

Typically, it has been found that a directional to diffuseness ratio-based measure (DTD) in blocks 290a, 290b already results in the situation that either the specular part or the diffuse part should be dominant. However, in order to avoid any unnatural situation, the correction 290d is applied in a certain way, such as providing a maximum or minimum amount for each segment or for a plurality of segments or by applying a certain curve on the measures determined as shown in blocks 290a, 290b.

Depending on the implementation, the Directional-To-Diffuse-Ratio can be used as a threshold value or can be used as a smooth transition from 0 to 1. A fully specular or salient reflection is given, when the first window has two times the energy of the second window. A fully diffuse segment is obtained, when the average energy in the first window is 0.5 times the energy in the second window, and all values in between 0 and 1 are possible as well. These values are advantageously used as weighting factors or in determining the weighting factors for the weighted combination of the specular part and the diffuse part.

Additionally, reference is made to FIG. 11a illustrating the procedure for calculating the specifically advantageous directional-to-diffuseness ratio (DTD). The early reflection part is cut into overlapping parts. Then, a pre-gain factor is determined to adopt a directivity transfer energy, for the purpose of applying the directivity transfer functions not only to the direct sound part but also to the early reflection part as discussed before with respect to the first and the second aspect. Then, the early reflections are sliced into blocks or segments with a block size of 256 samples and a hop size of 128 samples and, then a zero padding operation is performed to 512 samples so that, after that, a Fourier transform is applied to each block. Then, the directional-to-diffuse ratio is determined by determining the amount of energy for each block, by comparing it a moving average and by determining the relation of the geometric reflection and the diffuse part in decibels. To this end, the energy illustrated in FIG. 11a is changed to the smooth energy by means of the moving average operation.

The advantageous procedure can also be performed as follows. For instance, the diffuse component can be derived, by taking a binaural noise sequence of the same length as the RIR's reverberant part and the RIR's reverb as input. (Binaural noise sequence hereby refers to a kind of white noise, which shows the same phase characteristics and inter-aural correlation as the recording of a diffuse sound field.) The combination of the diffuse part and the specular part is advantageously performed in accordance with the above equation (1).

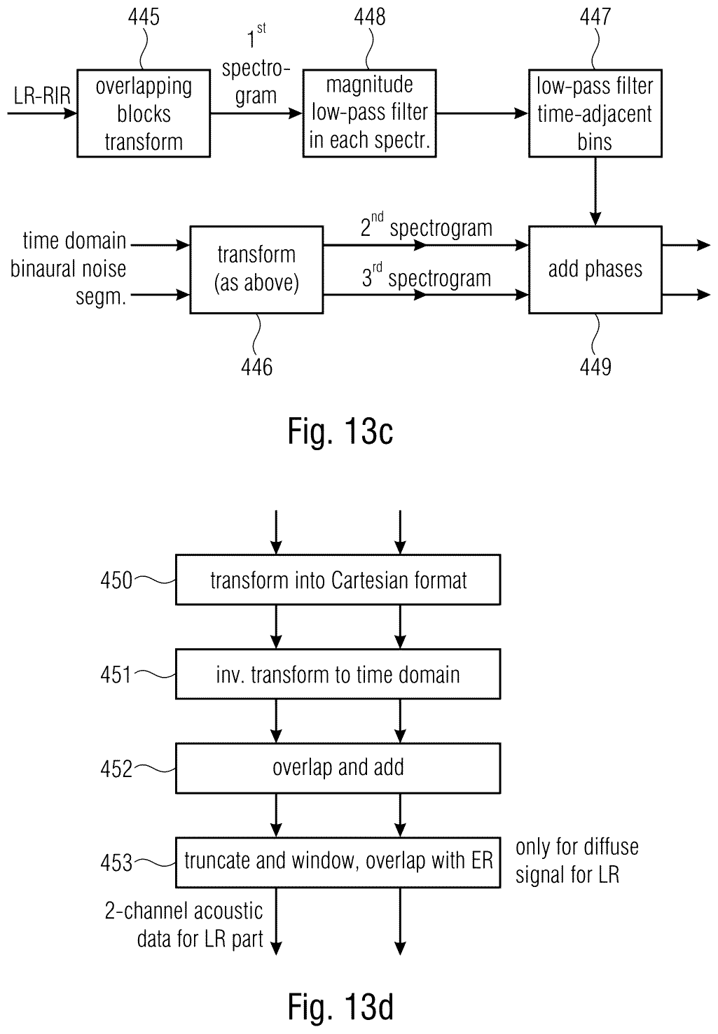

FIG. 13a illustrates the subject-matter of the present invention in accordance with the fourth aspect. This aspect refers to the improved calculation of the diffuse part either for the early reflection part or the late reverberation part or only for the late reverberation part or for both parts using a magnitude spectrum of the early reflection part and/or the late reverberation part and using phase spectra for the two-channel (binaural) noise. The two-channel synthesizer 200 of FIG. 1 is configured to calculate a two-channel diffuse portion of the early reflection part or of the single-channel acoustic data without the direct sound part using a magnitude spectrum of the early reflection part or of the single-channel acoustic data without the direct sound part and a first channel noise phase spectrum for obtaining a first channel of the two-channel acoustic data and using a magnitude spectrum of the early reflection part or of the single-channel acoustic data without the direct sound part and a second channel noise phase spectrum.

Particularly, the first channel nose phase spectrum and the second channel noise phase spectrum are derived from a two-channel binaural noise sequence. This is illustrated by block 530 illustrating the calculation of the magnitude spectrum and block 532 in FIG. 13a illustrating the calculation of the phase spectra of the two-channel (binaural) noise.

The conversion of a single-channel data as derived by block 520 or as advantageously derived subsequent to a smoothing of the magnitude spectrum in block 531 is transformed into a second-channel result by adding the phases of the first channel phase spectrum to the smoothed amplitudes of a spectrum in block 531 to obtain the first channel result and by adding the second channel phase spectrum of block 532 to the advantageously smoothed magnitude spectrum of block 531 in the combiner 533 to obtain the second channel of the two-channel diffuse part for the late reverberation part or for the early reflection part plus the late reverberation part or, stated in other words, for the single-channel acoustic data without the direct sound part that is assumed to be non-diffuse and, therefore, does not receive and diffuse contribution. It is to be noted that the “adding” of magnitude and phase is, in the specific mathematical sense, a multiplication as shown in block 444 of FIG. 13b, i.e., a multiplication of a magnitude spectrogram and a phase spectrogram: |RTF|*e\hat{ }(angle(binauralNoise1)) and |RTF|*e\hat{ }(angle(HbinauralNoise2)), where H stands for a transform into the spectral domain.

As illustrated in FIG. 13b, a mono RIR is provided in block 440 and absolute values of an STFT spectrogram consisting of a sequence of spectra is taken as shown in block 442. A binaural noise sequence 441 is provided as well and is subjected to a corresponding spectrogram processing by means of a time-to-frequency conversion and the phase angles of each channel of the binaural noise are taken as illustrated in block 443 and, then, the phase angles are combined with the corresponding magnitudes as illustrated in block 444, advantageously subsequent to the smoothing operation in block 531.

The smoothing operation in block 531 has the advantage that this smoothing along the frequency direction of the magnitude spectrum, naturally in each spectrum of the sequence of spectra covering e.g. the early reflection part and the late reverberation part avoids any peaks that might occur due to the inverse Fourier transform when a phase manipulation has been performed in the spectral domain as it is the case the present invention. On the other hand, the procedure of calculating spectrograms and simply “adding” the phases of the binaural sequences to the (smoothed) spectrogram is a computationally easy procedure that does not require a considerable amount of computational resources. Additionally, it has been found that this late reverberation processing has a pleasant sound for the listener which is particularly useful, since, due to its quality, the same late reverberation two-channel acoustic data for the acoustic environment can be used irrespective of whether the source position or orientation or the listener position or orientation changes. This situation results in a significant consequence in that the update ratio for the calculation of the late reverberation part can be made significantly smaller (typically by one or even two orders) which additionally reduces required computational resources and also allows to distribute the processing tasks to different elements as will be illustrated with respect to the sixth aspect of the present invention.

FIG. 13c illustrates a further implementation of the procedures in FIGS. 13a and 13b. In block 445, an overlapping blocks transform is applied to the late reverberation room impulse response or to both, the early reflection part and the late reverberation part. This results in a first spectrogram where, advantageously, and as shown in block 531, a low-pass filtering is performed in each magnitude spectrum over frequency.

In block 447, it is of advantage to additionally perform a lowpass filtering over time, i.e., over two or more adjacent blocks and with respect to the same frequency bin, but in adjacent blocks, i.e., with time-adjacent frequency bins relating to the same frequency. A similar transform 446 is performed for the time domain binaural noise sequence to obtain the second spectrogram and the third spectrogram, and the phases of the second and third spectrograms are added in block 449 to the spectral domain and time domain lowpass filtered spectra.

Then, the result of block 449 is transformed into a Cartesian format as shown in block 450 and, then, inversely transformed into the time domain in block 451. In block 452, an overlap and add procedure is performed and, finally, in block 453, a truncation and windowing and an overlap with the earlier reflection part is performed which is only done for the diffuse signal for the late reverberation to then obtain the two-channel acoustic data for the late reverberation part at the output of block 453.

of the same length as the RIR's reverberant part and the RIR's reverb as input. (Binaural noise sequence hereby refers to a kind of white noise, which shows the same phase characteristics and inter-aural correlation as the recording of a diffuse sound field.)

The two filters can then be transformed into a time-frequency representation using the Short Time Fourier Transform (STFT). The STFT's parameters can be chosen in a way, that it allows near perfect reconstruction, e.g. by using half overlapping Hann Windows. The complex valued, blockwise spectra are then converted to the polar form, separating each frequency bin into a magnitude and phase component. The complex representation of the diffuse component is then constructed by pairwise combination of each bin of the complex magnitude of the transformed RIR block and the complex phase of the transformed noise sequence block, per channel of the noise. The recombination of the magnitude and phase is done for each bin of the equivalent length blocks.

In some embodiments of the described system, the Binaural Synthesizer is additionally configured to perform low pass filtering between the magnitudes of the frequency bins at this processing stage. A typical lowpass filter might be a moving average filter, corresponding to equivalent bins of ⅓ octave, but other configurations are possible. This reduces artifacts introduced by combination of the two magnitude and phase parts of two different transfer functions.

Additional, a lowpass filter might be applied between time-adjacent blocks of the recombined transfer function, such that bins, corresponding to the same frequencies, are low pass filtered between the blocks. A typical configuration for this, assuming a block size of 512 samples at 48000 kHz, is a moving average filter over 3 values (or time blocks). The exact parameters also depend on the individual embodiment.

The new filter is then converted back into its Cartesian form and transformed back into the time domain, using an inverse STFT with the same parameters, which were used for the forward transform. The resulting filter is a binaural diffuse reverb filter, with the length of the combined ER and LR parts and two channels. To state it clearly: the beginning of this diffuse part is used as one of two layers for the ER segment and the later diffuse part is the input for the LR segment.

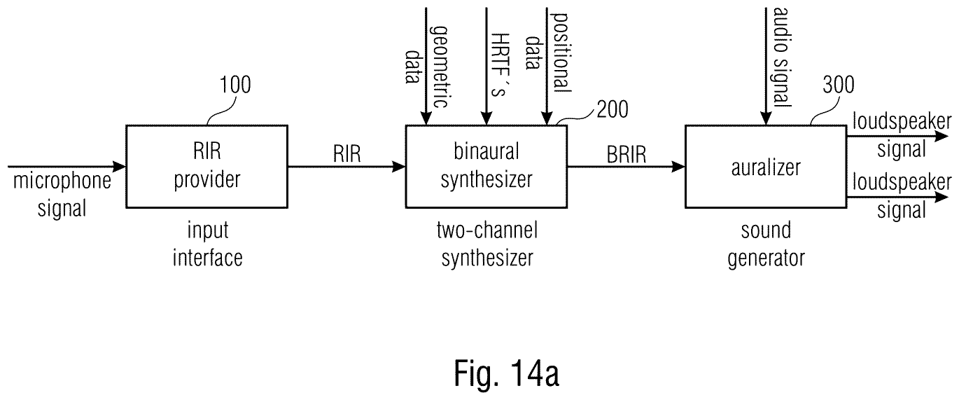

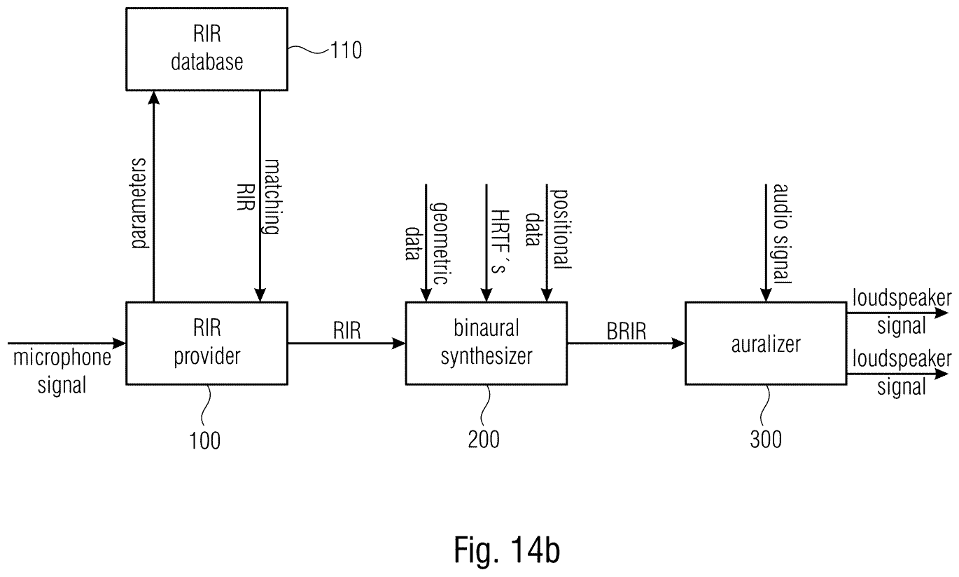

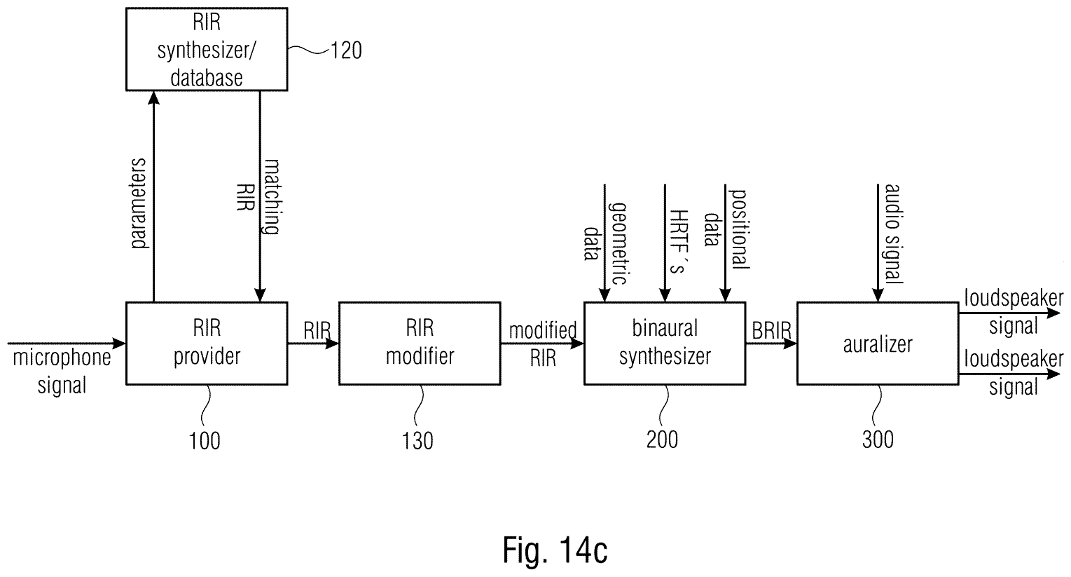

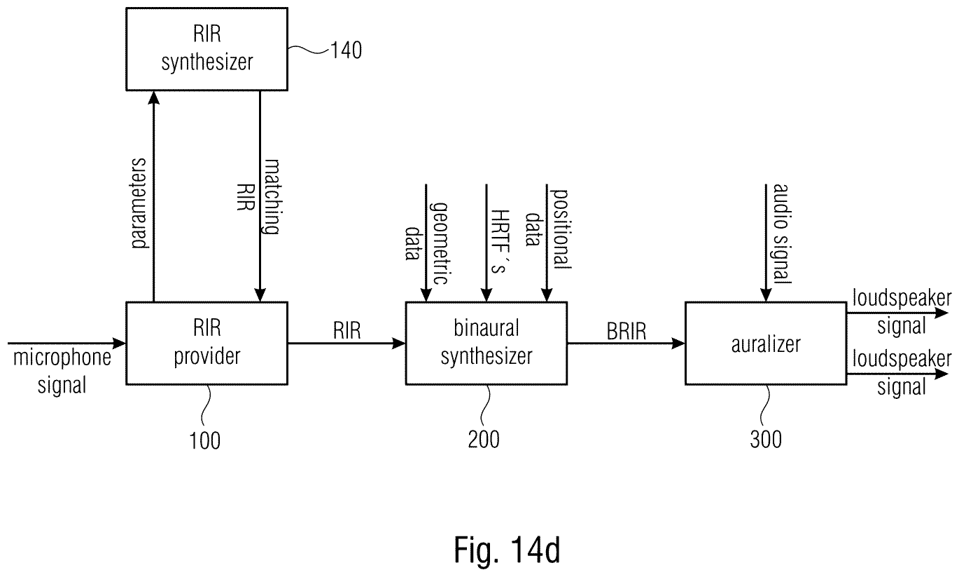

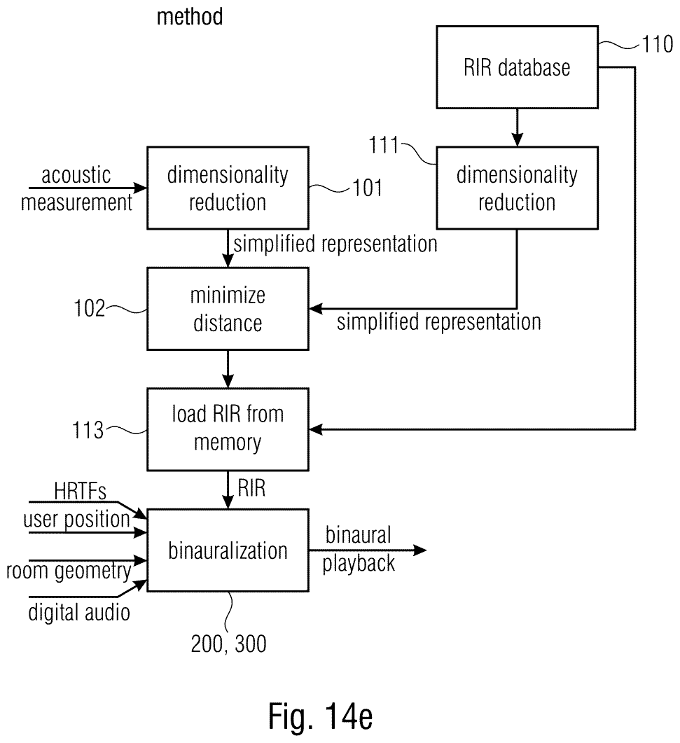

Subsequently, FIGS. 14a to 14e are illustrated that can be used in each of the first to fourth aspect of the invention and, particularly, in the fifth aspect of the present invention which allows to efficiently provide the required room impulse response. To this end, the input interface is termed to be an RIR provider 100, and the RIR provider receives, as an input, for example a microphone signal of an initial measurement.

This room impulse response is forwarded to the binaural synthesizer which calculates, based on geometric data on the room such as required for the calculation of the image sources, the required HRTFs, and positional data on the sound source and the user, the binaural room impulse response that can then be auralized by the auralizer 300 or sound generator using an audio signal to obtain the two output loudspeaker signals that can be rendered by a headphone, by an ear bud, by an in-ear device or by discrete speakers.

In FIG. 14d, a microphone signal is measured and the RIR provider 100 calculates parameters or, in general, a fingerprint from the microphone signal, accesses a certain room impulse response database 110, and the database replies with the matching room impulse response that is then forwarded by block 100 to the two-channel synthesizer or binaural synthesizer 200.

In FIG. 14c, the RIR provider 100 generates a set of parameters from the microphone signal and forwards these parameters into a database or to and RIR synthesizer that is in the position to synthesize the RIR based on the parameters. Hence, block 120 may have two functionalities compared to block 110. Furthermore, an RIR modifier 130 is provided that modifies the RIR in some way for the purpose of implementing certain desired sound effects or room effects.

FIG. 14d illustrates a procedure where only an RIR synthesizer 140 and no database is used for the purpose of auralization of the room acoustics.

FIG. 14e illustrates a further advantageous way of providing a certain room impulse response. This procedure relies on an acoustic measurement that can be a microphone signal or can come from another source. In a block 101, a dimensionally reduction is performed in order to obtain a simplified representation which can, for example, be a set of parameters, or, in general, a fingerprint that can, for example, be derived from the acoustic measurement by other procedures different from parameterizing this signal for, for example, psychoacoustic parameters.

Furthermore, an RIR database 110 is provided that also comprises a dimensionality reduction block 111 for again generating a simplified representation that is then input, together with the other simplified representations for the other RIRs stored in the RIR database 110 to block 112 that minimizes the distance and finds a best matching RIR. This RIR that is best matching is identified from block 112 and this information is sent to block 113 that loads the RIR from the RIR database 110 and, then, a binauralization is performed. The block binauralization in FIG. 14e combines the functionalities of blocks 200 and 300 of FIG. 1 or other figures.

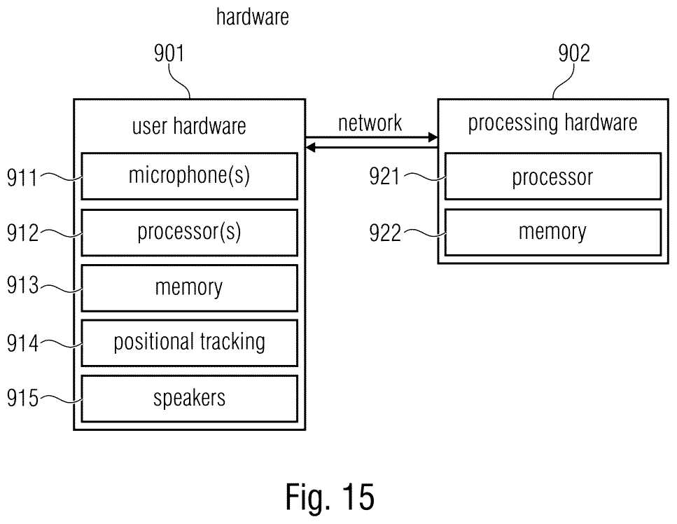

Furthermore, FIG. 15 illustrates a certain hardware in accordance with an implementation of the sixth aspect of the present invention. Particularly, a first device 901 comprises one or more microphone 911, one or more processors 912, a memory 930, a positional tracking system 914 for tracking the position of the listener, where the position of the listener also refers to the orientation of the listener, i.e., collectively the listener's pose. Furthermore, the first device 901 can comprise speakers 915.

The second device 902 comprises, in this embodiment, a processor 921 and a memory 922 and is connected to the first device 901 via a network.

Part 1 of the solution infers a RIR (for a specific, virtual source-listener configuration), from available audio data, recorded at the listeners listening environment. The real configuration that this audio has been recorded in can, but does not have to match the configuration of the virtual configuration.

System 1 is configured to continuously or once record a measurement of the local sound field, including room acoustics of the users real environment. In some embodiments, this is done by measuring a RIR between the microphone(s) and any real sound source in the room, for instance using the exponential sine sweep method. This is especially feasible, when the system is only calibrated to the listening environment once. The RIRs recorded this way might or might not be feasible for auralization of the virtual sound sources, due to belonging to a different sound source or due to limitations of the capturing part of the system, like a limited bandwidth of the transducers, that might not match those of the virtual sound source to be auralized. [A]

The recorded audio data is sent to a second system via a network [B]. The memory holds a database of pre-recorded high quality, omnidirectional RIRs of different rooms of varying acoustical properties. The data base might (but does not need to) include one or more measurements from the actual listening room.

The purpose of this system is to process the transmitted audio data and select a RIR, that is best fitting the unknown RIR of the real room at the current listener position, sending it back to the first system for further processing and binaural synthesis [C].

This second system is configured in a way, that it reduces the high dimensional, time- or time-frequency representation of the audio data into a lower dimensional representation. In some embodiments, this is being achieved by transforming the data with an adequately trained neural network. Such a network can for instance be trained on the task of classifying RIRs to classes of single rooms, other than the ones residing inside of the database. The coefficients of a layer of the network and the latent space they form are then selected as the lower-dimensional representation of the data, which is calculated for both the pre-recorded RIRs and the ad-hoc measured RIR [D]. These coefficients are then used to find the best matching RIR, based on the minimization of a suitable distance metric in this dimensionality reduced space. The acquired RIR is now transferred back to the first system via a network. This process of acquiring a RIR is repeated in a certain interval, to reflect major changes in the room acoustics, e.g. when the listener moves into an area with substantially different reflections or an different acoustic environment. When a new RIR is found, which minimizes the distance metric to the new data point, it is selected. The system keeps a short history of used RIRs, allowing it to gradually blend between the changing RIRs.

Further embodiments are given below:

1. [A] Instead of recording an impulse response, the systems are configured to record and process well defined, self-produced sounds of the user like clapping or speech, so that RIRs can be inferred without requiring a sine sweep.

2. [A] Instead of recording an impulse response, the systems are configured to record and process well defined, sounds like music, so that RIRs can be inferred without requiring a sine sweep.

3. [A] Instead of recording an impulse response, the systems are configured to record and process the general sound field, without relying on specific classes of sounds or sounds, so that RIRs can be inferred automatically without requiring a sine sweep or any user input for calibration.

4. [D] Instead of using the latent space of a neural network for dimensionality reduction, adequate digital signal processing backed by a psycho acoustic model is used to create a lower dimensional space suitable for matching RIRs.

5. [C] Instead of selecting from a set of pre-recorded RIRs, the neural network is trained to synthesize a new RIR directly. Those RIRs might or might not be a combination of existing RIRs.

6. [C] Instead of selecting from a set of pre-recorded RIRs, a second neural network is trained to synthesize a new RIR from the dimensionality-reduced representation. Those RIRs might or might not be a combination of existing RIRs.

7. [C] Instead of selecting from a set of pre-recorded RIRs, a neural network is trained to synthesize a new RIR from the output of the embodiment described in 4.

8. [B] System one is extended with non-transitory memory, storing the RIR database. All processing is done on system one.

In some embodiments, the RIR provider does not have to be manually configured with a RIR. Instead, the system might use a speaker and microphone, which might not meet the qualitative requirements for a broadband RIR measurement, i.e. the transducers might have non-linear or impeded frequency responses over the audible range, or they might be built into the same chassis. Instead of measuring the RIR directly, it is configured to measure a low quality RIR, which might or might not be usable for the Binaural Synthesis. The measured RIR is not used directly as an input for Binaural Synthesis. Instead, acoustic or psycho acoustic parameters are derived from the measured RIR. For instance, the bandwise reverberation time (RT60) or the Energy Decay Curve (EDC), the Direct to Reverberant Ration (DRR) or other parameters might be calculated. The exact parameters that are calculated depend on the embodiment.

The calculated parameters are then used to find a similar RIR from a database for pre-recorded RIR's, which are suitable for the binaural synthesis. The pre-recorded RIR's were stored in non-transitory memory, together with the chosen set of acoustic parameters. When the RIR provider is set up to a new acoustic environment and a low quality RIR is measured, these parameters are calculated and compared to the pre-recorded dataset. The best matching pre-recorded RIR is selected from the database and used as an input RIR for the Binaural Synthesizer.

In some embodiments, instead of directly finding the RIR with the best matching parameters, a psycho acoustic weighting function is employed, which specifies a weighting coefficient for the influence of each of the parameters.

In some other embodiments, the parameters used to find the best matching RIR are other acoustic or psycho acoustic parameters. Instead, the measured RIR's are represented by a set of parameters, which are calculated by transforming the data with an adequately trained neural network. Such a network can for instance be trained on the task of classifying RIR's to classes of single rooms, other than the ones residing inside of the database. The coefficients of a layer of the network and the latent space they form are then selected as the lower-dimensional representation of the data, which is calculated for both the pre-recorded RIR's and the ad-hoc measured RIR. These coefficients are then used to find the best matching RIR, based on the minimization of the distance metric in this dimensionality reduced parameter space.

When a traditional RIR measurement (i.e. using an exponential sine sweep deconvolution) is not feasible, some embodiments of the system might make use of classes of sound, i.e. the sound of a human clapping or human speech, to make assumptions about the RIR or derive a RIR from reverberant audio, directly recorded with one or more microphones. To achieve this, the chosen parameters are derived either directly from the reverberant audio, or an intermediate approximation of the RIR is derived.

Some embodiments of the system, which are used in more than one acoustic environment, need to adjust to changing room acoustics. This is achieved, by changing the RIR which is sent from the RIR Provider to the Binaural Synthesizer. Depending on the embodiment of these RIR updates can either be done periodically, for instance at a fixed rate, or when a significant acoustic change requires the update.

To achieve inaudible, gradual changes between the two input RIR's, the RIR provider is configured to gradually interpolate between the two filters. Suitable algorithms to achieve this kind of interpolation are e.g. linear interpolation in the time- or frequency domain.

In some embodiments, where a pre-configuration of the system for one or multiple room acoustic environments is not possible, e.g. when the device is worn and used in multiple environments, like when listening to music while traveling. Here, the one or multiple microphones of the device constantly or periodically record sounds from the acoustic environment. The RIR provider is configured to detect one of the many classes of sounds, which it is configured to derive the intermediate representation of the RIR for. Even though room acoustics might sometimes change quickly, e.g. when entering or leaving rooms, the system can be configured to gradually integrate over the detected room acoustics and adjust gradually, to increase stability of the results.

Alternative to acquiring RIR's from a database of pre-recorded RIR's, a state of the art room acoustic simulation might be employed to generate the omnidirectional RIR's, which are used for Binaural Synthesis. The employed algorithm is able to simulate good approximations of the real room acoustics, given a limited time frame and set of input parameters. It must especially reproduce a good approximation of the real, frequency dependent distribution of energy over time, since phase relationships of the BRIR's are modeled by the Binaural Synthesizer. Depending on the employed room acoustic simulation method, the RIR provider is configured to calculate the input parameters required for the simulation.

Some embodiments of the described system use an extended version of the Binaural Synthesis method, which instead of processing the individual specular reflections from the recorded RIR, might use room acoustic modeling, like the Image Source Model, to calculate specular reflections. Here, the provided room geometric information is used to determine the time of arrival and direction of arrival of individual specular reflections. Acoustic absorption effects of the reflective surfaces, which the reflections originate from, can be included as an input in the room geometric data. Alternatively, some embodiments might chose to estimate the absorption coefficients of the walls by analyzing the initial reflections at the time of arrival of the ISM's reflection, by deriving a filter based on the reflection window and the direct sound window, which is assumed to be close to linear over the audible frequency range. This modification allows a higher density of specular reflections to be calculated, resulting in potentially improved localizability, at the cost of more necessary calculations.

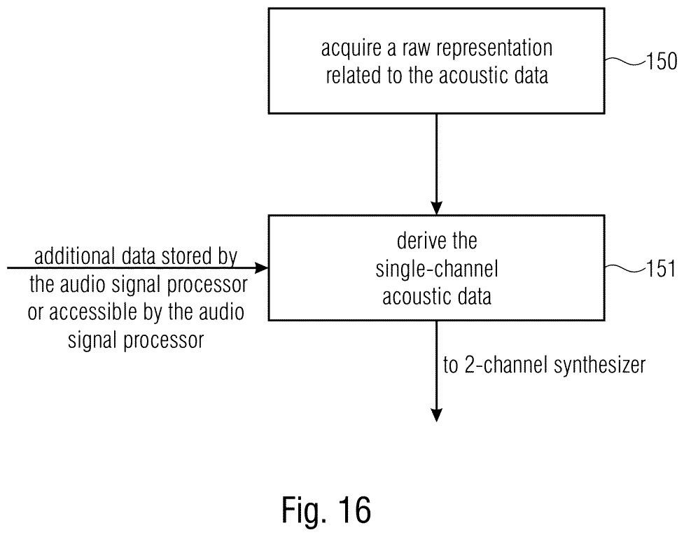

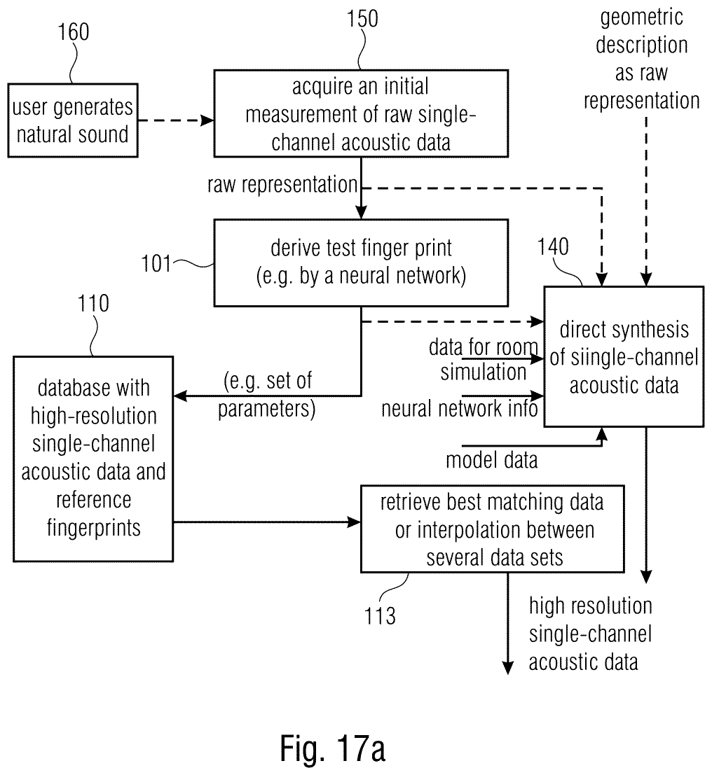

FIG. 16 illustrates an implementation of the fifth aspect related to the smart determination of the room impulse response from a raw representation related to the single-channel acoustic data. Particularly, the input interface 100 of the device illustrated in FIG. 1 is configured to acquire a raw representation related to the acoustic data as illustrated at 150. Furthermore, the input interface 100 is configured to derive the single-channel acoustic data using the raw representation obtained in block 150 and using additional data stored by the audio signal processor or accessible by the audio signal processor in order to obtain the single-channel acoustic data that is then forwarded to the two-channel synthesizer 200.

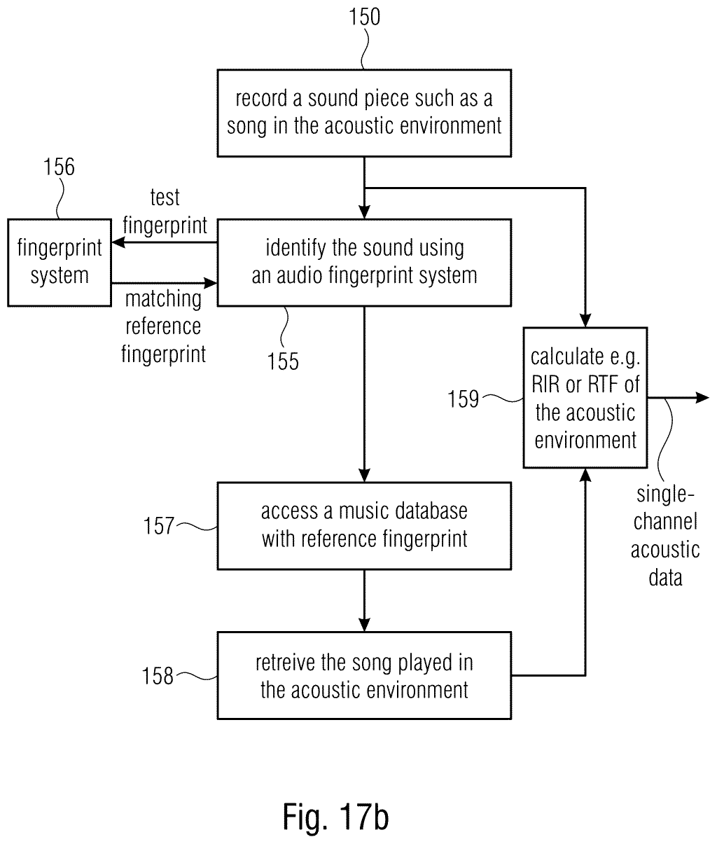

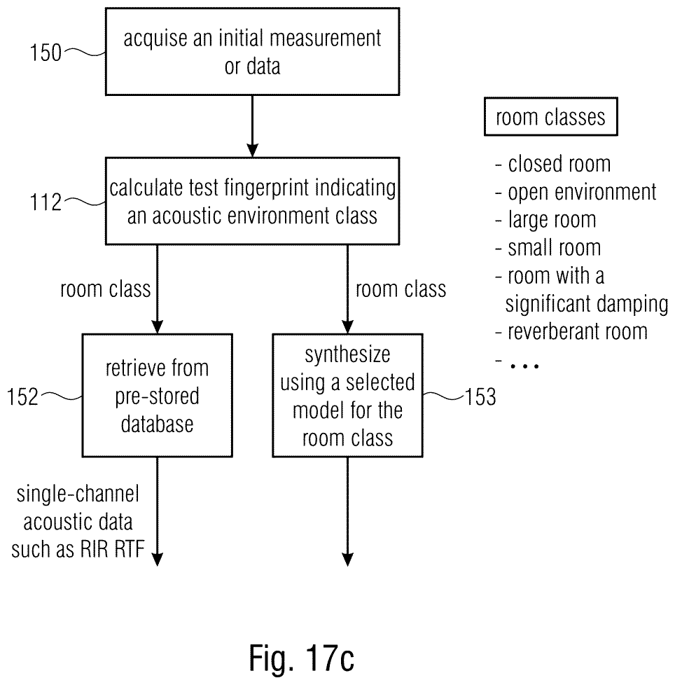

Exemplarily, the input interface is configured to acquire, as the raw representation, an initial measurement of raw single-channel acoustic data to derive a test fingerprint of the raw single-channel acoustic data as illustrated in block 101 of FIG. 17a. Based on this test fingerprint, a pre-stored database 110 with an associated set of reference fingerprints is accessed, where each reference fingerprint is associated to a higher resolution single-channel acoustic data, where the high resolution single-channel acoustic data has a higher resolution than the initial measurement. Furthermore, from the pre-stored database 110, the high resolution single-channel acoustic data having a reference fingerprint best matching with the test fingerprint is retrieved as illustrated in block 113 of FIG. 17a.

Alternatively, the high resolution single-channel acoustic data can also be synthesized from the test fingerprint or from the raw single-channel acoustic data typically using additional geometric data or only using geometric description data as illustrated in block 140 of FIG. 17a illustrating a direct synthesis of the single-channel acoustic data. To this end, block 140 receives the raw representation as acquired by block 150 or the test fingerprint as calculated by block 101 and, as the additional data, data for a room simulation, data on a neural network information where block 140, in this case, implements an neural network, or model data as the additional data. Thus, when the alternative of the direct synthesis is performed, the database 110 is not required. Furthermore, block 101 is configured to derive a test fingerprint as a set of at least one of the following parameters RT 60, EDC, DRR, and wherein the reference fingerprint additionally comprises at least one of the following parameters RT 60, EDC, DRR.

FIG. 17b illustrates a further procedure for the calculation of the room impulse response or room transfer function of the acoustic environment. In block 150, a sound piece such as a song as played by a loudspeaker in the acoustic environment is recorded as the raw representation of block 150 of FIG. 17a. In block 155, the sound is identified using a kind of an audio fingerprint system that is accessed as shown in block 155 and 156 by receiving a test fingerprint and by turning back an identification of the music piece or a matching reference fingerprint. In block 157, a typically remote music database can be accessed with the reference fingerprint or with the identification of the piece of music and, in block 158, the song played in the acoustic environment by one or more loudspeakers is retrieved, but not with the room acoustics imprinted on it, but in a clean version as played by the speakers.

In block 159, the RIR or the RTF of the acoustic environment is calculated using the song as recorded in the environment and using the song in a clean version, i.e., without any room effects as provided by the music database 157.

A further implementation is illustrated in FIG. 17c, where an initial measurement or data is acquired in block 150 and, in block 112, at test fingerprint indicating an acoustic environment class is calculated, for example, by a neural network or by other procedures. Then, based on the room class, the matching RIR can be retrieved from the pre-stored database as shown in block 152 or can by synthesized using a selected room class as shown in block 153. Room classes can be a closed room, an open environment, a large room, a small room, a room with a significant damping, a reverberant room, etc.

A further implementation of the present invention is that the user generates a natural sound as illustrated in 160 of FIG. 17a. Such a natural sound is clapping, or speech or any transient sound producible a listener. This avoids the generation of an unpleasant measuring sound in a room such as sine sweep. Then, based on this sound, a (low resolution) RIR is recorded as the microphone signal, and is processed by any of the procedures shown in FIG. 17a-17c in order to obtain, from this raw representation, the high resolution room impulse response for the purpose of further processing.

Subsequently, embodiments in accordance with the sixth aspect of the present invention are discussed. Auralization of the direct sound path is typically achieved by blockwise convolution of a filter, which approximates the filter effects of the users head, ears and torso in relation to a sound source at a given position and distance (the HRTF), with the audio signal. Processing of these filters needs to encode correct changes in the inter-aural-time-difference (ITD) and inter-aural-level-difference (ILD) as well as changes in the sound intensity and other cues. Human listeners are comparatively sensitive to even small changes in these values, which is why it is necessary to calculate these changes with good spatial- and time-resolution. These filters are however comparatively short and deriving them usually involves only few processing steps. The room reverb simulates the filter effects on the sound which are caused by the environments geometry for sound which does not travel on a direct part from the sound source to the users ears. This includes reflection, refraction, absorption and resonance effects.

Such a reverb filter is expected to be much longer than the short direct sound filter. A number of processes and algorithms and systems are capable of processing adequate binaural reverb, such as the image source algorithm, raytracing, parametric reverberators and a number of delay network based approaches. The exact implementation of the reverberator is not relevant for this invention, as long as it is capable of simulating a well externalized auralization. In this embodiment, the system uses the fact, that human listeners are more sensible to changes of the direct sound filter and less sensitive to changes of the reverberation filter. The signal processor is programmed in a way, that it calculates the direct sound filters far more rapidly than the reverberation filters. This allows the system to minimize clearly audible jumps of the auralized sound, when filters are exchanged and increases the sensation of externalization, while avoiding full filter updates. Updating these filters or signal parts encoding the direct sound path at a rate of about 188 Hz has proven to be a sensible default for such a system, but lower refresh rates (like 94 Hz or 50 Hz) might be feasible in different embodiments of the system. The reverb filters are calculated at a much lower rate, typically at most one tenth of the direct sounds processing rate, depending on the acoustics of the environment and the user.

Either the signal processor, or another processor is configured as an aggregator. In some embodiments, in which the employed binaural synthesis methods return a continuous stream of blockwise binaural audio signals, this aggregator simply sums up the blocks supplied by the direct- and reverberant processing paths and acts as a signal aggregator. This requires, that the blocks to be summed correspond to the same point in time or contain control data that identifies the time frame they correspond to. Alternatively, the aggregator can be configured to sum up the two partial filters, with respect to their time delays, as determined by the algorithms. It therefore reconstructs a full BRIR filter from the individual processors results and acts as a filter aggregator. The filter can then be used to convolve audio signal blocks using state of the art realtime (blockwise) convolution methods.

The aggregator keeps a full BRIR filter in its memory at all times. The BRIR can therefore be partially updated at the individual rates of the individual processors, which process the partial filters. The resulting signal blocks contain the combined binaural signals for the direct sound path and the reverberation path. They are then passed to an loudspeaker signal generator, to be played back over the systems loudspeakers. This enables auralization of binaural audio with a similar level of externalization and perceived quality to those of the individual algorithms, while lowering processing requirements significantly.

In a different embodiment, the processing of the reverberation tail might be additionally split into separate processing paths, calculating separate filters for early reflections and late reverberation on one or more processors on the same device. This uses the fact, that strong, early reflections do often help human listeners to locate sound. These reflections are often subject to strong and momentary changes, especially when the listener moves in their environment. While humans are less sensitive to these changes than to changes in the direct sound, these early reflections carry a lot of energy and a low rate of filter calculation can result in bad externalization, mislocalisation or audible jumps. On the other hand, the largest part of typical reverberation tail contains dense, overlapping reflections with relatively low energy. These late reverberations change relatively slowly. For some environments, they might consist mostly of the diffuse part of the reverberation tail, meaning they are constant for the entirety of the sound field.

In this embodiment, a different reverberator might be used to process the late reverberation part at an even lower rate. Depending on the acoustical environment, the system can be tuned to leave the late reverb constant, refresh it at a low rate like 1 Hz, or to process it on demand when a substantial change in room acoustics is detected. In some embodiments, the employed algorithms might provide a mix of binaural filters and binaural signals. Here, the aggregation stage can be split into a filter aggregator plus convolver and a signal aggregator, first combining partial filters, convolving the reconstructed filter with the audio signal and then summing the binaural signals, resulting in the full binaural signal.

In this embodiment, the system is split into 4 or more reverberators, segmenting the BRIR into 4 or more segments. This can be used to further process parts of the reverberation tail with different complexity. For instance, for first order reflections a precise, geometric algorithm might be employed, while later order reflections are processed stochastically and the late reverberation tail is processed as in the previous embodiment.

In this embodiment, the direct-sound processors and reverberation processors of 1. are separately implemented on two devices, making up a system with the same capabilities as in embodiment 1, suitable for distributed synthesis of a binaural signal and auralization of binaural audio on the wearable device.

The first device is the wearable device, which contains the sensors, the transducers and one or more processors as in 1. These processors are configured to synthesize the direct sounds binaural filters or binaural signals directly on the device at the sufficiently high refresh rate. Processing of the direct sound part is done directly on the device, avoiding transmission over a wireless channel. The wearable device contains the aggregators and loudspeaker signal generators that are required for the aggregation of filters and/or signals, as in 1. It further contains a subsystem for the wireless transmission and receiving of audio and control data. The second device contains a processor configured to calculate the reverberation filter or signal. It further contains a subsystem for the wireless transmission and receiving of audio and control data.

In embodiments, where the algorithm employed on the second device synthesizes a binaural reverberation filter, the sensor data and control data required by the employed algorithm is sent by the wearable device. The partial filter is processed and sent back to the first device wirelessly. The processed filter then gets sent to the aggregator, which reassembles a complete representation of the BRIR, which it holds in memory as in 1. The complete BRIR then gets convolved and played back over the loudspeakers as in 1.

In embodiments, where the algorithm employed on the second device directly synthesizes a binaural reverberation signal, the audio signal is streamed along the sensor data and control data required by the employed algorithm. The reverberation processor then synthesizes a binaural signal based on the employed algorithm, which is directly returned back to the wearable system on the wireless channel. The data return contains the necessary control data, which allows determining the time frame that the binaural signal block corresponds to. The audio signals sent to the processor calculating the direct sound path are delayed by a configurable delay, which is at least as long as the transmission latency introduced by the two wireless transmissions to and from the second device. The aggregator then combines the signal blocks corresponding to the same audio signal block, specified by the time data specified in the control data stream.

In a further system, the additional reverberator calculating the late reverberation is distributed on another device. This second additional device includes a processor, configured with the late reverberation algorithm and a subsystem for wireless or wired transmission to the connected device. In some embodiments, the additional reverberator device might be connected wirelessly to the wearable device. In others, it might be connected to the first additional device. The summed delay of the chosen transmission channel can be less than the target refresh interval, at which the late reverberation signal or filter is processed. Due to the low latency requirements, the second additional device configured to process the late reverberation can be connected over a IP network with greater latency, like the internet. In a further system the additional reverberators are distributed over any number of additional devices.

Instead of being entirely self-contained, some embodiments of the described system are connected to another device, using a wired or wireless connection. The connected device sends the required audio data and meta data to the system using the connection. This allows devices such as a computer or smartphone to be connected and used with the system, using it as a device to auralize spatial audio content.

Some embodiments of the device might use a so called three degree of freedom (3DoF) tracking system, which just measures the users head rotation, to provide positional data to the system. Similarly, some embodiments might only send 3DoF tracking data and limited translational data or acceleration data to the system. In these embodiments, the system can be used to auralize a virtual audio scene, with sound sources existing in a space relative to the user. The sound sources stay stable at one position, when the user merely rotates their head. When the user (and the device) move, the virtual sound sources appear to move with them, as they are centered around the user. When some form of translational or acceleration data is available, it might be used to allow small head translations within a limited radius (i.e. fifty centimeters), which benefits externalization and localization. Larger movements are not reproduced. These embodiments of the system are especially useful for auralization of classic spatial audio content, music, movies and audio dramas, where the user is not intended to freely explore the virtual acoustic scene or leave it.

Different embodiments of the device might use a six degree of freedom (6DoF) tracking system, which measures the users absolute head rotation and position. In these embodiments, the user can freely navigate a virtual acoustic environment, walk through and out of it. This is especially useful for auralization of AR content, games, navigational content and human machine interaction scenarios. The entirety of the sensors, RIR Provider, Binaural Synthesizer and Auralizer might be spread across multiple devices. For instance, an especially small form factor, like in ear buds, might require parts of the system to be distributed to another device. In this case, the positional tracking sensors and sound transducers remain on the wearable, while the RIR Provider, Binaural Synthesizer and Auralizer are distributed to one or multiple devices. In embodiments where this is the case, the motion-to-sound latency requirements must still be upheld.

Some embodiments of the system might configure the RIR provider to provide RIR's with different characteristics, which do not match the actual acoustic environments parameters partially or fully. Alternatively, the system is extended by a RIR Modifier component, which receives the RIR input from the RIR Provider and modifies it to change certain acoustic parameters of the matching RIR, so that the modified RIR has these desired qualities and parameters. This can done to modify those room acoustic parameters to a desired level, e.g. to make a listening room appear less reverberant, for a more pleasurable listening experience. Alternatively, this can be done to make the room sound more like a different room, i.e. when listening to a concert, making the current virtual acoustic environment the listener is in sound more like a concert hall for aesthetic purposes. For instance, a longer late reverberation tail (LR) can be auralized, by selecting a RIR which shows similar parameters, but a longer reverberation time. Alternatively, the LR original (input) RIR might be resampled and thereby stretched by a certain amount, resulting in a longer reverberation time, while keeping other, perceptively relevant parts like the DS and ER intact.

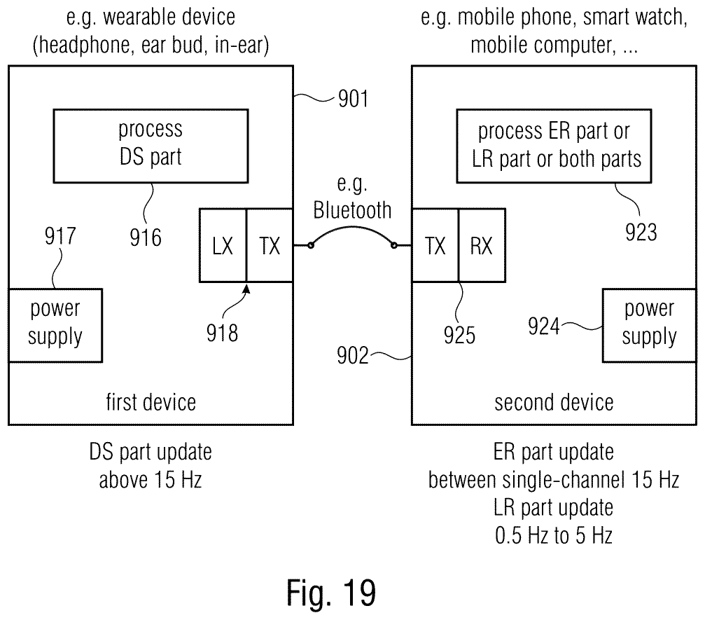

FIG. 19 illustrates an embodiment of the sixth aspect of the present invention. Particularly, the device illustrated in FIG. 1 is separated into a first device and a second device. Particularly, the two-channel synthesizer 200 is configured by two physically separate devices 901, 902 which are also illustrated in FIG. 15. The first device 901 of the two physically separate devices is configured to process the direct sound part as shown in block 916 and as illustrated in block 220 of FIG. 2. To this end, the processing requires the listener position or rotation. Furthermore, the second device 902 of the two physically separate devices is configured to process the at least one of the early reflection part and the late reverberation part. This block is illustrated at 923 and implements either one or both of the functionalities of block 230 and 240 of FIG. 2.

Both devices are connected to each other via transmission interface 918 of the first device and 925 of the second device. This transmission interface is advantageously a wireless interface and operates in accordance, for example, with the Bluetooth standard. Furthermore, one consequence of the separation of the two physically separated devices is that the first device 901 has an own power supply 917 and the second device 902 also has an own power supply 924.

Advantageously, as illustrated in FIG. 19, the first device is configured to update the two-channel acoustic data for the direct sound part more often than the second device updates the two-channel audio data for the at least one of the early reflection part and the late reverberation part. In figures it is of advantage to have a direct sound part update above 15 Hz, i.e., more than 15 updates per second, advantageously more than 20 updates per second and even more advantageously more than 50 updates per second. An update rate of the early reverberation part is advantageously in a range between 5 Hz and 15 Hz, and a late reverberation part update is sufficient to be in the range between 0.5 Hz to 5 Hz. Hence, it appears that the parts that require a lower update rate are processed in the second device 902. It has been found that it is these parts that require a significant higher processing power due to the long filters which require, on the other hand, a lower update rate. Thus, the second device is implemented to be computationally and battery-power like significantly stronger and more powerful than the first device. The first device can be an earbud device, a headphone device, an in-ear device or any other wearable device that typically has a limited battery power. However, the second device can be a highly powered device such as a mobile phone, a smart watch, a laptop computer, a tablet or even a stationary computer connected to the power mains and also typically connected to a large area network such as the internet. Advantageously, as already outlined with respect to FIG. 15, the first device not only comprises the processing block for the direct sound part 916 but also comprises a microphone for the recording of the acoustic measurement for the RIR provision and, additionally, the functionality for sound rendering as illustrated by the sound generator 300 of FIG. 1 and, additionally, the speakers when the device is a headphone device, for example. Alternatively, the speakers can also be separate when the speakers are provided with Bluetooth signals, for example, from the device 901 which has the communication interface rather than the actual speakers.

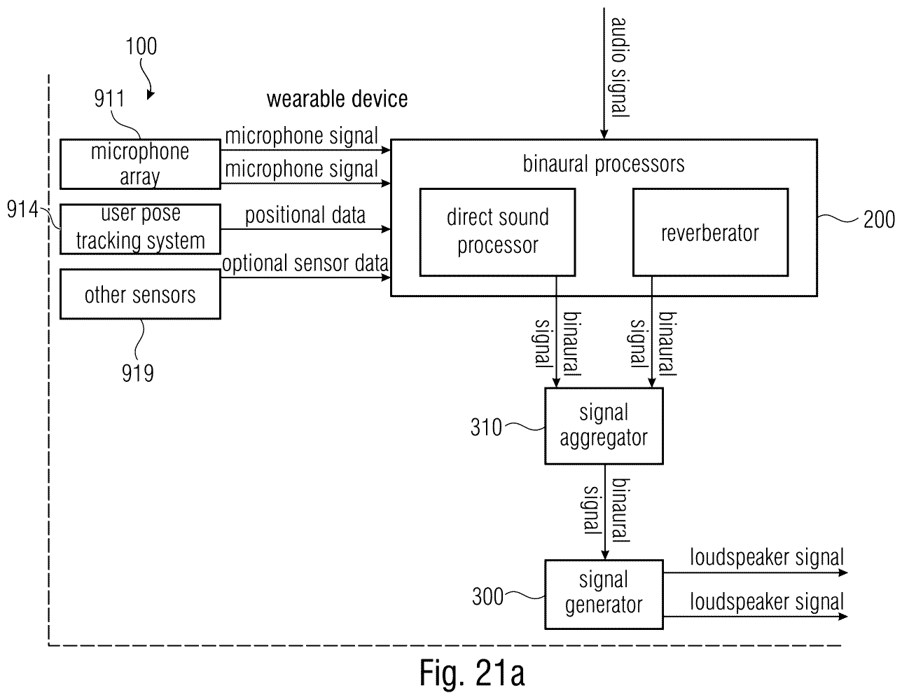

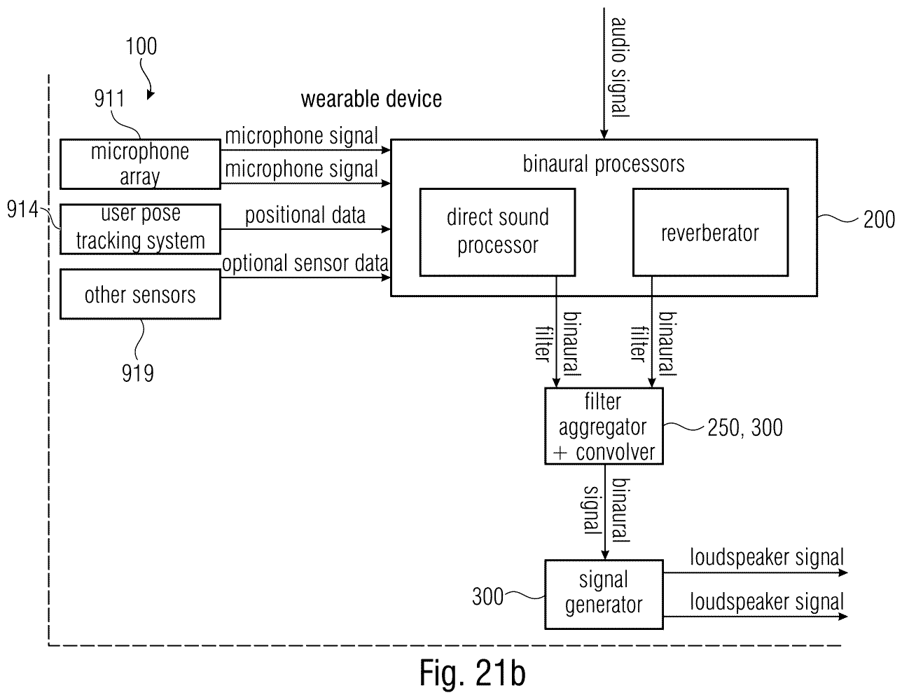

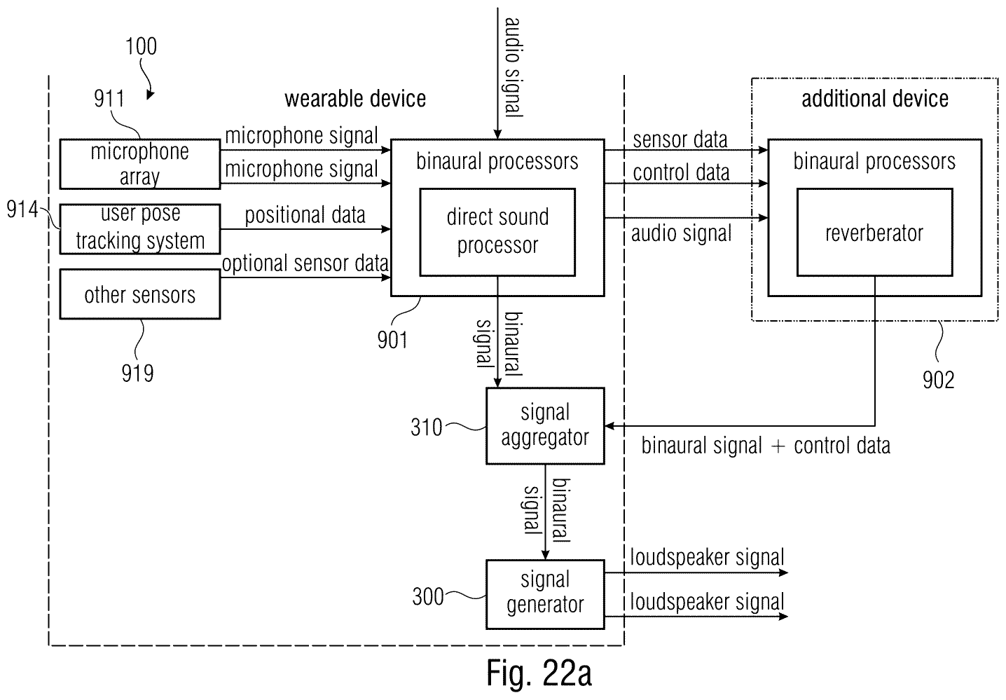

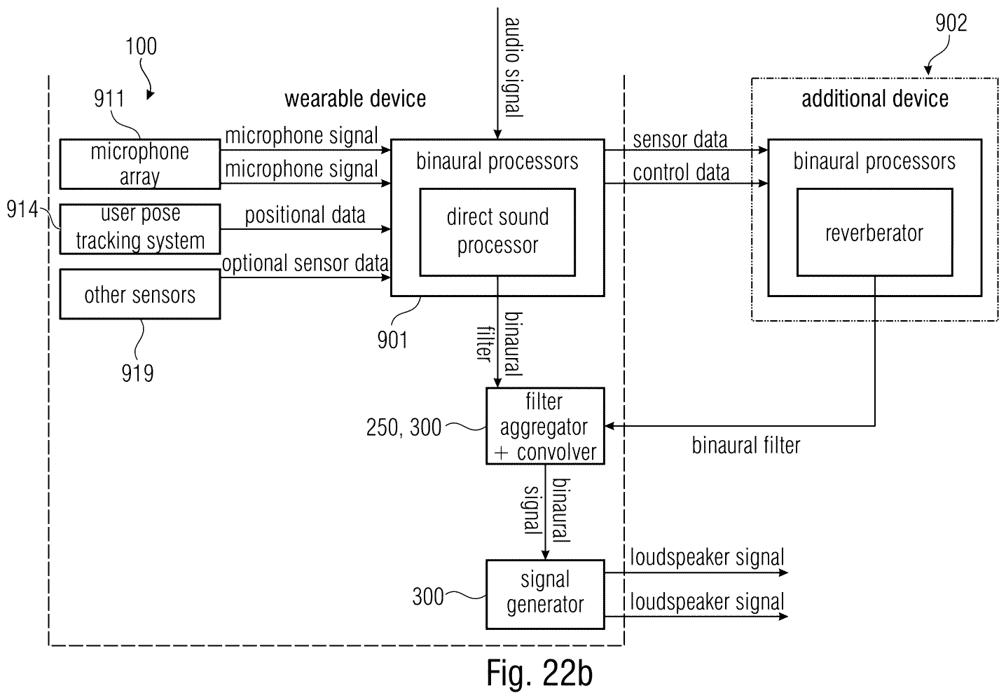

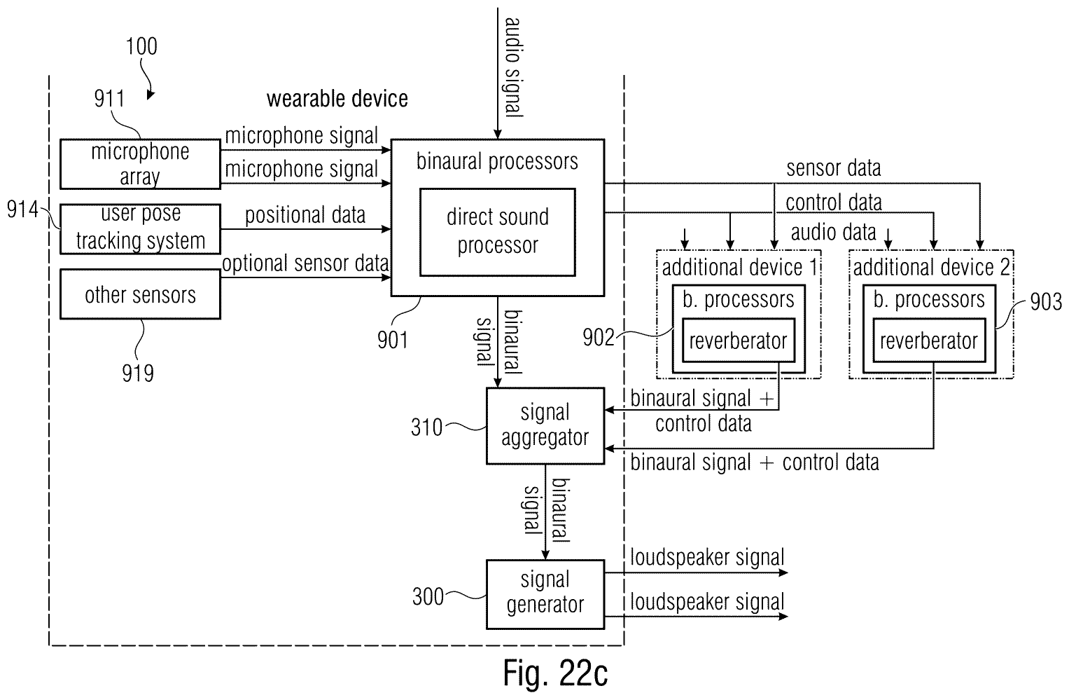

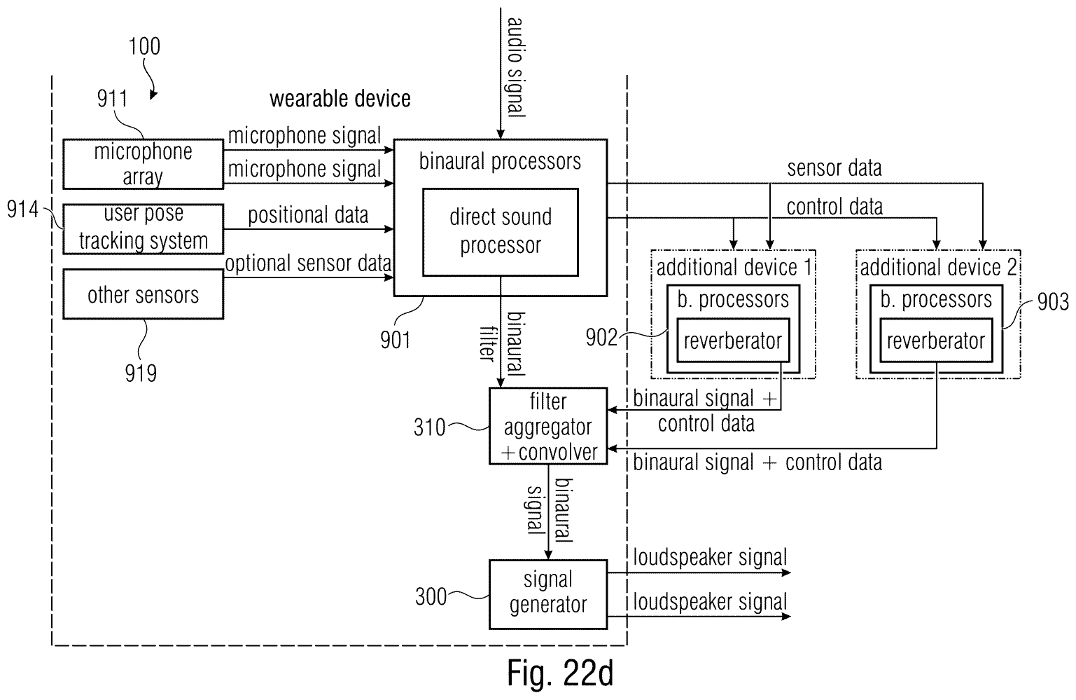

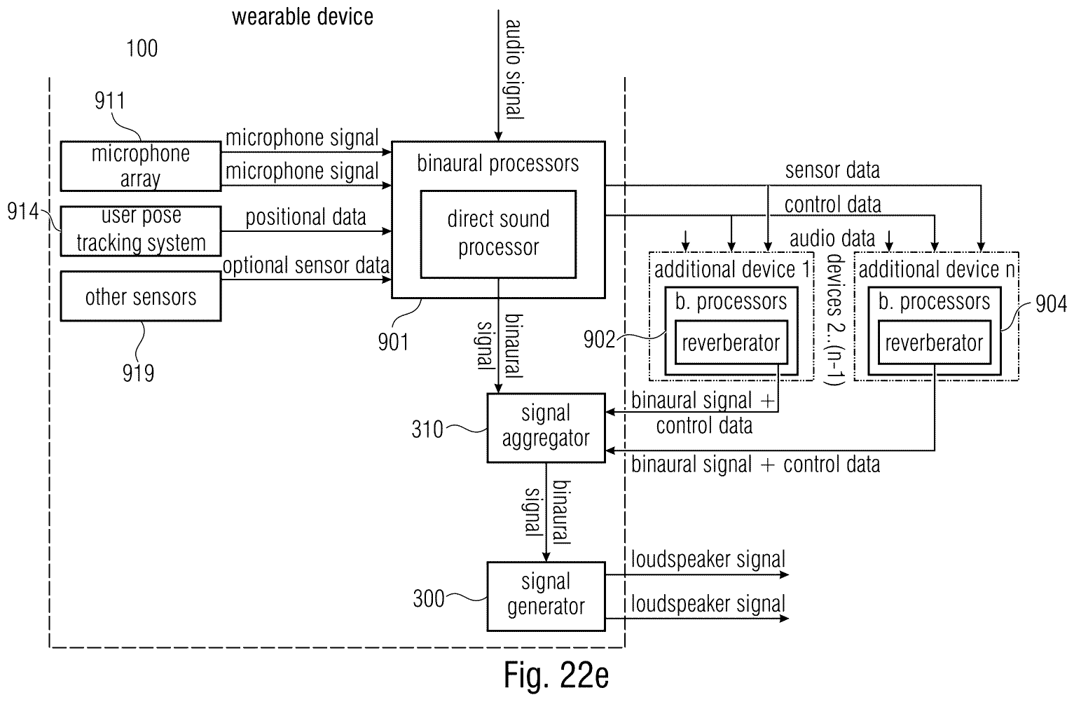

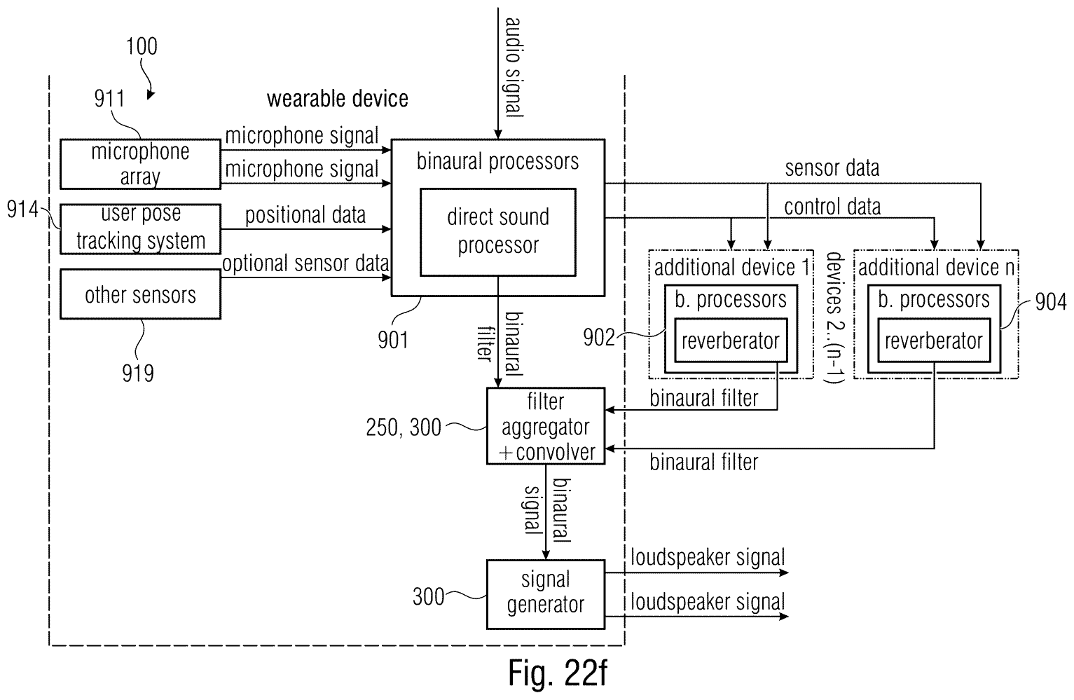

FIG. 21a and FIG. 21b illustrate the starting point for the embodiments in accordance with the sixth aspect which is illustrated in FIGS. 22a to 22f. Particularly, in FIG. 21a, the input interface comprises a microphone array consisting of one or more microphones illustrated at 911, and a user post tracking system 914 as well as potentially provided other sensors 919. The binaural processors in block 200 comprise the direct sound processor and a reverberator for generating binaural signals, and the signals are then aggregated by a signal aggregator 310 to have a two-channel binaural signal that is then processed by the signal generator. The functionality of the signal aggregator is as in FIG. 23b.

Conversely, FIG. 21b has a similar implementation, but the binaural filter parts are aggregated as shown in the filter aggregator block 250, 300 and the result of the filter aggregation is processed by the sound generator 300 or “auralizer” in FIG. 21b implementing the procedure schematically illustrated in FIG. 23a.

In accordance with the present invention as defined in the sixth aspect, the reverberation processing is implemented in the second device and the direct sound processing is implemented in the first device 901. Additionally, the functionalities of the input interface 100, the signal aggregator 310 and the signal generator 300 are also implemented in the first device 901 of FIG. 22a implementing the processing alternative of FIG. 23a. FIG. 22b is similar to FIG. 22a, but with the signal processing alternative of FIG. 23b. FIG. 22c illustrates a further embodiment which is different from the embodiments of FIG. 22a and FIG. 22b in that a second additional device 903 is provided. Particularly, in this embodiment, the second device 903 typically processes the late reverberation processing of block 240 of FIG. 2, where the first additional device 902 performs the early refraction processing of block 230 of FIG. 2, and the direct sound processor in the first device performs the direct sound processing 220 of FIG. 2. Again, the signal aggregator 310 aggregates individually convolved audio signals as illustrated in the FIG. 23b alternative. FIG. 22d is similar to FIG. 22c but now with the functionality of the filter aggregation in line with the processing alternative of FIG. 23a.

FIG. 22e illustrates a further implementation where even more than two additional devices are provided. Such a further device 904 can, for example, be implemented to do the initialization task such as the calculation of the image sources and image source positions so that the battery of the wearable device is used as less as possible. Then, the additional device 904 receives the microphone signal and the initial measurement data and performs the image source position processing and other initialization procedures such as the correct room impulse response determination using a database or so, since these tasks are to be performed even less often than the calculation of the late reverberation part. Other distributions of processing tasks to even more additional devices are useful as well. FIG. 22e again has the processing alternative of FIG. 23b, while FIG. 22f has the processing alternative of the filter aggregation of FIG. 23a.

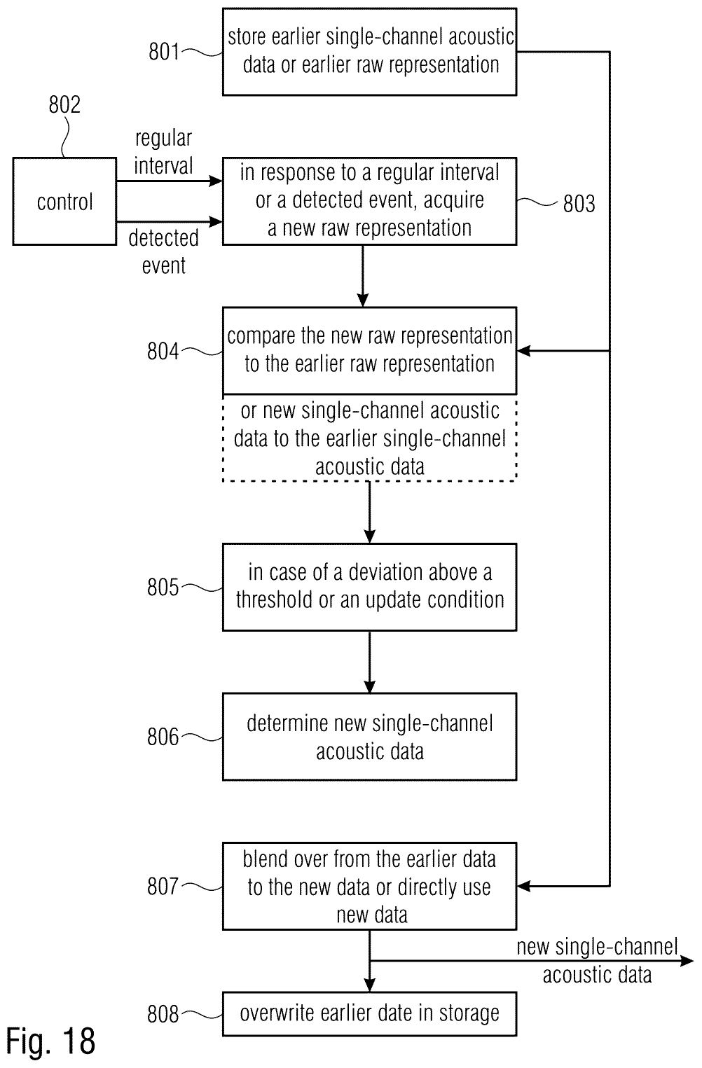

FIG. 18 illustrates an implementation of the processing in accordance with the sixth aspect, but this procedure can also be applied in any other aspect. In block 801, an earlier single-channel acoustic data or an earlier raw representation as obtained by block 150 for the fifth embodiment has been obtained.

In step 803, a new raw representation is acquired in reply to a control 802 that provides the activation signal to block 803 at regular intervals or at a detected event, i.e., when a user moves from one room into another room, so that an update of the whole room impulse response rather than an update of the user or listener position is necessary. In block 804, the new raw representation is compared to the earlier raw representation, or the new single-channel acoustic data are compared to the earlier single-channel acoustic data in order to find out whether an update is necessary at all.

In case it is determined in block 805 that the deviation is about a threshold or an update condition, a new single-channel acoustic data 806 is to be determined. In order to have a gradually change from one RIR to the next, a blend-over from the earlier data to the new data is used or, alternatively, the new data is directly used when it is not so much different from the earlier data. In block 808, the earlier data in the storage is overwritten with the current data so that, in the next procedure with block 801, the current single-channel acoustic data or the current raw representation is there.

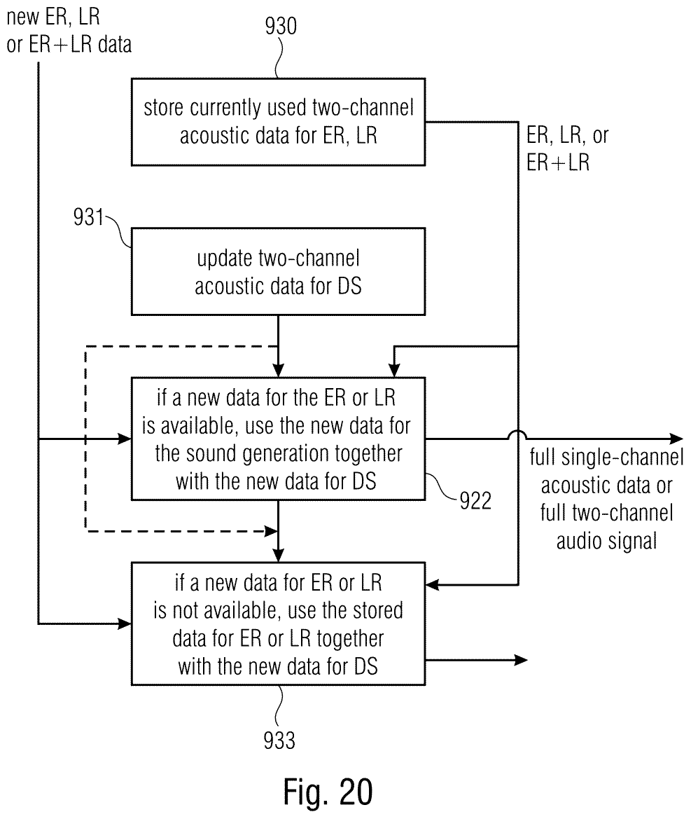

Subsequently, FIG. 20 is illustrated for the purpose of processing a two-channel synthesis with different update ratios. In block 930, the currently used two-channel acoustic data for the earlier reflection and the late reverberation are stored. In block 931, it is assumed that an update of the two-channel acoustic data for the direct sound portion has been performed. In block 932, it is determined whether a new data for the early reflection part or the later reverberation part is available. If this question is confirmed, then the new data is used for the sound generation together with the new data for the direct sound. However, when it is determined in block 933 that the new data for the earlier reflection part or the late reverberation is not available, then the stored data for the earlier reflection part or the late reverberation part is used together with the new data for the direct sound part. Hence, due to the fact that always the two-channel acoustic data for the portions with the reduced update rate are stored, this data can easily be used together with a new updated direct sound portion which requires a high update rate.

Subsequently, an embodiment of the present invention related to the seventh aspect that refers to an improved separation of the single-channel acoustic data and an improved combination of the two-channel acoustic data is illustrated.

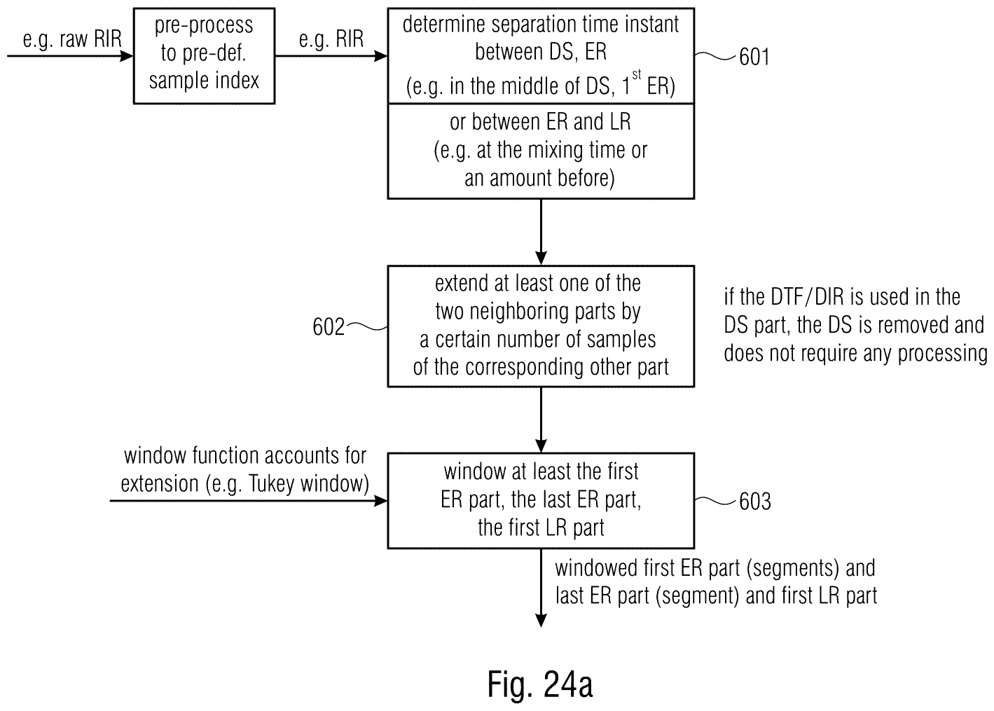

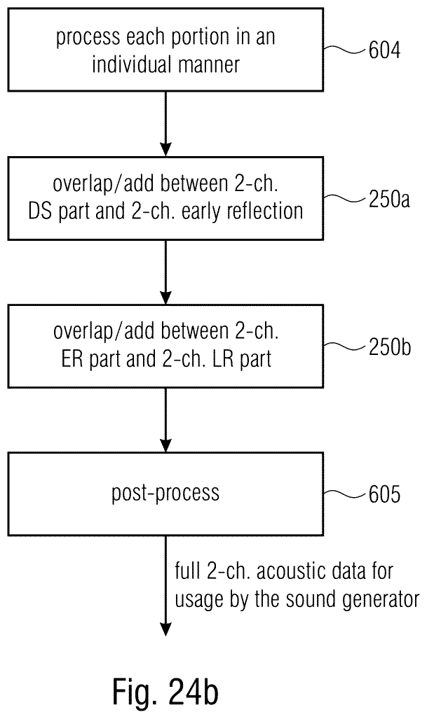

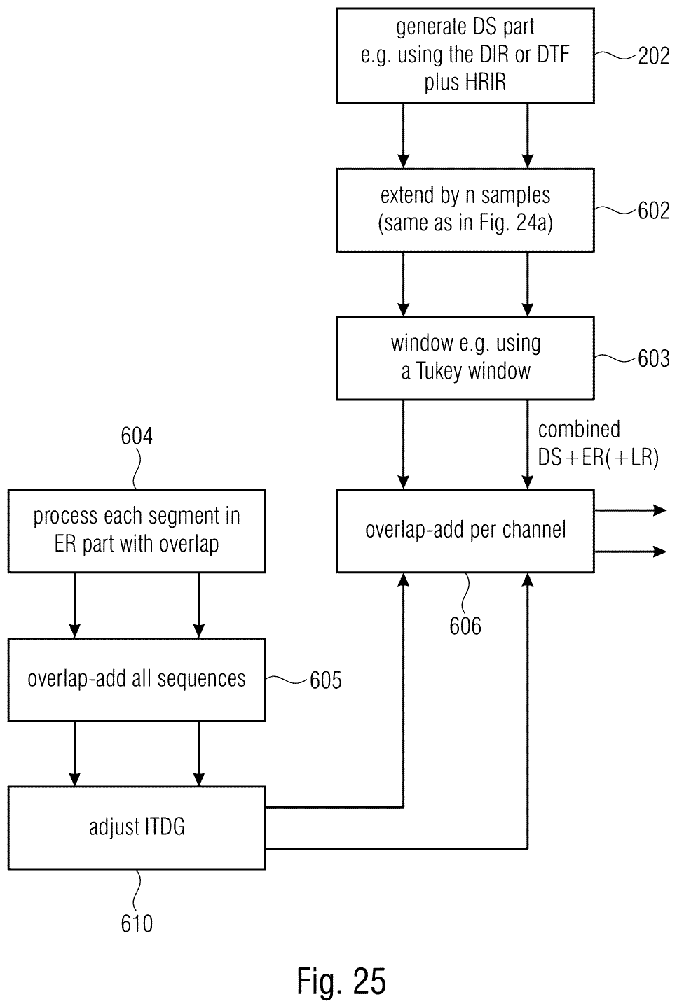

In FIG. 24a, block 600 refers to a pre-processing of the whole room impulse response as, for example determined form a database or from a measurement or from a synthesis process so that the direct sound portion of the room impulse response is at a predefined sample index. Then, this preprocessed room impulse response is forwarded, from the input interface 100, to the two-channel synthesizer and, particularly, the block 210 that forms the separation. In block 601, a separation time instant between the direct sound part and the earlier refraction sound part is determined, for example, in the middle between the maximum of the direct sound part and the maximum of the first earlier reflection. Additionally, or alternatively, a separation time is determined between the early deflection part and the late reverberation part, for example, at the mixing time or, for the purpose of saving computational resources, a certain predetermined amount of time before the mixing time.

In block 602, at least one of the two neighboring parts is extended by a certain number of samples of the corresponding other part. When, for example, the directivity transfer function or directivity impulse response is used in the direct sound part, then the direct sound part is removed and does not require to be extended or subsequently windowed by block 603. However, when a directivity transfer function is not used or, for some reason, the direct sound part of the RIR is used, then the processing in block 602 and 603 is also applied to the portion of the direct sound part at the first separation time instant. In block 603, at least the first earlier reflection part, the last earlier reflection part and the first late reverberation part are windowed using a window function that accounts for the extension such as a Tukey window. Thus, at the output of block 603, there exists a windowed first early reflections part, a windowed last early reflections part and a windowed first late reverberation part.

FIG. 24b illustrates the procedure when the individually processed data are put together as illustrated in FIG. 2, item 250. To this end, before the combination, each portion is processed in an individual manner as indicated at block 604, and the manners are as illustrated with respect to items 220, 230 and/or 240 of FIG. 2. Then, an overlap-add between the two-channel direct sound part and the two-channel earlier reflection part is performed in block 250a, and an overlap-add between the two-channel earlier reflection part and the two-channel late reverberation part is performed in block 250b and, finally, a post-processing in block 605 is performed to obtain the full two-channel acoustic data for the usage by the sound generator 300 of FIG. 1.

In an implementation as illustrated in FIG. 25, a direct sound part is generated, for example, using the directivity impulse response or the directivity transfer function plus the associated head related impulse response. The result is extended by n samples in a similar procedure as discussed before with respect to FIG. 24a and, in block 603, a windowing, for example, using a Tukey window is performed.

Furthermore, each segment in the early reflection part is processed with an overlap and all sequences are overlap-added as illustrated in block 605, and in block 610 it is of advantage to adjust the initial time delay gap. Subsequent to the adjustment of the initial time delay gap, an overlap-add per channel is performed as illustrated in block 606 to finally obtain the aggregated two-channel data for the acoustic environment.

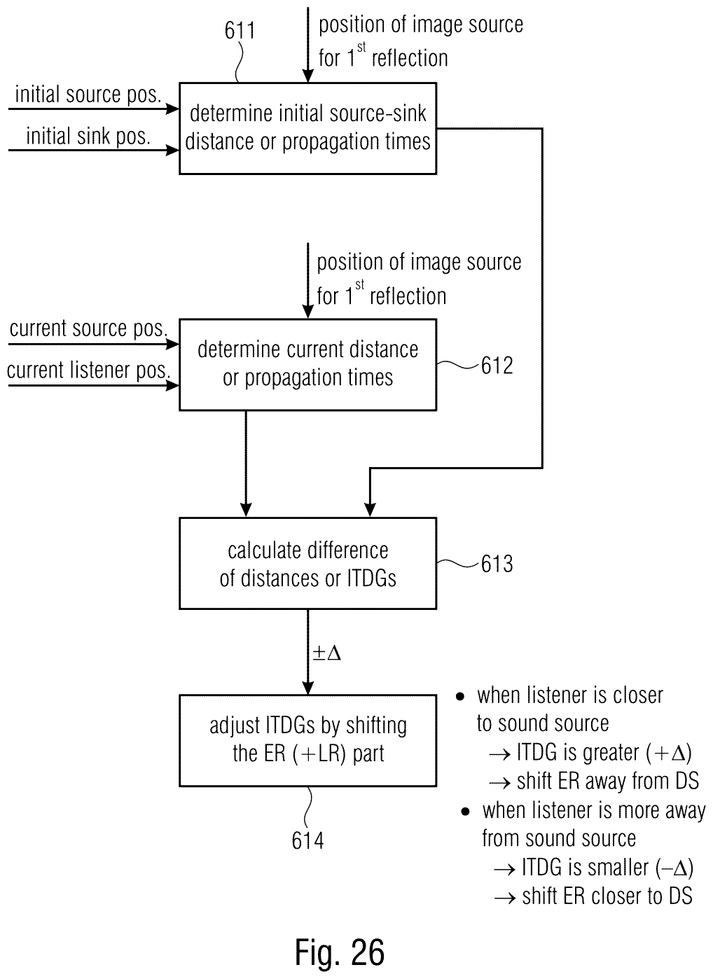

FIG. 26 illustrates an implementation of the procedure performed in block 610 of FIG. 25 for the purpose of initial time delay gap adjustment. In block 611, an initial source position and an initial sink position are used to determine the initial source-sink distance or initial propagation times, additionally placed on the position of the image source for the first reflection.

In block 612, a current source position and a current listener positon are used to calculate, together with the position of the image source for the first reflection, the current distance or the corresponding propagation times. In block 613, a difference of distances or a difference of the corresponding propagation times, for example, a delta ITDGs is calculated in block 630, and in block 640 the ITDG is adjusted by shifting the earlier reflection part (typically with the already “connected late reverberation part” more to the direct sound or further away from the direct sound. When, for example, the listener is closer to the sound source, then the ITDG is greater than the initial time delay gap and, therefore, the earlier reflections portions is shifted away from the direct sound portion. Thus, the overlap does not match anymore in the perfect manner and this can be accounted by padding with some samples in order to have a full overlap at the beginning of the ER portion.

However, when the listener is more away from the sound source compared to the initial measurement situation, then the ITDG is smaller and the delta is negative. In this case, the earlier reflection part is shifted closer to the direct sound part which is managed by simply truncating several samples in front of the earlier reflection part so that these samples are not overlap-added into the direct part in block 606 of FIG. 25 which are subsequent to the ITDG adjustment in block 610.

Thus, to keep the distance perception plausible, the initial time delay gap (ITDG) needs to be appropriate for the listener pose to be synthesized. This acoustic feature describes the gap between the direct sound and the first reflection. Therefore, the timing relation between DS and ER must be adapted. In the basic embodiment of the binaural synthesizer, this is achieved by shifting the ER segment in time, as the system is designed to keep the DS part in place. Utilizing the image source model, the ITDG can be calculated by getting the propagation time of the image source closest to the listener's position and subtracting this from the propagation time of the direct sound. This is done for the source-sink-constellation of the initial conditions as well as for the new constellation to be synthesized. The difference between the two ITDG values gives how much the ER segment needs to be shifted to represent the new situation. E.g. when the listener is closer to the sound source compared to the initial constellation, the ITDG will be larger, thus the ER segment is shifted a little away from the DS. In other embodiments, this mechanism might be derived from the image source model directly by placing the individual reflections in relation to the direct sound.

Subsequently, examples of the present invention relating to the first aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
wherein the two-channel synthesizer (200) is configured
to separate (210) the single-channel acoustic data into at least two parts consisting of a direct sound part and at least one of an early reflection part and a late reverberation part, and to individually process (220, 230, 240) the at least two parts for generating two-channel acoustic data for each part,
to determine (222), for the listener position and a source position or orientation of a sound source, directivity information of the sound source, and
to use the directivity information in the calculation (220) of the two-channel acoustic data for the direct sound part.

2. Audio signal processor of example 1, wherein the two-channel synthesizer (200) is configured to determine (227, 228), in addition to the directivity information, two head-related data channels from the source position and the listener position or orientation and to use (229) the two head-related data channels, and the directivity information in the calculation of the two-channel acoustic data for the direct sound part.

3. Audio signal processor of example 1 or 2, wherein the two-channel synthesizer (200) is configured to determine (222) a direction of emittance information from a source location vector (423) of the sound source and a listener location vector (422) of the listener and a rotation of the sound source and to derive the directivity information from a database of directivity information sets, wherein a directivity information set is associated with a certain source emittance direction information.

4. Apparatus of example 2 or 3, wherein the two-channel synthesizer (200) is configured to derive a direction of arrival (421) for the listener position or orientation using a source location vector (423) of the sound source and a listener location vector (422) of the listener and the rotation of the listener.

5. Apparatus of one of the preceding examples, wherein the directivity information is a directivity impulse response or a directivity transfer function, or wherein the two head-related data channels are a first head-related impulse response or a first head-related transfer function and a second head-related impulse response or a second head-related transfer function, or wherein the source emittance direction information comprises an angle or an index for a database.

6. Apparatus of one of the preceding examples, wherein the two-channel synthesizer (200) is configured to determine a directivity impulse response as the directivity information,
to determine a first head-related impulse response and a second head-related impulse response as the two head-related data channels, and
to combine the directivity impulse response and the first head-related impulse response and to combine the directivity impulse response and the second head-related impulse response by convolving in a time domain or using a frequency domain multiplication.

7. Apparatus of example 6, wherein the two-channel synthesizer (200) is configured
to perform (261) a padding operation with the directivity impulse response and the first and second head-related impulse responses to obtain padded functions,
to transform (262) the padded functions into a frequency domain,
to multiply (263) a frequency domain directivity information and the frequency domain head-related data channels to obtain two frequency domain data channels, and
to transform (264) the two frequency domain data channels into the time domain to obtain a time domain data portion for the direct sound part of the two-channel acoustic data.

8. Audio signal processor of example 6 or 7, wherein the two-channel synthesizer (200) is configured to adjust (265) a phase of the two-channel acoustic data by removing a phase shift introduced by the convolution, and to truncate (266) a phase-adjusted two-channel acoustic data, so that a time-domain representation of the two-channel acoustic data has a length being equal to a length of the direct sound part of the single-channel acoustic data describing the acoustic environment.

9. Apparatus of one of the preceding examples,
wherein the two-channel synthesizer (200) is configured to determine (221) an energy-related measure from the direct sound part,
to determine (223) an energy-related measure from a raw directivity information determined for the listener position or orientation and the source position, and
to scale (226) the raw directivity information using a scaling value derived (224) from the energy-related measures to derive the determined directivity information.

10. Apparatus of one of the preceding examples,
wherein the two-channel synthesizer (200) is configured to determine (225) a distance scaling information from a distance between the source position and the listener position, and
to account for (226) the distance in the calculation of the two-channel acoustic data for the direct sound part.

11. Signal processor of example 10,
wherein the two-channel synthesizer (200) is configured to generate an amplified two-channel acoustic data for the direct sound part in case of an actual distance being lower than a distance in an initial situation where the single-channel acoustic data has been determined, and to generate an attenuated two-channel acoustic data for the direct sound part in case of an actual distance being greater than the distance in the initial situation.

12. Apparatus of one of the preceding examples,
wherein the two-channel synthesizer (200) is configured to combine the directivity information and a head-related impulse response as the head-related channel data using padding (261) both filters to an increased length, multiplying (263) both filters in a spectral domain, converting (264) two multiplication results into the time domain, and removing (265) an introduced phase so that a center index of a result is similar to a center index of the direct sound part of the single-channel acoustic data describing the acoustic environment.

13. Audio signal processor of one of examples 8 or 12, wherein the two-channel synthesizer is configured to apply the distance scaling information (226) to a result of a phase removal in the time domain.

14. Audio signal processor of one of the preceding examples,
wherein the two-channel synthesizer (200) is configured to update the calculation (222) of the direct sound part more frequently than the calculation (232) for the early reflection part or the calculation (240) for the late reverberation part.

15. Audio signal processor of one of the preceding examples configured for comprising or accessing a storage for directivity information data sets for a plurality of angles with respect to a predetermined sound emission direction (430) of the sound source distributed over a cylinder or a sphere around the sound source position, and
wherein the two-channel synthesizer is configured to derive (269, 270, 271) from a sound emittance direction determined (268) for the listener position and the sound source position and orientation, a directivity information data set having a reference to a directivity information data set that is closest to the sound emittance direction, or to derive (271) two or more directivity information data sets having reference information being closest to the determined sound emittance direction and to interpolate between the two or more directivity information data sets to obtain the directivity information, or
to synthesize (272) the directivity information using the determined sound emittance direction and a directivity model for the sound source.

16. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data,
wherein the synthesizing comprises
separating (210) the single-channel acoustic data into at least two parts consisting of a direct sound part and at least one of an early reflection part and a late reverberation part, and to individually process (220, 230, 240) the at least two parts for generating two-channel acoustic data for each part,
determining (222), for the listener position and a source position or orientation of a sound source, directivity information of the sound source, and
using the directivity information in the calculation (220) of the two-channel acoustic data for the direct sound part.

17. Computer program for performing, when running on a computer or a processor, the method of example 16.

Subsequently, examples of the present invention relating to the second aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
wherein the two-channel synthesizer (200) is configured to separate (210) the single-channel acoustic data into at least two parts consisting of a direct sound part and at least one of an early reflection part and a late reverberation part, and to individually process (220, 230, 240) the at least two parts for generating two-channel acoustic data for each part,
wherein the two-channel synthesizer (200) is configured to segment (231) the early reflection part into a plurality of segments,
to determine (232) a plurality of image source positions representing source positions of reflecting sound,
to associate the image source positions to the segments using a matching operation, wherein the matching operation comprises calculating a time of sound arrival for each image source to the listener position and associating (234) the image source positions to corresponding segments that have time delays in the corresponding segments best matching with the time of sound arrival of the corresponding image source positions, and
to calculate the two-channel acoustic data for the direct sound using the image source positions associated to the segments.

2. Audio signal processor of example 1,
wherein the two-channel synthesizer (200) is configured to determine (232) the plurality of image source positions using an initial source position and an initial sink position of an initial measurement for the generation of the single-channel acoustic data for the acoustic environment and geometric data on the acoustic environment.

3. Audio signal processor of example 1 or 2, in which the two-channel synthesizer (200) is configured to determine the image source positions using an image source method modelling specular reflections in the acoustic environment.

4. Audio signal processor of one of the preceding examples, wherein the two-channel synthesizer (200) is configured to determine the image source positions up to a predetermined order, and
to use (235) random or predetermined direction of arrival data or two-channel head-related data for a reflection in a segment that does not have an associated image source position or that does not have a time of sound arrival being in a predetermined matching range to a time delay of a reflection in a segment.

5. Audio signal processor of one of the preceding examples,
wherein the two-channel synthesizer is configured to detect salient reflections in the early reflection part and to place a segment around each salient reflection, the segment having a predetermined length corresponding to a length of a head-related impulse response or to partition the early reflection part into a regular grid of reflection segments each having a sample count and an overlap to an adjacent segment.

6. Audio signal processor of example 5, wherein the two-channel synthesizer is configured to detect the salient reflection by comparing (283) a first average energy per sample in a first window with a second average energy per sample in a second window, wherein a sample count of the second window is greater than a sample count of the first window, wherein a salient reflection is determined, when the first average energy is greater than the second average by a predetermined amount.

7. Audio signal processor of example 6, wherein the predetermined amount is between 3 dB and 9 dB, or wherein a sample count of the first window is smaller than a sample count of the second window advantageously by at least a factor of 0.25.

8. Audio signal processor of one of the preceding examples, wherein the two-channel synthesizer (200) is configured to determine (284) for each segment, a direction of arrival information from the listener position and the image source position associated to the respective segment and to combine the early reflection part in the segment and two head-related data channels associated with the direction of arrival information to obtain at least a part of the two-channel acoustic data for the segment.

9. Audio signal processor of one of the preceding examples,
wherein the two-channel synthesizer (200) is configured to pad (285) the segment to a length of the two-channel acoustic data in a time domain,
to convert the padded segment into a frequency domain and to multiply a frequency domain padded segment by each channel of the head-related two-channel data in the frequency domain to obtain a frequency domain two-channel acoustic data for the segment, and
to transform the frequency-domain two-channel data for the segment into the time domain.

10. Audio signal processor of example 9, wherein the two-channel synthesizer is configured to remove an introduced phase delay from the two-channel acoustic data in the time domain.

11. Audio signal processor of one of the preceding examples, wherein the two-channel synthesizer (200) is configured to generate the two-channel acoustic data for each segment from a combination (239) of a specular part derived using the image source positions associated to the segments and a diffuse part for the corresponding segment.

12. Audio signal processor of one of the preceding examples,
wherein a single-channel acoustic data describing the acoustic environment is a room impulse response or a room transfer function, or wherein the two-channel acoustic data is a binaural two-channel head-related impulse response or a binaural two-channel head-related transfer function.

13. Audio signal processor of one of examples 2 to 11, wherein the two-channel synthesizer is configured to maintain the image source position for a listener position at the initial sink position and at a listener position different from the initial sink position, or for the initial source position or a source position being different from the initial source position, or to maintain the association between the segments and the image source positions for a source position at the initial source position or a source position being different from the initial source position.

14. Audio signal processor of one of the preceding examples, wherein the two-channel synthesizer is configured to determine, for the listener position and an image source position or orientation of an image sound source, directivity information of the image sound source, and to use the directivity information in the calculation (220) of the two-channel acoustic data for the earlier reflection sound part.

15. Audio signal processor of example 14, wherein the directivity information for each image source is derived from the same set of directivity information determined for the direct sound part, or wherein an orientation of the image sound source is determined by an image source model.

16. Audio signal processor of example 14 or 15, wherein the directivity information is determined and used for a predetermined subset of the segments in the early reflection part.

17. Audio signal processor of example 14 or 15, wherein the predetermined subset of segments in the early reflection part comprises less than ten segments and advantageously only 2 segments.

18. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data, wherein the generating comprises
separating (210) the single-channel acoustic data into at least two parts consisting of a direct sound part and at least one of an early reflection part and a late reverberation part, and to individually process (220, 230, 240) the at least two parts for generating two-channel acoustic data for each part,
segmenting (231) the early reflection part into a plurality of segments,
determining (232) a plurality of image source positions representing source positions of reflecting sound, and
associating the image source positions to the segments using a matching operation, wherein the matching operation comprises calculating a time of sound arrival for each image source to the listener position and associating (234) the image source positions to corresponding segments that have time delays in the corresponding segments best matching with the time of sound arrival of the corresponding image source positions, and
calculating the two-channel acoustic data for the direct sound using the image source positions associated to the segments.

19. Computer program for performing, when running on a computer or a processor, the method of example 18.

Subsequently, examples of the present invention relating to the third aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
wherein the two-channel synthesizer (200) is configured to separate (210) the single-channel acoustic data into at least two parts consisting of a direct sound part and at least one of an early reflection part and a late reverberation part, and to individually process (220, 230, 240) the at least two parts for generating two-channel acoustic data for each part, and
wherein the two-channel synthesizer (200) is configured to calculate (230) the two-channel acoustic data for the early reflection part using a specular part describing distinct early reflections and a diffuse part describing a diffuse influence in the early reflection part.

2. Audio signal processor of claim 1, wherein the two-channel synthesizer is configured to calculate (238) the diffuse part using a combination of the early reflection part of the single-channel acoustic data and a two-channel noise sequence.

3. Audio signal processor of example 1 or 2, wherein the two-channel synthesizer (200) is configured to perform a weighted addition (239, 290) of the specular part (292) and the diffuse part (293), wherein weights for the weighted addition are determined by a diffuseness coefficient indicating how diffuse a segment of the early reflection part of the single-channel acoustic data is.

4. Audio signal processor of one of the preceding examples, wherein the two-channel synthesizer (200) is configured to determine the diffuseness coefficient from a ratio of a first average of energy per sample in a first window with a sample count n and a second average of energy per sample in a second window with a sample count m around the first window,
wherein, when the ratio plus a first predetermined number divided by a second predetermined number is 1 or greater than 1, the part is considered to be fully specular, or is 0 or lower than 0, the part is considered to be fully diffuse, and wherein the second predetermined number is greater than the first predetermined number by at least 3 dB, or has a value in a range between 1.5 and 2.5 times the value of the first predetermined number.

5. Audio signal processor of one of the preceding examples, wherein the two-channel synthesizer is configured to segment the early reflection part into a plurality of segments and to calculate the specular part and the diffuse part for each segment.

6. Audio signal processor of one of examples 3 to 5, wherein the weights for the weighted addition are furthermore determined by a position of a segment of the early reflection part with respect to the direct sound part and the late reverberation part, so that a weight of the specular part for a segment close to the direct sound part is enhanced and a weight of the diffuse part close to the later reverberation part is enhanced.

7. Audio signal processor of example 6, wherein the weights are determined so that the specular part for a segment being closer in time to the direct sound part has a greater weight than the specular data for a segment being closer in time to the late reverberation part, or so that diffuse data for a segment being closer in time to the direct sequence part have a lower weight than specular data for the segment being closer in time to the direct sound part, or wherein the weights for the specular data for the segments are determined using a diffuseness measure for the segment, and wherein the weights for the diffuseness data for the segments are determined using the diffuseness measure for the specular data for the corresponding segment.

8. Audio signal processor of one of the preceding examples, wherein the multi-channel synthesizer (200) is configured
to calculate the specular part in two channels using direction of arrival data depending on the listener position or orientation and the source position for the early reflection part and a convolution of head-related data channels associated with the direction of arrival data and the early reflection part of the single-channel acoustic data,
to calculate the diffuse part using a combination of two-channel binaural noise data and the early reflection part of the single-channel acoustic data, and
to combine the specular part and the diffuse part.

9. Audio signal processor of example 8, wherein the two-channel synthesizer (200) is configured
to calculate the specular part (292) in a plurality of segments of the early reflection part to obtain first channel specular data for the plurality of segments and second channel specular data for the plurality of segments,
to calculate the diffuse part in the same plurality of segments of the early reflection part to obtain first channel diffuse segment data and second channel diffuse segment data,
to combine, per segment, the first channel specular data for the segment and the first channel diffuse specular data for the segment to obtain a first channel of the early reflection data for the segment, and
to combine the second channel specular data for the segment and the second channel diffuse data for the segment to obtain a second channel of the early reflection data for the segment.

10. Audio signal processor of example 9, wherein the multi-channel synthesizer (200) is configured to linearly combine using a first weighting coefficient and a second weighting coefficient, wherein the first weighting coefficient and the second weighting coefficient add up to substantially unity.

11. Audio signal processing of example 9 or 10, wherein the two-channel synthesizer (200) is configured
to window overlapping segments of the early reflection part of the single-channel acoustic data using a window function when calculating the first and second channel specular segment data,
to window overlapping segments of the first channel diffuse segment data using a similar window function,
to window overlapping segments of the second channel diffuse segment data using the similar window function, and
to perform a weighted addition of corresponding first channel specular segment data and first channel diffuse segment data and second channel specular segment data and second channel diffuse segment data to obtain the two-channel acoustic data for the early reflection part.

12. Audio signal processor of example 11, wherein the two-channel synthesizer is configured to overlap and add, for each channel, result data for the sequence of segments for obtaining the two-channel audio data of the early reflection part.

13. Audio signal processor of example 12, wherein the two-channel synthesizer is configured to account (610) for an initial time delay gap depending on the source position and the listener position by shifting in time a result of the overlap add operation with the segments with respect to the direct sound part to obtain the early reflection part in a timing relation to the direct sound part.

14. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data,
wherein the synthesizing comprises
separating (210) the single-channel acoustic data into at least two parts consisting of a direct sound part and at least one of an early reflection part and a late reverberation part, and to individually process (220, 230, 240) the at least two parts for generating two-channel acoustic data for each part, and
calculating (230) the two-channel acoustic data for the early reflection part using a specular part describing distinct early reflections and a diffuse part describing a diffuse influence in the early reflection part.

15. Computer program for performing, when running on a computer or a processor, the method of example 14.

Subsequently, examples of the present invention relating to the fourth aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
wherein the two-channel synthesizer (200) is configured to separate (210) the single-channel acoustic data into at least two parts consisting of a direct sound part and at least one of an early reflection part and a late reverberation part, and to individually process (220, 230, 240) the at least two parts for generating two-channel acoustic data for each part, and
   wherein the two-channel synthesizer (200) is configured to calculate a two-channel diffuse portion of the early reflection part or of the single-channel acoustic data without the direct sound part or of the late reverberation part using a magnitude spectrum of the early reflection part or of the single-channel acoustic data without the direct sound part or of the late reverberation part and a first channel noise phase spectrum for obtaining a first channel of the two-channel acoustic data and using a magnitude spectrum of the early reflection part or of the single-channel acoustic data without the direct sound part or of the late reverberation part and a second channel noise phase spectrum.

2. Audio signal processor of example 1, wherein the first channel noise phase spectrum and the second channel noise phase spectrum are derived from a two-channel binaural noise sequence.

3. Audio signal processor of example 1 or 2, wherein the two-channel synthesizer (200) is configured to calculate (530) a first spectrogram for the early reflection part of the single-channel acoustic data or of the single-channel acoustic data without the direct sound part or of the late reverberation part of the single-channel acoustic data, and a second spectrogram for the first channel noise phase spectrum and a third spectrogram for the second channel noise phase spectrum.

4. Audio signal processor of example 3, wherein the two-channel synthesizer is configured to calculate the first spectrogram as a first sequence of magnitude spectra, to calculate the second spectrogram as a second sequence of phase spectra, to calculate the third spectrogram as a third sequence of phase spectra, and to combine the first sequence of magnitude spectra and the second sequence of phase spectra to obtain a first channel for the two-channel diffuse portion, to combine the first sequence of magnitude spectra and the third sequence of phase spectra to obtain a second channel for the two-channel diffuse portion.

5. Audio signal processor of example 3 or 4, wherein the second channel synthesizer is configured to use overlapping segments and a window function for each segment in the calculation of the first spectrogram, the second spectrogram and the third spectrogram.

6. Audio signal processor of example 4 or 5, wherein the first spectrogram, the second spectrogram and the third spectrogram are calculated as complex spectra and are converted to a polar representation.

7. Audio signal processor of one of examples 4 to 6, wherein the two-channel synthesizer is configured to low-pass filter (448) the magnitude spectra of the sequence of magnitude spectra, so that a first sequence of low-pass filtered magnitude spectra is combined with the second and the third sequences of phase spectra.

8. Audio signal processor of example 7, wherein the low-pass filter is a moving average filter.

9. Audio signal processor of example 8, wherein the moving average filter extends over a size of between 0.1 and 0.75 octaves.

10. Audio signal processor of one of examples 3 to 9, wherein the multi-channel synthesizer is configured to perform (447), in the first sequence of spectra of the first spectrogram, or in a spectrogram of the first channel or the second channel of the second-channel diffuse portion, a low-pass filtering from spectrum to spectrum, so that frequency bins of adjacent spectra relating to the same frequency are low-pass filtered.

11. Audio signal processor of example 10, wherein the low-pass filter for the low-pass filtering is a moving average filter with a number of inputs between two and six.

12. Audio signal processor of example 4, wherein the two-channel synthesizer (200) is configured to transform (450) the first channel for the two-channel diffuse portion and the second channel for the two-channel diffuse portion into a time domain to obtain overlapping blocks for the first channel and the second channel.

13. Apparatus of example 12, wherein the two-channel synthesizer is configured to perform an overlap-and-add operation (452) for the overlapping time domain blocks for the first channel on the one hand and for the second channel on the other hand to obtain the diffuse part of the two-channel representation.

14. Apparatus of one of the preceding examples, wherein the two-channel synthesizer is configured to only use the diffuse portion in the late reverberation part as the two-channel acoustic data or to use a combination of the diffuse portion together with the specular portion as the two-channel acoustic data in the early reflection part.

15. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data,
wherein the synthesizing comprises
separating (210) the single-channel acoustic data into at least two parts consisting of a direct sound part and at least one of an early reflection part and a late reverberation part, and to individually process (220, 230, 240) the at least two parts for generating two-channel acoustic data for each part, and
calculating a two-channel diffuse portion of the early reflection part or of the single-channel acoustic data without the direct sound part or of the late reverberation part using a magnitude spectrum of the early reflection part or of the single-channel acoustic data without the direct sound part or of the late reverberation part and a first channel noise phase spectrum for obtaining a first channel of the two-channel acoustic data and using a magnitude spectrum of the early reflection part or of the single-channel acoustic data without the direct sound part or of the late reverberation part and a second channel noise phase spectrum.

16. Computer program for performing, when running on a computer or processor, the method of example 15.

Subsequently, examples of the present invention relating to the fifth aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
   wherein the input interface (100) is configured to acquire (150) a raw representation related to the single-channel acoustic data, and to derive (151) the single-channel acoustic data using the raw representation and additional data stored in the audio signal processor or accessible by the audio signal processor.

2. Audio signal processor of example 1, wherein the input interface (100) is configured
to acquire (150), as the raw representation, an initial measurement of raw single-channel acoustic data,
to derive (101) a test fingerprint, to access a pre-stored database with an associated set of reference fingerprints, wherein each reference fingerprint is associated to a high-resolution single-channel acoustic data, wherein the high-resolution single-channel acoustic data has a higher resolution than the initial measurement, and
to retrieve (113), from the pre-stored database the high-resolution single-channel acoustic data having a reference fingerprint best matching with the test fingerprint, or to synthesize (140) a high-resolution acoustic data from the test fingerprint from the initial measurement of the raw single-channel acoustic data or from geometric parameters.

3. Audio signal processor of example 1, wherein the input interface (100) is configured
to acquire, as the raw representation, an initial measurement of raw single-channel acoustic data,
to derive a test fingerprint, and
to synthesize (140) the single-channel acoustic data from the test fingerprint or from the initial measurement of the raw single-channel acoustic data.

4. Audio signal processor of example 1, wherein the raw representation is a geometric description of the acoustic environment, and wherein the input interface (100) is configured to perform an acoustic room simulation to derive the single-channel acoustic data from the geometric description.

5. Audio signal processor of example 1, wherein the input interface (100) is configured to determine, as the test fingerprint, at least one of the following parameters RT60, EDC, DRR, and
wherein the reference fingerprint comprises at least one of the following parameters RT60, EDC, DRR.

6. Audio signal processor of any one of the preceding examples, wherein the input interface (100) is configured to apply a psycho-acoustic weighting function to a calculated fingerprint to obtain the fingerprint for accessing the pre-stored database (110) or for performing a direct synthesis (140).

7. Audio signal processor of one of examples 1 to 3, wherein the input interface (100) is configured to derive the fingerprint using a trained neural network, or to perform a direct synthesis (140) using a trained neural network from the raw representation related to the single-channel acoustic data.

8. Audio signal processor of example 1, wherein the input interface (100) is configured to use a trained neural network to calculate the test fingerprint, wherein the trained neural network is trained to classify the single-channel acoustic data to classes of single rooms, and wherein the input interface (100) is configured to synthesize (153) a prototype single-channel acoustic data for a fingerprint indicating a matched room class, or to retrieve (152) the prototype single-channel acoustic data for the matched room class from the pre-stored database.

9. Audio signal processor of one of examples 1 to 5, wherein the input interface (100) is configured
to derive the test fingerprint, so that the test fingerprint has a lower dimension than the raw single-channel acoustic data,
   to derive, from the pre-stored database, the lower dimension reference fingerprint for using the same procedure as for the deriving of the test fingerprint, and
to select the single-channel acoustic data having a reference fingerprint that minimizes a distance to the test fingerprint.

10. Audio signal processor of one of the preceding examples, wherein the input interface (100) is configured to use, for an initial measurement, to a natural sound producible by a listener.

11. Audio signal processor of example 10, wherein the natural sound is clapping, or speech, or a transient sound producible by the listener.

12. Audio signal processor of example 1, wherein the input interface (100) is configured
to record (150) a piece of sound played in the acoustic environment by one or more speakers,
to determine (155, 156) an identification of the piece of sound using a sound identification process,
   to access (157) a database having at least on approximation of a representation of the piece of sound as played by the one or more speakers without an influence of the acoustic environment, and
   to determine (159) the single-channel acoustic data using the recorded piece of sound and the piece of sound as obtained from the database.

13. Audio signal processor of example 8, wherein the input interface (100) comprises a second trained neural network for generating the single-channel acoustic data from the test fingerprint calculated by the first trained neural network.

14. Audio signal processor of one of the preceding examples, wherein the input interface (100) comprises a speaker and a microphone embedded in a mobile device, and wherein the input interface (100) is configured to perform an initial measurement with the speaker and the microphone or only with the microphone embedded in the mobile device.

15. Audio signal processor of one of the preceding examples, wherein the input interface (100) is configured to receive new single-channel acoustic data at regular intervals or at a specific event, to compare the new single-channel acoustic data with the single-channel acoustic data and to replace the single-channel acoustic data with the new single-channel acoustic data, when a deviation exceeds a deviation threshold, or to compare a new initial measurement with an earlier initial measurement or to compare a new test fingerprint with an earlier test fingerprint or to compare a new raw representation with an earlier raw representation.

16. Audio signal processor of one of the preceding examples, wherein the input interface (100) is configured to store a history of earlier single-channel acoustic data in order to allow a blending from an earlier single-channel acoustic data to a new single-channel acoustic data.

17. Audio signal processor of example 16, wherein the blending comprises a linear interpolation in a time or frequency domain between an earlier single-channel acoustic data and a later single-channel acoustic data.

18. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data,
   wherein the synthesizing comprises acquiring (150) a raw representation related to the single-channel acoustic data, and deriving (151) the single-channel acoustic data using the raw representation and additional data stored in the audio signal processor or accessible by the audio signal processor.

19. Computer program for performing, when running on a computer or a processor, the method of example 18.

Subsequently, examples of the present invention relating to the sixth aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
wherein the two-channel synthesizer (200) is configured to separate (210) the single-channel acoustic data into at least two parts consisting of a direct sound part and at least one of an early reflection part and a late reverberation part, and to individually process (220, 230, 240) the at least two parts for generating two-channel acoustic data for each part, and
wherein the two-channel synthesizer comprises two physically separate device (901, 902), wherein the first device (901) of the two physically separated devices is configured to process (220, 230) at least one of the direct sound part and the early reflection part, wherein the second device (903) of the two physically separated devices is configured to process (230, 240) at least one of the early reflection part and the late reverberation part, and wherein the first device (901) and the second device (902) are connected via a transmission interface (918, 925) and have separate power supplies (917, 924).

2. Audio signal processor of example 1, wherein the first device (901) is configured to update the two-channel acoustic data for the direct sound part or the early reflection part more often than the second device (902) updates the two-channel acoustic data for at least one of the early reflection part and the late reverberation part.

3. Audio signal processor of example 1, wherein the transmission interface (918, 925) is configured to operate in accordance with a wireless transmission protocol.

4. Audio signal processor of one of the preceding examples, wherein the first device (901) is a wearable device and additionally comprises the input interface (100) and the sound generator (300), and wherein the second device (102) is a mobile device or a stationary device separate from the wearable device.

5. Audio signal processor of one of the preceding claims, wherein the wearable device (901) is an earbud device, a headphone device or an in-ear device, and wherein the mobile or stationary device is a mobile phone, a smart watch, a tablet, a notebook computer or a stationary computer.

6. Audio signal processor of one of the preceding examples, wherein the first device (901) comprises a user tracking system (914) and is configured to transmit data for the user position or orientation to the second device (902).

7. Audio signal processor of one of the preceding examples, wherein the two-channel synthesizer (200) is configured to separate (210) the single-channel acoustic data into the three parts direct sound, early reflection, and late reverberation,
wherein the two-channel acoustic data for the direct sound part is generated (220) by the first device, wherein the two-channel acoustic data for the early reflection part is generated (230) by the second device (902), or wherein the two-channel acoustic data for the late reverberation part is generated (240) by a third device (903), wherein the third device (903) is separate from the first device (901) and the second device (902).

8. Audio signal processor of example 6, wherein the second device (902) is a mobile phone having access to the internet, and wherein the third device (903) is a remote computer connected to the mobile device via the internet, and wherein the two-channel audio data for the late reverberation part are updated less often than the two-channel acoustic data for the early reverberation part.

9. Audio signal processor of one of the preceding examples, wherein the second device (902) is configured to receive, from the first device (901), the user position or orientation, to provide the two-channel acoustic data for the early reflection and/or the late reverberation part, and to transmit the two-channel acoustic data for the early reflection part and/or the late reverberation part to the first device.

10. Audio signal processor of one of the preceding examples, wherein the second device is configured to receive, from the first device, the user position or orientation, and the audio signal, and to provide the two-channel acoustic data for at least the early reflection part, and
wherein the sound generator (300) is distributed to the first device (901) and the second device (902), wherein the first device is configured to generate the two-channel audio signal for the direct sound part, wherein the second device is configured to generate the two-channel audio signal for at least the early reflection part, and wherein the second device is configured to transmit the two-channel audio signal for the early reflection part to the first device.

11. Audio signal processor of one of the preceding examples, wherein the first device (901) is configured to delay the two-channel acoustic data for the direct sound part by a delay value covering a delay incurred by a transmission to the second device and from the second device.

12. Audio signal processor of one of the preceding examples,
wherein the first device (901) has a memory for storing the second acoustic data for the early reflection part and/or for the late reverberation part,
wherein the two-channel synthesizer (200) or the sound generator (300) are configured to use the stored two-channel acoustic data in a calculation of a full two-channel acoustic data, when updated two-channel data for the direct sound part are available and updated two-channel acoustic data for the early reflection part or the late reverberation part are not available (933) due to different update rates of the first device (901) and the second device (902).

13. Audio signal processor of one of the preceding examples,
wherein the sound generator (300) is configured to aggregate the two-channel acoustic data for each part to obtain a full two-channel acoustic data and to combine the full two-channel acoustic data and a multichannel audio signal to obtain the two-channel audio signal, or to combine the two-channel acoustic data for each part and the input audio signal to obtain partial two-channel audio signal for each part and to aggregate the partial two-channel audio signals to obtain the two-channel audio signal.

14. Audio signal processor of one of the preceding examples, wherein the two-channel analyzer is configured to update the two-channel acoustic data for each part at a different rate, wherein the direct sound part is updated more often than the remaining parts, or wherein the early reflection part is updated less frequently than the direct sound part and more frequently than the late reverberation part, or wherein the late reverberation part is updated less frequently than the remaining part of the two-channel acoustic data for the acoustic environment.

15. Audio signal processor of one of the preceding examples,
wherein the second device comprises a calculator or a reverberator network for generating or processing the two-channel audio data for the early reflection and/or the late reverberation part, or wherein the update ratio for the direct sound part is above 15 Hz, wherein the update ratio for the early reflection part is greater than 5 Hz and lower than 15 Hz, or wherein the update ratio for the late reverberation part is greater than 0.5 Hz and lower than 5 Hz.

16. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data,
wherein the synthesizing comprises separating (210) the single-channel acoustic data into at least two parts consisting of a direct sound part and at least one of an early reflection part and a late reverberation part, and to individually process (220, 230, 240) the at least two parts for generating two-channel acoustic data for each part, and
wherein the synthesizing comprises using two physically separate device (901, 902), wherein the first device (901) of the two physically separated devices to processes (220, 230) at least one of the direct sound part and the early reflection part, wherein the second device (903) of the two physically separated devices to processes (230, 240) at least one of the early reflection part and the late reverberation part, and wherein the first device (901) and the second device (902) are connected via a transmission interface (918, 925) and have separate power supplies (917, 924).

17. Computer program for performing, when running on a computer or a processor, the method of example 16.

Subsequently, examples of the present invention relating to the seventh aspect are summarized, where the reference numbers in brackets are not to be considered limiting the scope of the examples.

1. Audio signal processor for generating a two-channel audio signal, comprising:
an input interface (100) for providing single-channel acoustic data describing an acoustic environment;
a two-channel synthesizer (200) for synthesizing two-channel acoustic data from the single-channel acoustic data using a listener position or rotation; and
a sound generator (300) for generating the two-channel audio signal from an audio signal and the two-channel acoustic data,
wherein the two-channel synthesizer (200) is configured
to separate (210) the single-channel acoustic data into at least two parts consisting of a direct sound part and at least one of an early reflection part and a late reverberation part, and to individually process (220, 230, 240) the at least two parts for generating two-channel acoustic data for each part,
to determine (601) a separation time instant in the single-channel acoustic data between the direct sound part and the early reflection part or between the early reflection part and the late reverberation part,
to extend (602) at least one of the two parts of the separation time instant by a certain number of samples, so that an overlap at the separation time instant is achieved, and
to window (603) the at least one extended part using a certain window function accounting for the sample extension.

2. Audio signal processor of example 1, wherein the number of samples for the overlap are taken from the respective other part.

3. Audio signal processor of example 1 or example 2, wherein the window function is a Tukey window having lobes with a width of 2n, wherein n is the certain number of samples and the two parts are extended by n samples each.

4. Audio signal processor of one of the preceding examples, wherein the two-channel synthesizer is configured to determine the separation time instant between the direct sound part and the early reflection part, so that the distance of the separation time instant is substantially centered between a direct sound peak and a first early reflection peak or to determine the separation time instant between the early reflection part and the late reverberation part as a perceptual mixing time of the acoustic environment or at a predetermined amount of time before the perceptual mixing time.

5. Apparatus of one of the preceding examples, wherein the two-channel synthesizer is configured, subsequent to the individual processing (220, 230, 240) of the corresponding parts, to perform an overlap-add operation with the first channel of the two-channel acoustic data for the direct sound part with a first channel of the two-channel acoustic data for the early reflection part and with a first channel of the two-channel acoustic data for the late reverberation part, and
wherein the two-channel synthesizer is configured, subsequent to the individual processing (220, 230, 240) of the corresponding parts, to perform an overlap-add operation with a second channel of the two-channel acoustic data for the direct sound part, with a second channel of the two-channel acoustic data for the early reflection part, and with a second channel of the two-channel acoustic data for the late reverberation part.

6. Audio signal processor of one of the preceding example, wherein the two-channel synthesizer (200) is configured to pre-process (600) the single-channel acoustic data by detecting a direct sound index in a time representation of the single-channel acoustic data and to cut or extend by zero valued samples a start portion of the time representation of the single-channel acoustic data, so that the detected time index coincides with a predefined sample index offset from a beginning of the single-channel acoustic data.

7. Audio signal processor of one of the preceding example, wherein the acoustic data describing the acoustic environment is a room impulse response or a room transfer function, or wherein the two-channel acoustic data is a binaural two-channel head related impulse response or a binaural two-channel head related transfer function.

8. Audio signal processor of one of the preceding example, wherein the sound generator (300) is configured to aggregate the two-channel acoustic data for each part to obtain a full two-channel acoustic data and to combine the full two-channel acoustic data and an input audio signal to obtain the two-channel audio signal, or to combine the two-channel acoustic data for each part and the input audio signal to obtain a partial two-channel audio signal for each part and to aggregate the partial two-channel audio signals to obtain the two-channel audio signal.

9. Audio signal processor of one of the preceding examples, wherein the two-channel synthesizer is configured to determine (611) a current distance of the listener position to the source position with respect to an initial distance of an initial generation of the single-channel acoustic data, and to adjust (614) a time period between the two-channel acoustic data for the direct sound part and the two-channel acoustic data for the early reflection part, so that the time period is enlarged, when the current distance is lower than the initial distance or so that the time period is reduced, when the current distance is greater than the initial distance.

10. Audio signal processor of example 9, wherein the multi-channel synthesizer is configured by adding zero samples to the early reflection part before overlap-adding, when the time period is enlarged, or to remove excessive samples, when the time period is reduced.

11. Audio signal processor of examples 9 or 10, wherein the multi-channel synthesizer (200) is configured to determine (611) a first initial time delay gap for an initial measurement for the single-channel acoustic data provided by the input interface (100), to determine (612) a second initial time delay gap for a current listener position and a current sound source position, to calculate (630) a difference between the first initial time delay gap and the second initial time delay gap, and to adjust (614) the first initial time delay gap by shifting the earlier reflection part by the calculated difference.

12. Audio signal processor of example 11, wherein the multi-channel synthesizer is configured to determine (612) the second initial time delay gap by a difference between the propagation time of a first reflection from an image source position associated to a first segment of the early reflection part to the current listener position and the propagation time from the current sound source position to the current listener position.

13. Audio signal processor of one of the preceding example,
wherein the two-channel analyzer is configured to store an early generated two-channel acoustic data for the early reflection part and the late reverberation part in which the window function is applied, and to retrieve the stored two-channel acoustic data for the propose of an overlap-add operation (606) of the channels with a newly updated other part of the two-channel acoustic data.

14. Method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data,
wherein the synthesizing comprises:
separating (210) the single-channel acoustic data into at least two parts consisting of a direct sound part and at least one of an early reflection part and a late reverberation part, and to individually process (220, 230, 240) the at least two parts for generating two-channel acoustic data for each part,
determining (601) a separation time instant in the single-channel acoustic data between the direct sound part and the early reflection part or between the early reflection part and the late reverberation part,
extending (602) at least one of the two parts of the separation time instant by a certain number of samples, so that an overlap at the separation time instant is achieved, and
windowing (603) the at least one extended part using a certain window function accounting for the sample extension.

15. Computer program for performing, when running on a computer or a processor, the method of example 14.

It is to be mentioned here that all alternatives or aspects as discussed before and all aspects as defined by independent claims in the following claims or the preceding examples can be used individually, i.e., without any other alternative or object than the contemplated alternative, object, example or independent claim. However, in other embodiments, two or more of the alternatives or the aspects or the examples or the independent claims can be combined with each other and, in other embodiments, all aspects, or alternatives, or all examples and all independent claims can be combined to each other.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed. Some embodiments according to the invention comprise a data carrier having electronically readable control signals, which are capable of cooperating with a programmable computer system, such that one of the methods described herein is performed. Generally, embodiments of the present invention can be implemented as a computer program product with a program code, the program code being operative for performing one of the methods when the computer program product runs on a computer. The program code may for example be stored on a machine readable carrier. Other embodiments comprise the computer program for performing one of the methods described herein, stored on a machine readable carrier or a non-transitory storage medium. In other words, an embodiment of the inventive method is, therefore, a computer program having a program code for performing one of the methods described herein, when the computer program runs on a computer. A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein. In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An audio signal processor for generating a two-channel audio signal, comprising:
an input interface for providing single-channel acoustic data describing an acoustic environment;
a two-channel synthesizer for synthesizing two-channel acoustic data from the single-channel acoustic data using a listener position or rotation; and
a sound generator for generating the two-channel audio signal from an audio signal and the two-channel acoustic data,
wherein the two-channel synthesizer is configured to separate the single-channel acoustic data into at least two parts comprising a direct sound part and at least one of an early reflection part and a late reverberation part, and to individually process the at least two parts for generating two-channel acoustic data for each part,
wherein the two-channel synthesizer is configured to segment the early reflection part into a plurality of segments,
to determine a plurality of image source positions representing source positions of reflecting sound,
to associate the image source positions to the segments using a matching operation, wherein the matching operation comprises calculating a time of sound arrival for each image source to the listener position and associating the image source positions to corresponding segments that comprise time delays in the corresponding segments best matching with the time of sound arrival of the corresponding image source positions, and
to calculate the two-channel acoustic data for the direct sound using the image source positions associated to the segments.

2. The audio signal processor of claim 1,
wherein the two-channel synthesizer is configured to determine the plurality of image source positions using an initial source position and an initial sink position of an initial measurement for the generation of the single-channel acoustic data for the acoustic environment and geometric data on the acoustic environment.

3. The audio signal processor of claim 1, in which the two-channel synthesizer is configured to determine the image source positions using an image source method modelling specular reflections in the acoustic environment.

4. The audio signal processor of claim 1, wherein the two-channel synthesizer is configured to determine the image source positions up to a predetermined order, and
to use random or predetermined direction of arrival data or two-channel head-related data for a reflection in a segment that does not comprise an associated image source position or that does not comprise a time of sound arrival being in a predetermined matching range to a time delay of a reflection in a segment.

5. The audio signal processor of claim 1,
wherein the two-channel synthesizer is configured to detect salient reflections in the early reflection part and to place a segment around each salient reflection, the segment comprising a predetermined length corresponding to a length of a head-related impulse response or to partition the early reflection part into a regular grid of reflection segments each comprising a sample count and an overlap to an adjacent segment.

6. The audio signal processor of claim 5, wherein the two-channel synthesizer is configured to detect the salient reflection by comparing a first average energy per sample in a first window with a second average energy per sample in a second window, wherein a sample count of the second window is greater than a sample count of the first window, wherein a salient reflection is determined, when the first average energy is greater than the second average by a predetermined amount.

7. The audio signal processor of claim 6, wherein the predetermined amount is between 3 dB and 9 dB, or wherein a sample count of the first window is smaller than a sample count of the second window preferably by at least a factor of 0.25.

8. The audio signal processor of claim 1, wherein the two-channel synthesizer is configured to determine for each segment, a direction of arrival information from the listener position and the image source position associated to the respective segment and to combine the early reflection part in the segment and two head-related data channels associated with the direction of arrival information to acquire at least a part of the two-channel acoustic data for the segment.

9. The audio signal processor of claim 1,
wherein the two-channel synthesizer is configured to pad the segment to a length of the two-channel acoustic data in a time domain,
to convert the padded segment into a frequency domain and to multiply a frequency domain padded segment by each channel of the head-related two-channel data in the frequency domain to acquire a frequency domain two-channel acoustic data for the segment, and
to transform the frequency-domain two-channel data for the segment into the time domain.

10. The audio signal processor of claim 9, wherein the two-channel synthesizer is configured to remove an introduced phase delay from the two-channel acoustic data in the time domain.

11. The audio signal processor of claim 1, wherein the two-channel synthesizer is configured to generate the two-channel acoustic data for each segment from a combination of a specular part derived using the image source positions associated to the segments and a diffuse part for the corresponding segment.

12. The audio signal processor of claim 1,
wherein a single-channel acoustic data describing the acoustic environment is a room impulse response or a room transfer function, or wherein the two-channel acoustic data is a binaural two-channel head-related impulse response or a binaural two-channel head-related transfer function.

13. The audio signal processor of claim 2, wherein the two-channel synthesizer is configured to maintain the image source position for a listener position at the initial sink position and at a listener position different from the initial sink position, or for the initial source position or a source position being different from the initial source position, or to maintain the association between the segments and the image source positions for a source position at the initial source position or a source position being different from the initial source position.

14. The audio signal processor of claim 1, wherein the two-channel synthesizer is configured to determine, for the listener position and an image source position or orientation of an image sound source, directivity information of the image sound source, and to use the directivity information in the calculation of the two-channel acoustic data for the earlier reflection sound part.

15. The audio signal processor of claim 14, wherein the directivity information for each image source is derived from the same set of directivity information determined for the direct sound part, or wherein an orientation of the image sound source is determined by an image source model.

16. The audio signal processor of claim 14, wherein the directivity information is determined and used for a predetermined subset of the segments in the early reflection part.

17. The audio signal processor of claim 14, wherein the predetermined subset of segments in the early reflection part comprises less than ten segments and preferably only 2 segments.

18. A method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data, wherein the generating comprises
separating the single-channel acoustic data into at least two parts comprising a direct sound part and at least one of an early reflection part and a late reverberation part, and to individually process the at least two parts for generating two-channel acoustic data for each part,
segmenting the early reflection part into a plurality of segments,
determining a plurality of image source positions representing source positions of reflecting sound, and
associating the image source positions to the segments using a matching operation, wherein the matching operation comprises calculating a time of sound arrival for each image source to the listener position and associating the image source positions to corresponding segments that comprise time delays in the corresponding segments best matching with the time of sound arrival of the corresponding image source positions, and
calculating the two-channel acoustic data for the direct sound using the image source positions associated to the segments.

19. A non-transitory digital storage medium having a computer program stored thereon to perform a method of generating a two-channel audio signal, comprising:
providing single-channel acoustic data describing an acoustic environment;
synthesizing two-channel acoustic data from the single-channel acoustic data using a listener position or rotation; and
generating the two-channel audio signal from an audio signal and the two-channel acoustic data, wherein the generating comprises
separating the single-channel acoustic data into at least two parts comprising a direct sound part and at least one of an early reflection part and a late reverberation part, and to individually process the at least two parts for generating two-channel acoustic data for each part,
segmenting the early reflection part into a plurality of segments,
determining a plurality of image source positions representing source positions of reflecting sound, and
associating the image source positions to the segments using a matching operation, wherein the matching operation comprises calculating a time of sound arrival for each image source to the listener position and associating the image source positions to corresponding segments that comprise time delays in the corresponding segments best matching with the time of sound arrival of the corresponding image source positions, and
calculating the two-channel acoustic data for the direct sound using the image source positions associated to the segments,
when the computer program is run by a computer.
